(19) United States
(12) Patent Application Publication
(10) Pub. No.: US 2017/0051206 A1
(43) Pub. Date: Feb. 23, 2017

(54) LIQUID CRYSTAL COMPOUND HAVING ALKENYL ON BOTH ENDS, LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: Yasuyuki GOTOH, Tokyo (JP); Kazuo OKUMURA, Ichihara-shi (JP)

(73) Assignees: JNC CORPORATION, Tokyo (JP); JNC PETROCHEMICAL CORPORATION, Tokyo (JP)

(21) Appl. No.: 15/241,975

(22) Filed: Aug. 19, 2016

(30) Foreign Application Priority Data
Aug. 20, 2015 (JP) 2015-162419

(51) Int. Cl. C09K 19/34; C09K 19/30

(52) U.S. Cl. CPC C09K 19/3402; C09K 19/3068; C09K 19/3003; C09K 19/3001; C09K 19/3066; C09K 2019/3077; C09K 2019/3004; C09K 2019/3009; C09K 2019/301; C09K 2019/3016; C09K 2019/308; C09K 2019/3083; C09K 2019/3422; C09K 2019/3425; G02F 2001/133302

(57) ABSTRACT

Provided is a liquid crystal compound satisfying at least one of physical properties such as high stability to heat and light, a high clearing point (or high maximum temperature), low minimum temperature of a liquid crystal phase, small viscosity, suitable optical anisotropy, large dielectric anisotropy, a suitable elastic constant and good compatibility with other liquid crystal compounds, a liquid crystal composition containing the compound, and a liquid crystal display device including the composition.

A compound is represented by formula (1), for example:

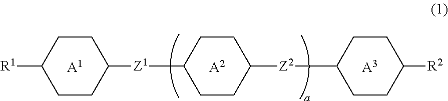

wherein, R¹ and R² are independently alkenyl having 2 to 10 carbons; ring A¹, ring A² and ring A³ are independently 1,4-phenylene or 1,4-phenylene in which at least one piece of hydrogen is replaced by fluorine or chlorine; Z¹ and Z² are independently alkylene having 1 to 4 carbons, and at least one of Z¹ and Z² may be a single bond; and a is 1 or 2.

### Technical Field

The invention relates to a liquid crystal compound, a liquid crystal composition and a liquid crystal display device. More specifically, the present invention relates to a liquid crystal compound having alkenyl at both terminals, a liquid crystal composition that contains the compound, and has a nematic phase, and a liquid crystal display device including the composition.

A liquid crystal display device has been widely used for a display of a personal computer, a television and so forth. The device utilizes physical properties such as optical anisotropy and dielectric anisotropy of a liquid crystal compound. As an operating mode of the liquid crystal display device, such a mode exists as a phase change (PC) mode, a twisted nematic (TN) mode, a super twisted nematic (STN) mode, a bistable twisted nematic (BTN) mode, an electrically controlled birefringence (ECB) mode, an optically compensated bend (OCB) mode, an in-plane switching (IPS) mode, a vertical alignment (VA) mode, a fringe field switching (FFS) mode and a polymer sustained alignment (PSA) mode. A liquid crystal composition containing a polymer is used in a device having the PSA mode. In the composition, alignment of liquid crystal molecules can be controlled by the polymer.

In such a liquid crystal display device, a liquid crystal composition having suitable physical properties is used. In order to further improve characteristics of the device, the liquid crystal compound contained in the composition preferably has physical properties described in (1) to (8) below: (1) high stability to heat and light, (2) a high clearing point, (3) a low minimum temperature of a liquid crystal phase, (4) a small viscosity (η), (5) suitable optical anisotropy (Δn), (6) large dielectric anisotropy (Δε) or small dielectric anisotropy, (7) a suitable elastic constant and (8) good compatibility with other liquid crystal compounds.

An effect of physical properties of the liquid crystal compound on the characteristics of the device is as described below. A compound having the high stability to heat and light as described in (1) increases a voltage holding ratio of the device. Thus, a service life of the device is elongated. A compound having the high clearing point as described in (2) extends a temperature range in which the device can be used. A compound having the low minimum temperature of the liquid crystal phase such as a nematic phase and a smectic phase as described in (3), in particular, a compound having the low minimum temperature of the nematic phase, also extends the temperature range in which the device can be used. A compound having the small viscosity as described in (4) shortens a response time of the device.

According to a design of the device, a compound having the suitable optical anisotropy, more specifically, a compound having a large optical anisotropy or a small optical anisotropy as described in (5) is required. When the response time is shortened by decreasing a cell gap of the device, a compound having the large optical anisotropy is suitable. A compound having the large dielectric anisotropy as described in (6) decreases a threshold voltage of the device. Thus, an electric power consumption of the device is reduced. On the other hand, a compound having a small dielectric anisotropy shortens the response time of the device by decreasing a viscosity of the composition. The compound extends the temperature range in which the device can be used by increasing a maximum temperature of the nematic phase.

With regard to (7), a compound having the large elastic constant shortens the response time of the device. A compound having the small elastic constant decreases the threshold voltage of the device. Therefore, the suitable elastic constant is required according to the characteristics that are desirably improved. A compound having the good compatibility with other liquid crystal compounds as described in (8) is preferred. The reason is that the physical properties of the composition are adjusted by mixing liquid crystal compounds having different physical properties.

A variety of liquid crystal compounds having a small negative dielectric anisotropy have been so far prepared in addition to liquid crystal compounds having a large negative dielectric anisotropy. The reason is that good physical properties that are not found in conventional compounds are expected from a new compound. The reason is also that the new compound may be occasionally provided with a suitable balance regarding at least two physical properties in the composition. In view of such a situation, with regard to the physical properties (1) to (8) described above, a compound in which good physical properties are provided or a suitable balance is provided in the composition has been desired.

Then, p-terphenyl having alkenyl at both terminals has been already known. In paragraph 0004 on page 4 of Patent literature No. 1: CN 102153441 A, the compound described below is disclosed.

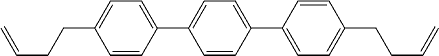 [SMILES: C=CCCc1ccc(-c2ccc(-c3ccc(CCC=C)cc3)cc2)cc1]

On page 13 (compound of IV-H) of Patent literature No. 2: CN 104263382 A, the compound described below is disclosed.

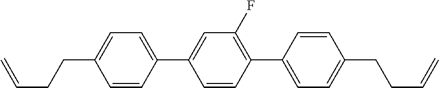 [SMILES: C=CCCc1ccc(-c2ccc(-c3ccc(CCC=C)cc3)c(F)c2)cc1]

In paragraph 0116 in Example 8 (the second compound from top) on page 49 of Patent literature No. 3: WO 2011/040170 A, the compound described below is disclosed.

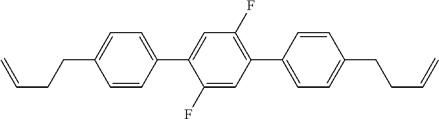 [SMILES: C=CCCc1ccc(-c2cc(F)c(-c3ccc(CCC=C)cc3)cc2F)cc1]

In paragraph 0358 on page 95 of Patent literature No. 4: WO 2014/148472 A, the compounds described below are disclosed.

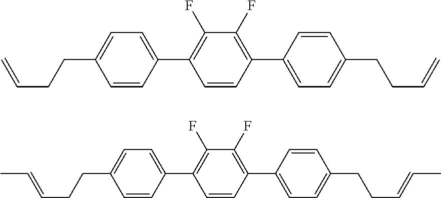

### CITATION LIST

### Patent Literature

Patent literature No. 1: CN 102153441 A.

Patent literature No. 2: CN 104263382 A.

Patent literature No. 3: WO 2011/040170 A.

Patent literature No. 4: WO 2014/148472 A.

### SUMMARY OF INVENTION

### Technical Problem

A first object is to provide a liquid crystal compound satisfying at least one of physical properties such as a high stability to heat and light, a high clearing point (or a high maximum temperature of a nematic phase), a low minimum temperature of a liquid crystal phase, a small viscosity, a suitable optical anisotropy, a small dielectric anisotropy, a suitable elastic constant and a good compatibility with other liquid crystal compounds. The object is to provide a compound having a small viscosity in comparison with a similar compound. A second object is to provide a liquid crystal composition that contains the compound and satisfies at least one of physical properties such as a high stability to heat and light, a high maximum temperature of a nematic phase, a low minimum temperature of the nematic phase, a small viscosity, a suitable optical anisotropy, a large positive or negative dielectric anisotropy, a large specific resistance and a suitable elastic constant. The object is to provide a liquid crystal composition having a suitable balance regarding at least two of the physical properties. A third object is to provide a liquid crystal display device including the composition and having a wide temperature range in which the device can be used, a short response time, a large voltage holding ratio, a low threshold voltage, a large contrast ratio, a small flicker rate and a long service life.

### Solution to Problem

The invention concerns a compound represented by formula (1), a liquid crystal composition containing the compound, and a liquid crystal display device including the composition:

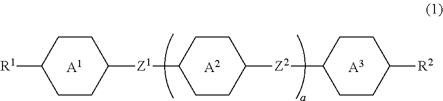

wherein, in formula (1),

R¹ and R² are independently alkenyl having 2 to 10 carbons, and in the alkenyl, at least one piece of hydrogen maybe replaced by fluorine or chlorine;

ring A¹, ring A² and ring A³ are independently 1,4-phenylene or 1,4-phenylene in which at least one piece of hydrogen is replaced by fluorine or chlorine;

Z¹ and Z² are independently alkylene having 1 to 4 carbons, and in the groups, at least one piece of —CH₂— may be replaced by —O—, —COO— or —OCO—, and at least one piece of —CH₂CH₂— may be replaced by —CH═CH—, and in the groups, at least one piece of hydrogen may be replaced by fluorine or chlorine, and at least one of Z¹ and Z² may be a single bond; and

a is 1 or 2.

### Advantageous Effects of Invention

A first advantage is to provide a liquid crystal compound satisfying at least one of physical properties such as a high stability to heat and light, a high clearing point (or a high maximum temperature of a nematic phase), a low minimum temperature of a liquid crystal phase, a small viscosity, a suitable optical anisotropy, a small dielectric anisotropy, a suitable elastic constant and a good compatibility with other liquid crystal compounds. The advantage is to provide a compound having a small viscosity in comparison with a similar compound (see Comparative Example 1). A second advantage is to provide a liquid crystal composition that contains the compound and satisfies at least one of physical properties such as a high stability to heat and light, a high maximum temperature of a nematic phase, a low minimum temperature of the nematic phase, a small viscosity, a suitable optical anisotropy, a large positive or negative dielectric anisotropy, a large specific resistance and a suitable elastic constant. The advantage is to provide a liquid crystal composition having a suitable balance regarding at least two of the physical properties. A third advantage is to provide a liquid crystal display device including the composition and having a wide temperature range in which the device can be used, a short response time, a large voltage holding ratio, a low threshold voltage, a large contrast ratio, a small flicker rate and a long service life.

### DESCRIPTION OF EMBODIMENTS

Usage of terms herein is as described below. Terms “liquid crystal compound,” “liquid crystal composition” and “liquid crystal display device” may be occasionally abbreviated as “compound,” “composition” and “device,” respectively. “Liquid crystal compound” is a generic term for a compound having a liquid crystal phase such as a nematic phase and a smectic phase, and a compound having no liquid crystal phase but to be added for the purpose of adjusting physical properties of a composition, such as a maximum temperature, a minimum temperature, viscosity and dielectric anisotropy. The compound has a six-membered ring such as 1,4-cyclohexylene and 1,4-phenylene, and has rod-like molecular structure. “Liquid crystal display device” is a generic term for a liquid crystal display panel and a liquid crystal display module. “Polymerizable compound” is a compound to be added for the purpose of forming a polymer in the composition.

The liquid crystal composition is prepared by mixing a plurality of liquid crystal compounds. An additive is added to the composition for the purpose of further adjusting the physical properties. The additive such as a polymerizable compound, a polymerization initiator, a polymerization inhibitor, an optically active compound, an antioxidant, an ultraviolet light absorber, a light stabilizer, a heat stabilizer, a dye and an antifoaming agent is added thereto when necessary. The liquid crystal compound and the additive are mixed in such a procedure. A proportion (content) of the liquid crystal compounds is expressed in terms of weight percent (% by weight) based on the weight of the liquid crystal composition containing no additive, even after the additive has been added. A proportion (amount of addition) of the additive is expressed in terms of weight percent (% by weight) based on the weight of the liquid crystal composition containing no additive. Weight parts per million (ppm) may be occasionally used. A proportion of the polymerization initiator and the polymerization inhibitor is exceptionally expressed based on the weight of the polymerizable compound.

“Clearing point” is a transition temperature between the liquid crystal phase and an isotropic phase in the liquid crystal compound. “Minimum temperature of the liquid crystal phase” is a transition temperature between a solid and the liquid crystal phase (the smectic phase, the nematic phase or the like) in the liquid crystal compound. “Maximum temperature of the nematic phase” is a transition temperature between the nematic phase and the isotropic phase in a mixture of the liquid crystal compound and a base liquid crystal or in the liquid crystal composition, and may be occasionally abbreviated as “maximum temperature.” “Minimum temperature of the nematic phase” may be occasionally abbreviated as “minimum temperature.” An expression “increases the dielectric anisotropy” means that the value positively increases for the composition having a positive dielectric anisotropy, and that the value negatively increases for the composition having a negative dielectric anisotropy. An expression “having a large voltage holding ratio” means that the device has a large voltage holding ratio at room temperature and also at a temperature close to the maximum temperature in an initial stage, and the device has the large voltage holding ratio at room temperature and also at a temperature close to the maximum temperature even after the device has been used for a long period of time. In the composition or the device, the characteristics may be occasionally examined before and after an aging test (including an acceleration deterioration test).

A compound represented by formula (1) may be occasionally abbreviated as “compound (1).” At least one compound selected from the group of compounds represented by formula (1) may be occasionally abbreviated as “compound (1).” “Compound (1)” means one compound, a mixture of two compounds or a mixture of three or more compounds represented by formula (1). A same rule applies also to any other compound represented by any other formula. In formulas (1) to (15), a symbol such as A¹, B¹ and C¹ surrounded by a hexagonal shape corresponds to ring A¹, ring B¹ and ring C¹, respectively. The hexagonal shape represents a six-membered ring such as cyclohexane or benzene. The hexagonal shape may occasionally represent a condensed ring such as naphthalene or a bridged ring such as adamantane. A perpendicular line crossing the hexagonal shape indicates that arbitrary hydrogen on the ring can be replaced by fluorine. A subscript such as d represents the number of groups to be replaced. When the subscript is 0, no such replacement exists.

A symbol of terminal group R¹¹ is used in a plurality of compounds in chemical formulas of component compounds. In the compounds, two groups represented by two pieces of arbitrary may be identical or different. For example, in one case, R¹¹ of compound (2) is ethyl and R¹¹ of compound (3) is ethyl. In another case, R¹¹ of compound (2) is ethyl and R¹¹ of compound (3) is propyl. A same rule applies also to a symbol such as R¹², R¹³ and Z¹¹. In compound (5), when i is 2, two of ring C¹ exists. In the compound, two groups represented by two of rings C¹ may be identical or different. A same rule applies also to two of arbitrary rings C¹ when i is larger than 2. A same rule applies also to other symbols.

An expression “at least one piece of ‘A’” means that the number of ‘A’ is arbitrary. An expression “at least one piece of ‘A’ may be replaced by ‘B’” means that, when the number of ‘A’ is 1, a position of ‘A’ is arbitrary, and also when the number of ‘A’ is 2 or more, positions thereof can be selected without restriction. A same rule applies also to an expression “at least one piece of ‘A’ is replaced by ‘B’.” An expression “at least one piece of ‘A’ may be replaced by ‘B’, ‘C’ or ‘D’” includes a case where arbitrary ‘A’ is replaced by ‘B’, a case where arbitrary ‘A’ is replaced by ‘C’, and a case where arbitrary ‘A’ is replaced by ‘D’, and also a case where a plurality of pieces of ‘A’ are replaced by at least two pieces of ‘B’, ‘C’ and/or ‘D’. For example, “alkyl in which at least one piece of —CH₂— may be replaced by —O— or —CH═CH—” includes alkyl, alkoxy, alkoxyalkyl, alkenyl, alkoxyalkenyl and alkenyloxyalkyl. In addition, a case where two pieces of consecutive —CH₂— are replaced by —O— to form —O—O— is not preferred. In alkyl or the like, a case where —CH₂— of a methyl part (—CH₂—H) is replaced by —O— to form —O—H is not preferred, either.

An expression “R¹⁶ and R¹⁷ are independently alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine” may be occasionally used. In the expression, “in the groups” may be interpreted according to wording. In the expression, “the groups” means alkyl, alkenyl, alkoxy, alkenyloxy or the like. More specifically, “the groups” represents all of the groups described before the wordings “in the groups.”

Halogen means fluorine, chlorine, bromine and iodine. Preferred halogen is fluorine and chlorine. Further preferred halogen is fluorine. Alkyl of the liquid crystal compound is straight-chain alkyl or branched-chain alkyl, but includes no cyclic alkyl. In general, straight-chain alkyl is preferred to branched-chain alkyl. A same rule applies also to a terminal group such as alkoxy and alkenyl. With regard to a configuration of 1,4-cyclohexylene, trans is preferred to cis for increasing the maximum temperature. Then, 2-fluoro-1,4-phenylene means two divalent groups described below. In a chemical formula, fluorine may be leftward (L) or rightward (R). A same rule also applies to an asymmetrical divalent group formed by removing two pieces of hydrogen from a ring, such as tetrahydropyran-2,5-diyl.

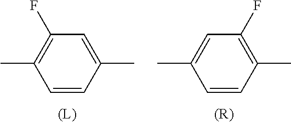

The invention includes items described below.

Item 1. A compound, represented by formula (1):

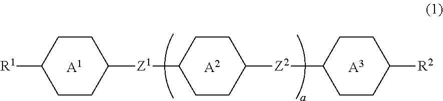

wherein, in formula (1),

R¹ and R² are independently alkenyl having 2 to 10 carbons, and in the alkenyl, at least one piece of hydrogen maybe replaced by fluorine or chlorine;

ring A¹, ring A² and ring A³ are independently 1,4-phenylene or 1,4-phenylene in which at least one piece of hydrogen is replaced by fluorine or chlorine;

Z¹ and Z² are independently alkylene having 1 to 4 carbons, and in the groups, at least one piece of —CH₂— may be replaced by —O—, —COO— or —OCO—, and at least one piece of —CH₂CH₂— may be replaced by —CH═CH—, and in the groups, at least one piece of hydrogen maybe replaced by fluorine or chlorine, and at least one of Z¹ and Z² may be a single bond; and

a is 1 or 2.

Item 2. The compound according to item 1, represented by formula (1a):

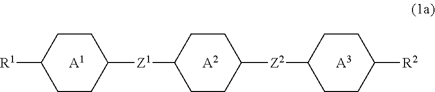

wherein, in formula (1a), R¹ and R² are independently alkenyl having 4 or 5 carbons, and in the groups, at least one piece of hydrogen may be replaced by fluorine or chlorine; ring A¹, ring A² and ring A³ are independently 1,4-phenylene or 1, 4 -phenylene in which at least one piece of hydrogen is replaced by fluorine; and Z¹ and Z² are independently —COO—, —CH₂O—, —CF₂O—, —CH₂CH₂—, —CF₂CF₂—, —CF═CF—, —(CH₂)₄— or —CH₂CH═CHCH₂—, and at least one of Z¹ and Z² may be a single bond.

Item 3. The compound according to item 1, represented by formula (1b):

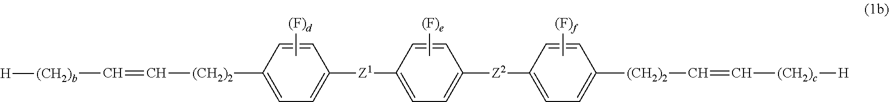

wherein, in formula (1b), b and c are independently 0 or 1; d, e and f are independently 0, 1 or 2, and a sum of d, e and f is from 0 to 3; and Z¹ and Z² are independently —COO—, —CH₂O—, —CH₂CH₂—, —(CH₂)₄— or —CH₂CH═CHCH₂—, and at least one of Z¹ and Z² may be a single bond.

Item 4. The compound according to item 1, represented by formula (1c):

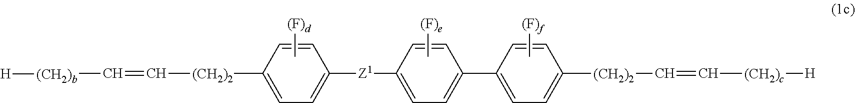

wherein, in formula (1c), b and c are independently 0 or 1; d, e and f are independently 0, 1 or 2, and a sum of d, e and f is 0, 1 or 2; and Z¹ is —COO—, —CH₂O— or —CH₂CH₂—.

Item 5. The compound according to item 4, wherein, in formula (1c), b and c are independently 0 or 1; d, e and f are independently 0 or 1, and a sum of d, e and f is 0 or 1; and Z¹ is —CH₂CH₂—.

Item 6. The compound according to item 1, represented by any one of formulas (1d) to (1g):

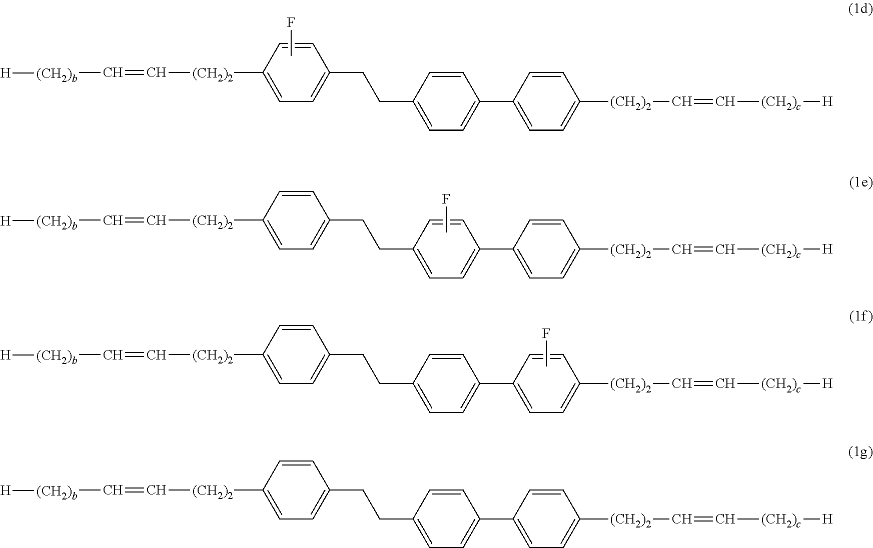

wherein, in formulas (1d) to (1g), b and c are independently 0 or 1.

Item 7. The compound according to item 1, represented by any one of formulas (1h) to (1k):

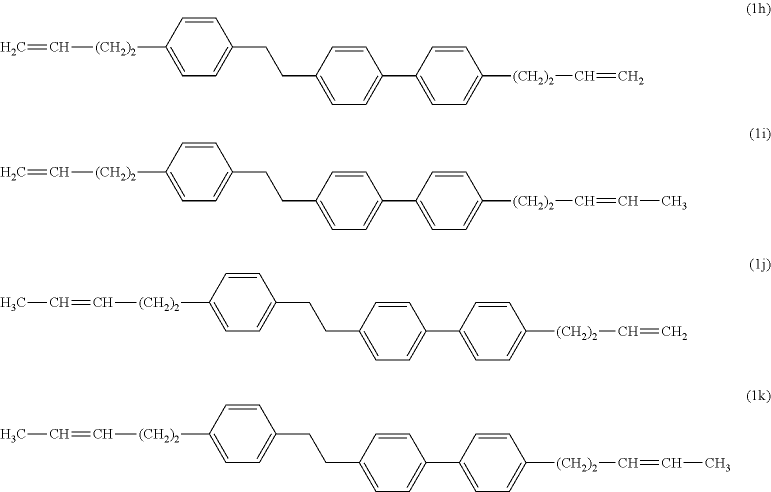

Item8. Aliquidcrystalcomposition, containing a compound according to item 1.

Item 9. The liquid crystal composition according to item 8, further containing at least one compound selected from the group of compounds represented by formulas (2) to (4):

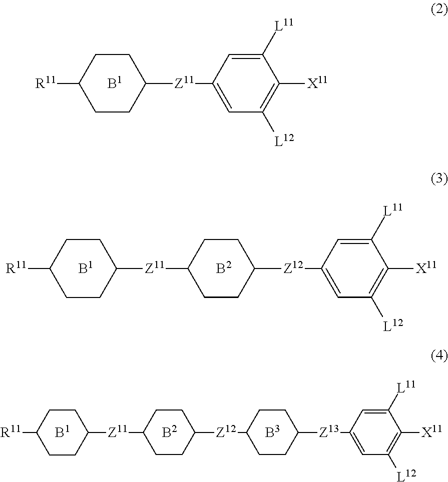

wherein, in formulas (2) to (4),

R¹¹ is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine;

X¹¹ is fluorine, chlorine, —OCF₃, —OCHF₂, —CF₃, —CHF₂, —CH₂F, —OCF₂CHF₂ or —OCF₂CHFCF₃;

ring B¹, ring B² and ring B³ are independently 1,4-cyclohexylene, 1,4-phenylene, 1,4-phenylene in which at least one piece of hydrogen is replaced by fluorine, tetrahydropyran-2,5-diyl, 1,3-dioxane-2,5-diyl or pyrimidine-2,5-diyl;

Z¹¹ , Z¹² and Z¹³ are independently —COO—, —OCO—, —CH₂O—, —OCH₂—, —CF₂O—, —OCF₂—, —CH₂CH₂—, —CH═CH—,—C≡C—, or —(CH₂)₄—; and

L¹¹ and L¹² are independently hydrogen or fluorine.

Item 10. The liquid crystal composition according to item 8, further containing at least one compound selected from the group of compounds represented by formula (5):

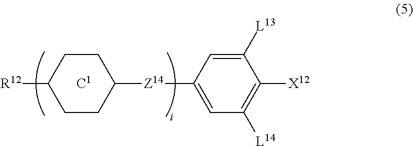

wherein, in formula (5),

R¹² is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine;

X¹² is —C≡N or —CC—CN;

ring C¹ is 1,4-cyclohexylene, 1,4-phenylene, 1,4-phenylene in which at least one piece of hydrogen is replaced by fluorine, tetrahydropyran-2,5-diyl, 1,3-dioxane-2,5-diyl or pyrimidine-2,5-diyl;

Z¹⁴ is a single bond, —COO—, —OCO—, —CH₂O—, —OCH₂—, —CF₂O—, —OCF₂—, —CH₂CH₂— or —C≡C—;

L¹³ _{and} L¹⁴ are independently hydrogen or fluorine; and

i is 1, 2, 3 or 4.

Item 11. The liquid crystal composition according to item 8, further containing at least one compound selected from the group of compounds represented by formulas (6) to (12):

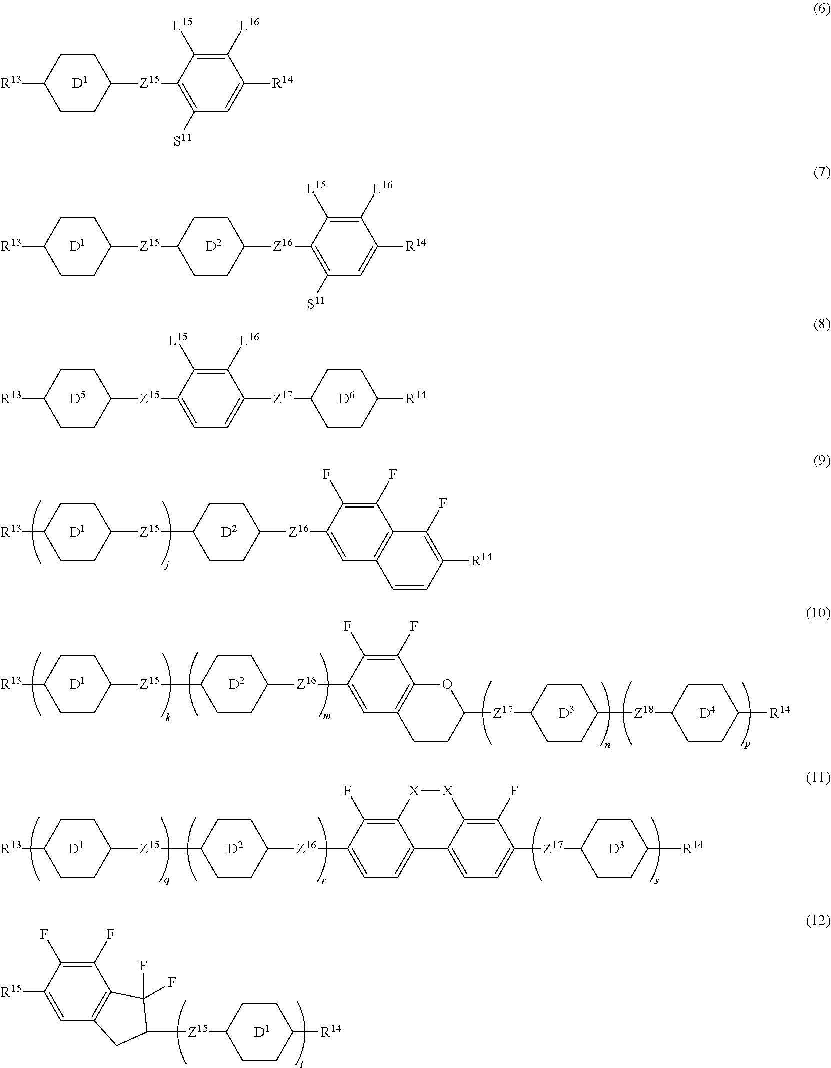

wherein, in formulas (6) to (12),

R13, R¹⁴ and R¹⁵ are independently alkyl having 1 to 10 carbons or alkenyl having 2 to 10 carbons, and in the groups, at least one piece of —CH₂— may be replaced by —O—, and in the groups, at least one piece of hydrogen may be replaced by fluorine, and R¹⁵ may be hydrogen or fluorine;

ring D¹, ring D², ring D³ and ring D⁴ are independently 1,4-cyclohexylene, 1,4-cyclohexenylene, 1,4-phenylene, 1, 4-phenylene in which at least one piece of hydrogen is replaced by fluorine, tetrahydropyran-2,5-diyl or decahydronaphthalene-2,6-diyl;

ring D⁵ and ring D⁶ are independently 1,4-cyclohexylene, 1,4-cyclohexenylene, 1,4-phenylene, tetrahydropyran-2,5-diyl or decahydronaphthalene-2,6-diyl;

Z¹⁵, Z¹⁶, Z¹⁷ and Z¹⁸ are independently a single bond, —COO—, —OCO—, —CH₂O—, —OCH₂—, —CF₂O—, —OCF₂—, —CH₂CH₂—, —CF₂OCH₂CH₂— or —OCF₂CH₂CH₂—;

L¹⁵ and L¹⁶ are independently fluorine or chlorine;

S¹¹ is hydrogen or methyl;

X is —CHF— or —CF₂—; and

j, k, m, n, p, q, r and s are independently 0 or 1, a sum of k, m, n and p is 1 or 2, a sum of q, r and s is 0, 1, 2 or 3, and t is 1, 2 or 3.

Item 12. The liquid crystal composition according to item 8, further containing at least one compound selected from the group of compounds represented by formulas (13) to (15):

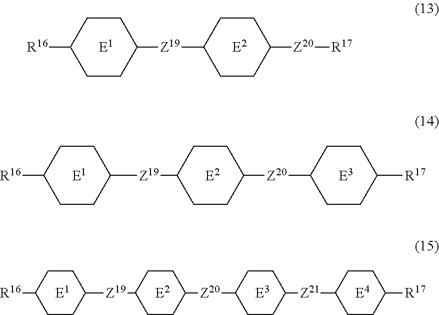

wherein, in formulas (13) to (15),

R¹⁶ and R¹⁷ are independently alkyl having 1 to 10 carbons or alkenyl having 2 to 10 carbons, and in the groups, at least one piece of —CH₂— may be replaced by —O—, and in the groups, at least one piece of hydrogen may be replaced by fluorine;

ring E¹, ring E², ring E³ and ring E⁴ are independently 1,4-cyclohexylene, 1,4-phenylene, 2-fluoro-1,4-phenylene, 2,5-difluoro-1,4-phenylene or pyrimidine-2,5-diyl;

Z¹⁹, Z²⁰ and Z²¹ are independently a single bond, —COO—, —CH₂CH₂—, —CH═CH— or —C≡C—; however,

in formulas (14) and (15), when one of R¹⁶ or R¹⁷ is alkenyl having 2 to 10 carbons, in which at least one piece of hydrogen thereof may be replaced by fluorine, another of R¹⁶ or R¹⁷ is alkyl having 1 to 10 carbons, in which at least one piece of hydrogen thereof may be replaced by fluorine.

Item 13. A liquid crystal display device, including a liquid crystal composition according to item 8.

The invention further includes the following items: (a) the composition, further containing one, two or at least three additives selected from the groups of a polymerizable compound, a polymerization initiator, a polymerization inhibitor, an optically active compound, an antioxidant, an ultraviolet light absorber, a light stabilizer, a heat stabilizer, a dye and an antifoaming agent; (b) the liquid crystal composition, wherein a maximum temperature of a nematic phase is 70° C. or more, an optical anisotropy (measured at 25° C.) at a wavelength of 589 nanometers is 0.07 or more, and a dielectric anisotropy (measured at 25° C.) at a frequency of 1 kHz is 2 or more; (c) the liquid crystal composition, wherein a maximum temperature of a nematic phase is about 70° C. or more, an optical anisotropy (measured at 25° C.) at a wavelength of 589 nanometers is about 0.08 or more, and a dielectric anisotropy (measured at 25° C.) at a frequency of 1 kHz is about −2 or less; (d) the liquid crystal display device, wherein an operating mode in the liquid crystal display device includes a TN mode, an ECB mode, an OCB mode, an IPS mode, a VA mode, an FFS mode or an FPA mode, and a driving mode in the liquid crystal display device includes an active matrix (AM) mode; and (e) the liquid crystal display device that has a polymer sustained alignment mode, and is prepared by using the liquid crystal composition containing a polymerizable compound.

An aspect of compound (1), a synthesis method of compound (1), the liquid crystal composition and the liquid crystal display device will be described in the order.

1. Aspect of compound (1)

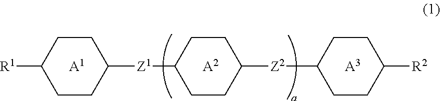

Compound (1) according to the invention has alkenyl at both terminals. At least one of Z¹ and Z² is not a single bond. A similar compound is p-terphenyl having alkenyl at both terminals. Compound (1) has a feature of having a small viscosity in comparison with the similar compound (see Comparative Example 1). Compound (1) is physically and chemically stable in a significant manner under a condition in which a device is ordinarily used, and has a good compatibility with other liquid crystal compounds. A composition contained compound (1) is stable under a condition in which a device is ordinarily used. When the composition is stored at low temperature, compound (1) has a small tendency of precipitation as a crystal (or a smectic phase). Compound (1) has general physical properties, a suitable optical anisotropy and a small dielectric anisotropy, all of which are required for a component of the composition.

Preferred examples of compound (1) will be described. Preferred examples of a terminal group R, ring A and a bonding group Z in compound (1) are also applied to a subordinate formula of formula (1) for compound (1). In compound (1), physical properties can be arbitrarily adjusted by suitably combining the groups. Compound (1) may contain a larger amount of isotope such as ²H (deuterium) and ¹³C than the amount of natural abundance because no significant difference exists in the physical properties of the compound. In addition, symbols in compound (1) are defined according to item 1.

In formula (1), R¹ and R² are independently alkenyl having 2 to 10 carbons, and in the alkenyl, at least one piece of hydrogen may be replaced by fluorine or chlorine.

When R¹ is alkenyl having the straight chain, a temperature range of the liquid crystal phase is wide and the viscosity is small. When R¹ is alkenyl having the branched chain, compatibility with other liquid crystal compounds is good. A preferred configuration of —CH═CH— in the alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity or the like. Cis is preferred in alkenyl such as 2 -butenyl, 2-pentenyl and 2-hexenyl. The alkenyl compound having a preferred configuration has a high clearing point or a wide temperature range of the liquid crystal phase. A detailed description is found in Mol. Cryst. Liq. Cryst., 1985, 131, 109 and Mol. Cryst. Liq. Cryst., 1985, 131 and 327.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. Particularly preferred alkenyl is 3-butenyl or 3-pentenyl. Most preferred alkenyl is 3-butenyl.

In the alkenyl, at least one piece of hydrogen may be replaced by fluorine or chlorine. The example includes a group in which at least two pieces of hydrogen is replaced by both fluorine and chlorine. A group in which at least one piece of hydrogen is replaced by fluorine is further preferred. Preferred examples of alkenyl in which at least one piece of hydrogen is replaced by fluorine include 2,2-difluorovinyl, 3,3-difluoro-2-propenyl, 4,4-difluoro-3-butenyl, 5,5-difluoro-4-pentenyl or 6,6-difluoro-5-hexenyl. Further preferred examples include 2,2-difluorovinyl or 4,4-difluoro-3-butenyl for decreasing the viscosity.

A preferred combination of R¹ and R² is 3-butenyl and 3-butenyl, 3-butenyl and 3-pentenyl, and 3-pentenyl and 3-pentenyl.

In formula (1), ring A¹, ring A² and ring A³ are independently 1,4-phenylene or 1,4-phenylene in which at least one piece of hydrogen is replaced by fluorine or chlorine.

In the above compounds, 1,4-phenylene is preferred from viewpoints of low viscosity. Then, 2-fluoro-1,4-phenylene is preferred from viewpoints of good compatibility with fluorine system liquid crystal compounds. A preferred combination is 1,4-phenylene and 1,4-phenylene from viewpoints of low viscosity.

In formula (1), Z¹ and Z² are independently alkylene having 1 to 4 carbons, and in the alkylene, at least one piece of —CH₂— may be replaced by —O—, —COO— or —OCO—, and at least one piece of —CH₂CH₂— may be replaced by —CH═CH—, and in the groups, at least one piece of hydrogen may be replaced by fluorine or chlorine, and at least one of Z¹ and Z² may be a single bond.

Preferred Z¹ or Z² is a single bond, —OCO—, —CH₂O—, —CF₂O—, —CH₂CH₂—, —CF₂CF₂—, —CF═CF—, —(CH₂)₄— or —CH₂CH═CHCH₂—. Further preferred Z¹ or Z² is a single bond, —OCO—, —CH₂O— or —CH₂CH₂—. Particularly preferred Z¹ or Z² is a single bond, —CH₂O— or —CH₂CH₂—. Most preferred Z¹ or Z² is a single bond or —CH₂CH₂—. In the preferred combination of Z¹ and Z², at least one is preferably a single bond. Further preferred combination of Z¹ and Z² is a single bond and —CH₂O—, or a single bond and —CH₂CH₂—. Most preferred combination is a single bond and —CH₂CH₂—.

In formula (1), a is 1 or 2. Preferred a is 1 for decreasing the viscosity. Preferred a is 2 for increasing the maximum temperature.

Preferred examples of compound (1) include compound (1a), compound (1b) and compound (1c) as described in the above-described items. Further preferred examples include compounds (1d) to (1g). Particularly preferred examples include compounds (1h) to (1k).

2. Synthesis of Compound (1)

A synthesis method of compound (1) will be described. Compound (1) can be prepared by suitably combining methods in synthetic organic chemistry. A method for introducing a required terminal group, ring and bonding group into a starting material is described in books such as “Organic Syntheses” (John Wiley & Sons, Inc.), “Organic Reactions” (John Wiley & Sons, Inc.), “Comprehensive Organic Synthesis” (Pergamon Press) and “New Experimental Chemistry Course (Shin Jikken Kagaku Koza in Japanese)” (Maruzen Co., Ltd.).

2-1. Formation of Bonding Group Z

First, a scheme is shown with regard to a method for forming bonding groups Z¹ and Z². Next, reactions described in the scheme in methods (1) to (11) are described. In the scheme, MSG¹ (or MSG²) is a monovalent organic group having at least one ring. The monovalent organic groups represented by a plurality of MSG¹ (or MSG²) used in the scheme may be identical or different. Compounds (1A) to (1J) correspond to compound (1).

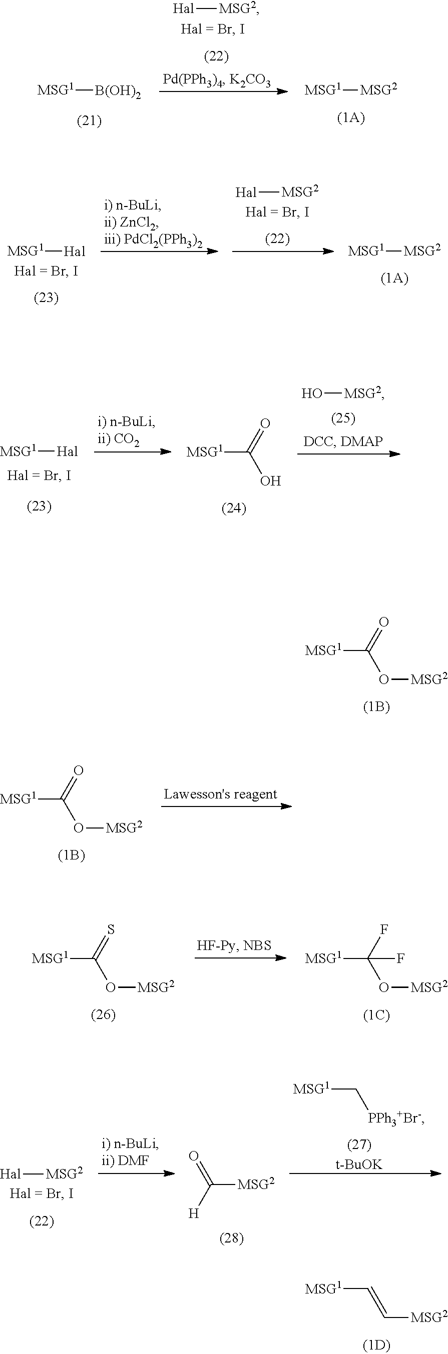

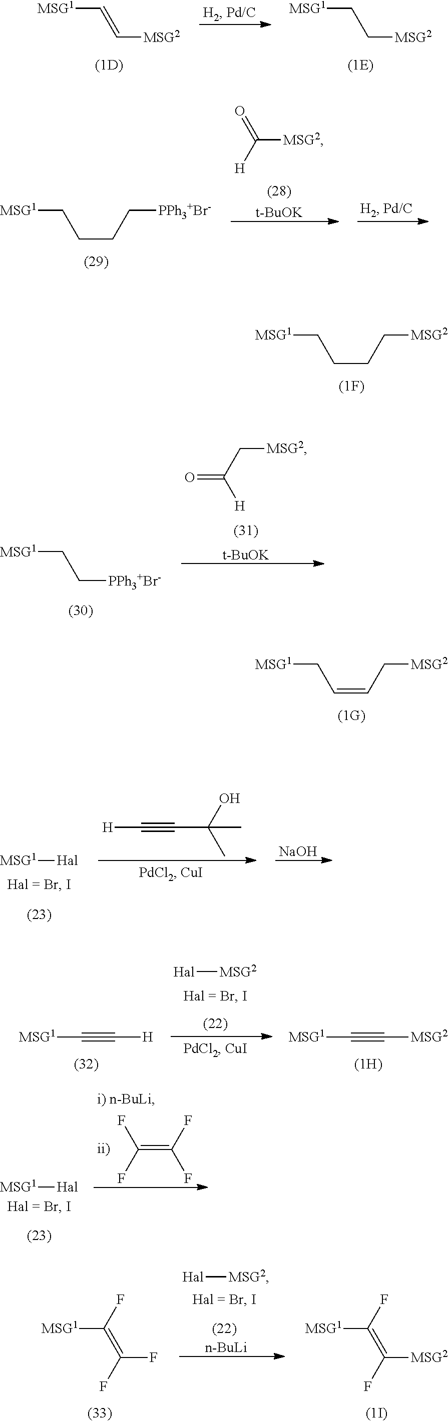

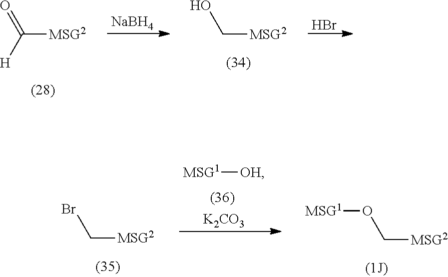

(1) Formation of a Single Bond

Compound (1A) is prepared by allowing aryl boronic acid (21) prepared according to a known method to react with halide (22), in the presence of carbonate and a catalyst such as tetrakis (triphenylphosphine) palladium. Compound (1A) is also prepared by allowing halide (23) prepared according to a known method to react with n-butyllithium and subsequently with zinc chloride, and further with halide (22) in the presence of a catalyst such as dichlorobis (triphenylphosphine) palladium.

(2) Formation of —COO—Carboxylic acid (24) is obtained by allowing halide (23) to react with n-butyllithium and subsequently with carbon dioxide. Compound (1B) is prepared by dehydration of compound (25) prepared according to a known method and carboxylic acid (24) in the presence of 1, 3-dicyclohexylcarbodiimide (DCC) and 4-dimethylaminopyridine (DMAP).

(3) Formation of —CF₂O—

Thionoester (26) is obtained by treating compound (1B) with a thiation reagent such as Lawesson's reagent. Compound (1C) is prepared by fluorinating thionoester (26) with a hydrogen fluoride-pyridine complex and N-bromosuccinimide (NBS). Refer to M. Kuroboshi et al., Chem. Lett., 1992, 827. Compound (1C) is also prepared by fluorinating thionoester (26) with (diethylamino)sulfur trifluoride (DAST). Refer to W. H. Bunnelle et al., J. Org. Chem. 1990, 55, 768. The bonding group can also be formed according to the method described in Peer. Kirsch et al., Angew. Chem. Int. Ed. 2001, 40, 1480.

(4) Formation of —CH═CH—

Aldehyde (28) is obtained by treating halide (22) with n-butyllithium and then allowing the treated halide to react with N,N-dimethylformamide (DMF). Phosphorus ylide is generated by treating phosphonium salt (27) prepared according to a known method with a base such as potassium t-butoxide. Compound (1D) is prepared by allowing the phosphorus ylide to react with aldehyde (28). A cis isomer may be generated depending on reaction conditions, and the cis isomer is isomerized into a trans isomer according to a known method when necessary.

(5) Formation of —CH₂CH₂—

Compound (1E) is prepared by hydrogenating compound (1D) in the presence of a catalyst such as palladium on carbon.

(6) Formation of —(CH₂)₄—

A compound having —(CH₂)₂—CH═CH— is obtained by using phosphonium salt (29) in place of phosphonium salt (27) according to the method in method (4). Compound (1F) is prepared by performing catalytic hydrogenation of the compound obtained.

(7) Formation of —CH₂CH═CHCH₂—

Compound (1G) is prepared by using phosphonium salt (30) in place of phosphonium salt (27) and aldehyde (31) in place of aldehyde (28) according to the method of the method (4). A trans isomer may be generated depending on reaction conditions, and the trans isomer is isomerized to a cis isomer according to a known method when necessary.

(8) Formation of —C≡C—

Compound (32) is obtained by allowing halide (23) to react with 2-methyl-3-butyn-2-ol in the presence of a catalyst including dichloropalladium and copper halide, and then performing deprotection under basic conditions. Compound (1H) is prepared by allowing compound (32) to react with halide (22) in the presence of the catalyst including dichloropalladium and copper halide.

(9) Formation of —CF═CF—

Compound (33) is obtained by treating halide (23) with n-butyllithium and then allowing the treated halide to react with tetrafluoroethylene. Compound (1I) is prepared by treating halide (22) with n-butyllithium, and then allowing the treated halide to react with compound (33).

(10) Formation of —OCH₂—

Compound (34) is obtained by reducing aldehyde (28) with a reducing agent such as sodium borohydride. Bromide (35) is obtained by brominating compound (34) with hydrobromic acid or the like. Compound (1J) is prepared by allowing bromide (35) to react with compound (36) in the presence of a base such as potassium carbonate.

(11) Formation of —CF₂CF₂—

A compound having —(CF₂)₂— is obtained by fluorinating diketone (—COCO—) with sulfur tetrafluoride, in the presence of a hydrogen fluoride catalyst, according to the method described in J. Am. Chem. Soc., 2001, 123, 5414.

2-2. Synthesis Scheme of Compound (1)

A starting material is commercially available or a formation method is well known with regard to a ring such as 1, 4-phenylene, 2-fluoro-1,4-phenylene or 2, 3-difluoro-1,4-phenylene. Compound (1) can be synthesized by connecting such a ring with a bonding group according to the above-described method. An example is as follows.

A method for introducing identical alkenyl into both terminals is as described below. Formyl groups (—CHO) in ring A¹ and ring A³ are protected by acetal (g=0), and formation reaction of bonding group Z¹ or Z² is carried out to obtain a tricyclic compound. The obtained compound is deprotected by using formic acid, and the resulting material is reduced by using sodium borohydride (SBH) to obtain a diol. The diol is allowed to react with hydrobromic acid to obtain a bromide. The bromide is allowed to react with a Grignard reagent to obtain a compound having identical alkenyl at both terminals. When a compound having different alkenyl at both terminals is synthesized, a functional group is stepwisely introduced by using acetal having different carbon numbers.

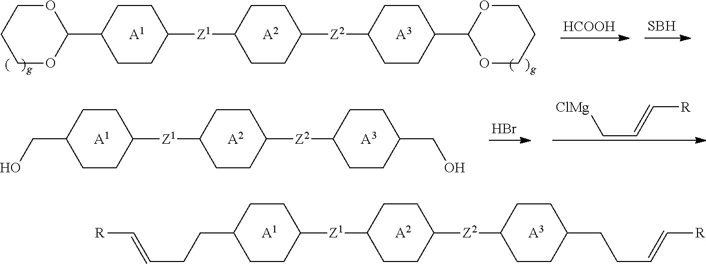

3. Liquid Crystal Composition

3-1. Component Compound

A liquid crystal composition according to the invention is described. The composition contains at least one compound (1) as component A. The composition may contain two, three or more compounds (1). A component in the composition may be only compound (1). In order to develop good physical properties, the composition preferably contains at least one of compounds (1) in the range of about 1% by weight to about 50% by weight. The dielectric anisotropy of compound (1) is small. In a composition having a positive dielectric anisotropy, a preferred content of compound (1) is in the range of about 5% by weight to about 50% by weight. In a composition having a negative dielectric anisotropy, a preferred content of compound (1) is in the range of about 5% by weight to about 40% by weight.

TABLE 1
Dielectric anisotropy of component compounds

| Component of | | Dielectric |
|---|---|---|
| compositions | Component compounds | anisotropy |
| Component A | Compound (1) | Small |
| Component B | Compound (2) to compound (4) | Positively large |
| Component C | Compound (5) | Positively large |
| Component D | Compound (6) to compound (12) | Negatively large |
| Component E | Compound (13) to compound (15) | Small |

The composition contains compound (1) as component A. The composition preferably further contains a liquid crystal compound selected from components B, C, D and E described in Table 1. When the composition is prepared, components B, C, D and E are preferably selected by taking into account a positive or negative dielectric anisotropy and magnitude of the dielectric anisotropy. The composition may contain a liquid crystal compound different from compounds (1) to (15). The composition may not contain such a liquid crystal compound.

Component B is a compound having a halogen-containing group or a fluorine-containing group at a right terminal. Preferred examples of component B include compounds (2-1) to (2-16), compounds (3-1) to (3-113) and compounds (4-1) to (4-57). In the above compounds, R¹¹ is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine. X¹¹ is fluorine, chlorine, —OCF₃, —OCHF₂, —CF₃, —CHF₂, —CH₂F, —OCF₂CHF₂ or —OCF₂CHFCF₃.

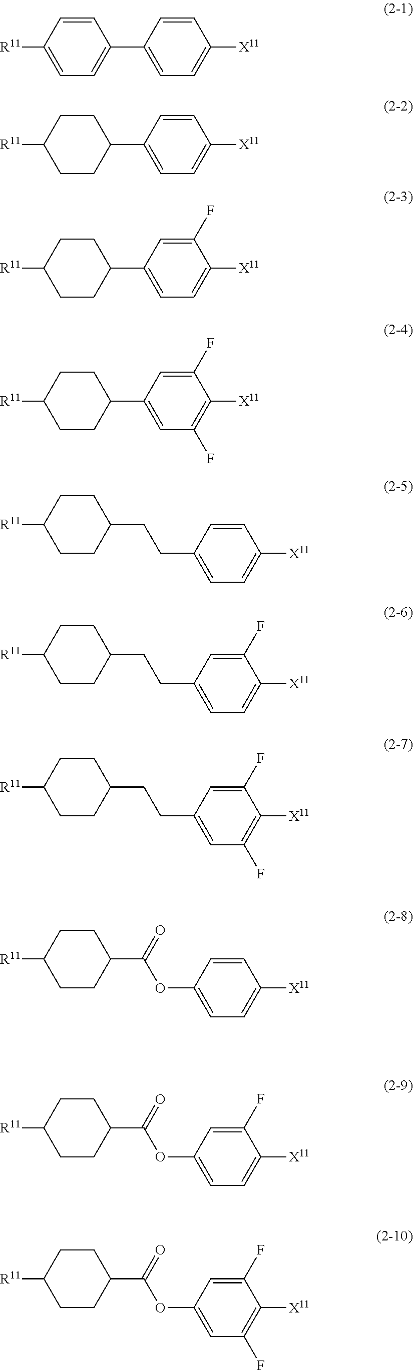

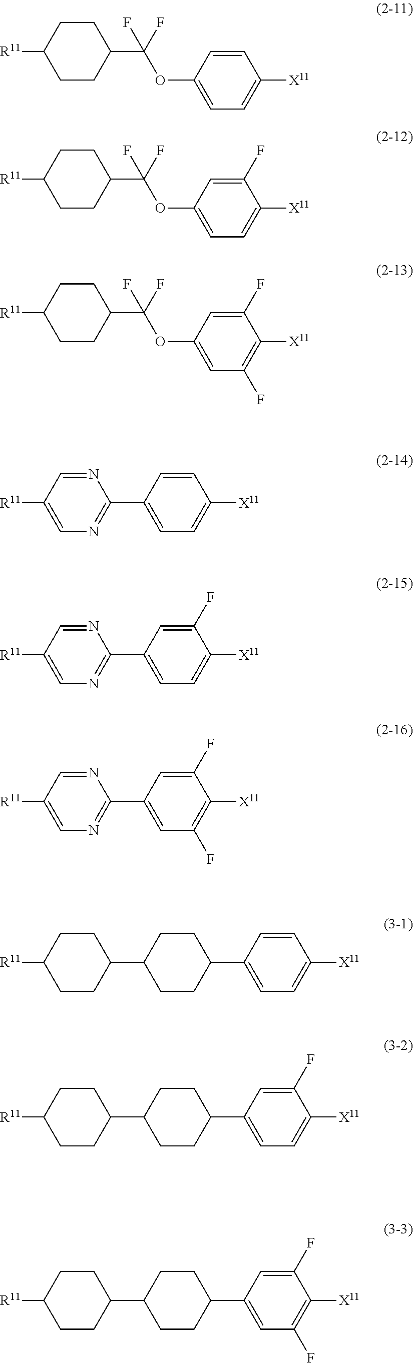

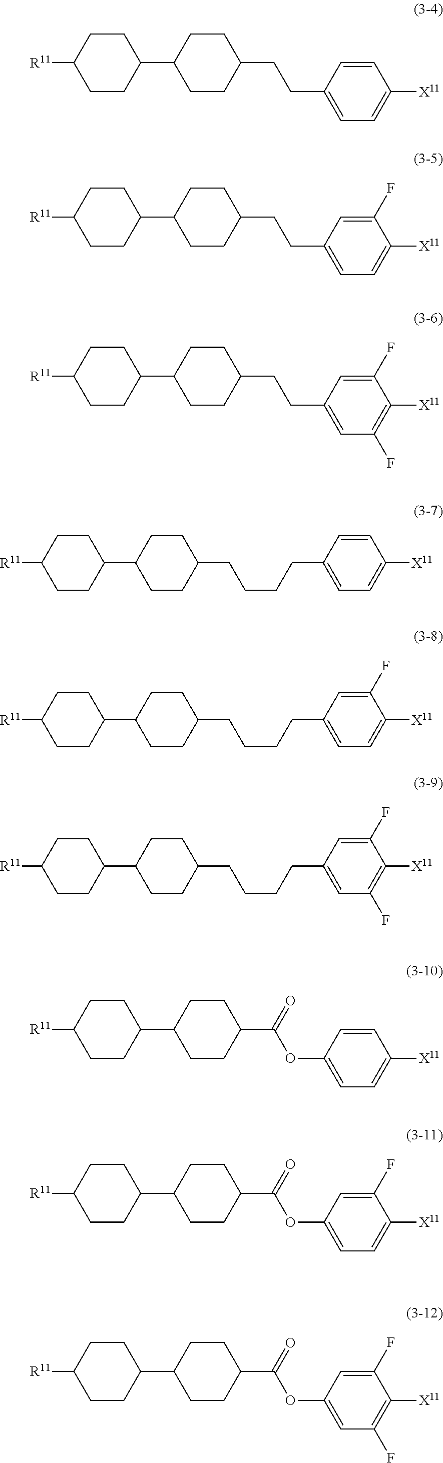

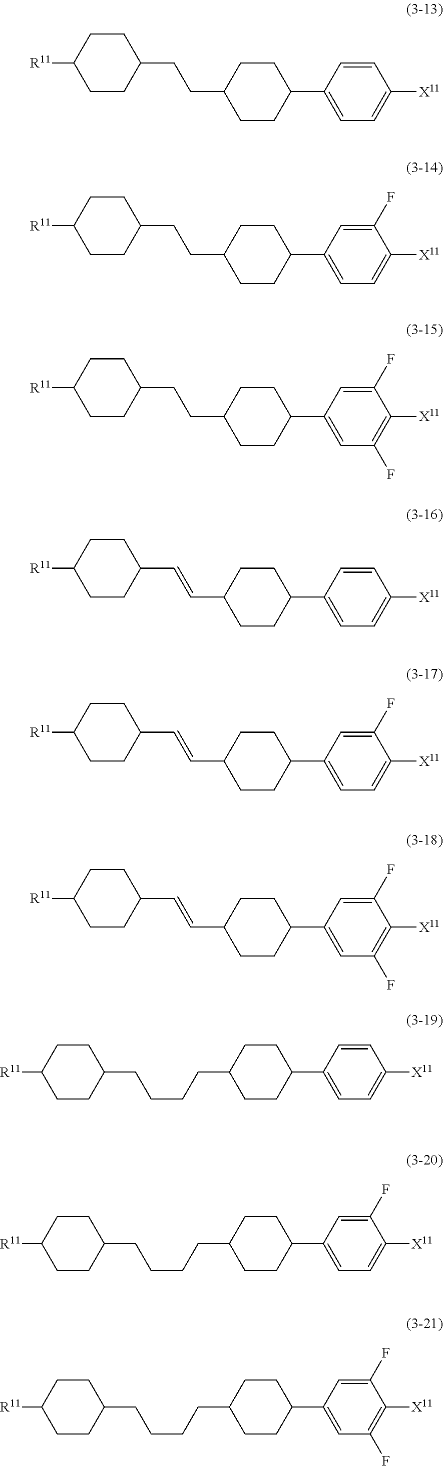

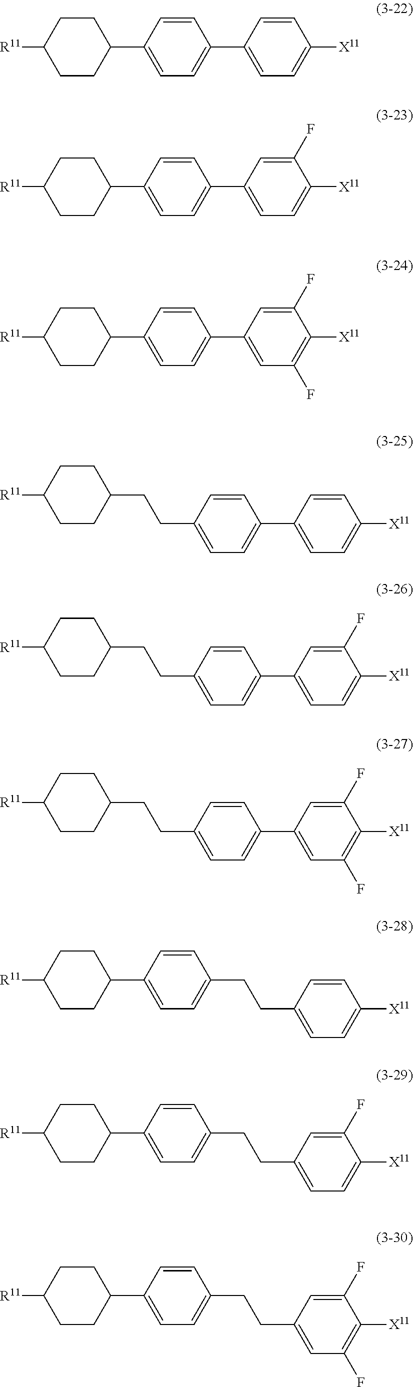

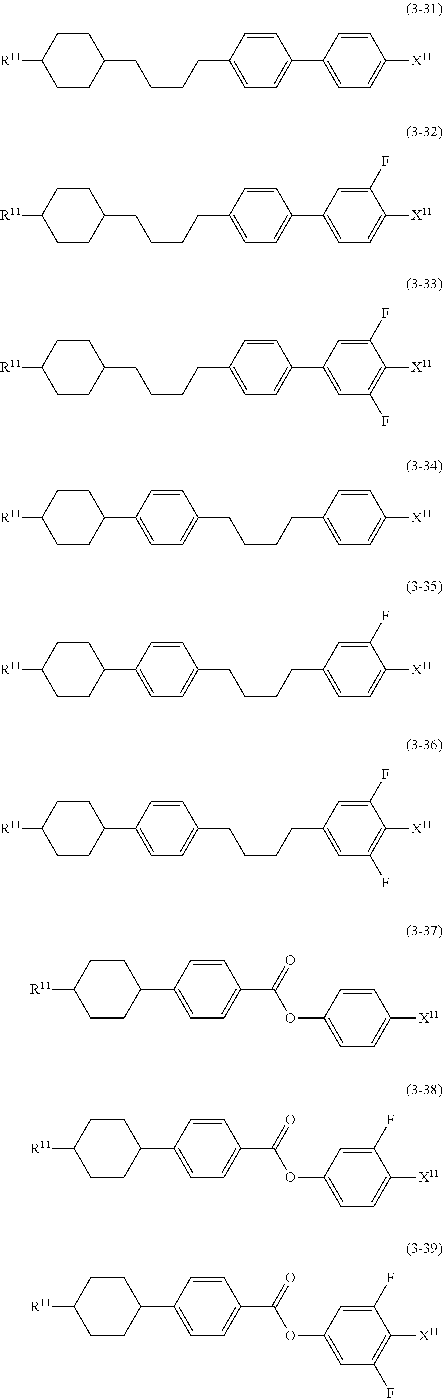

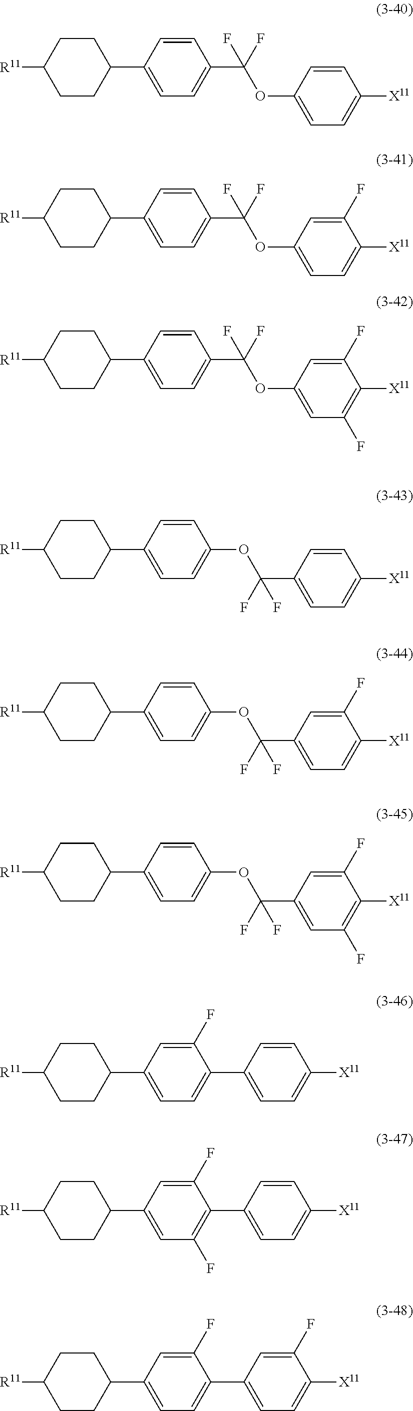

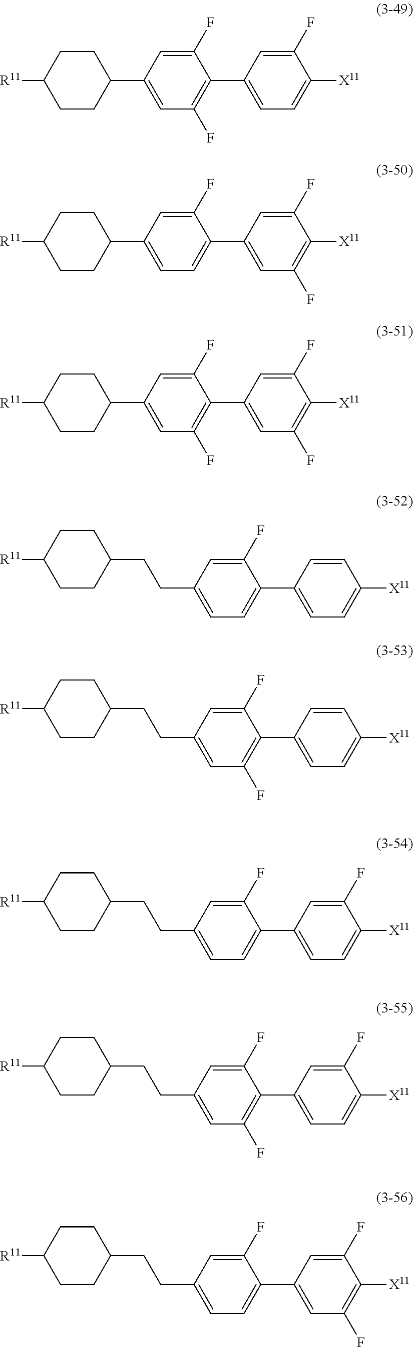

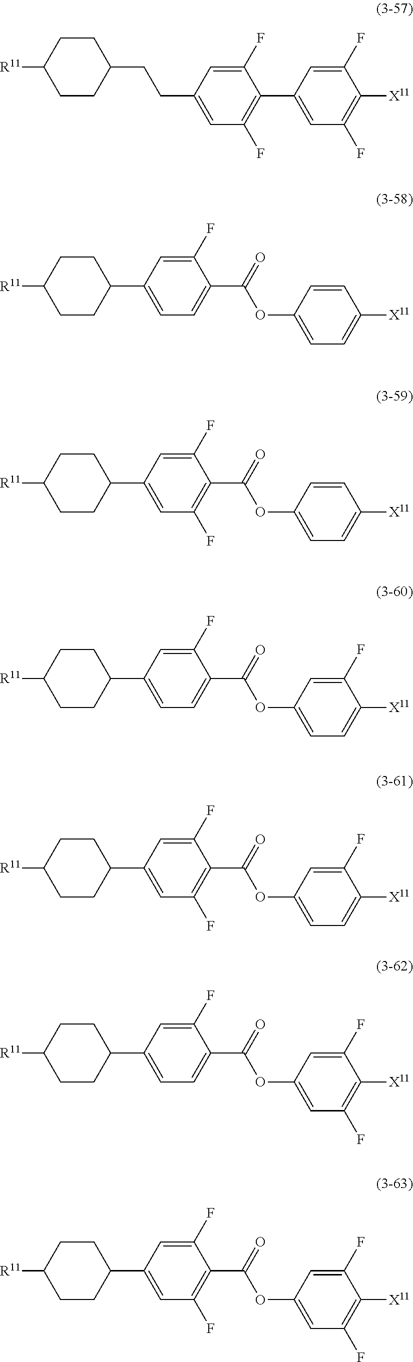

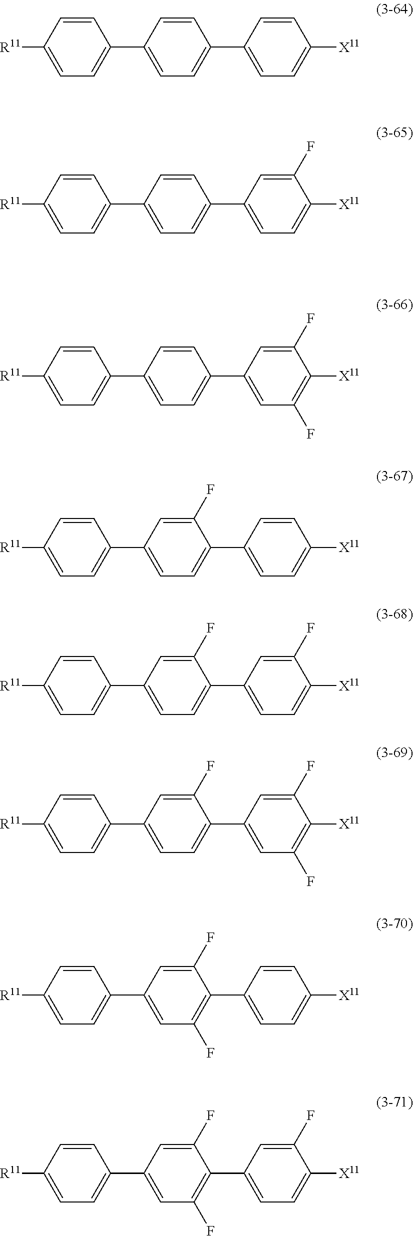

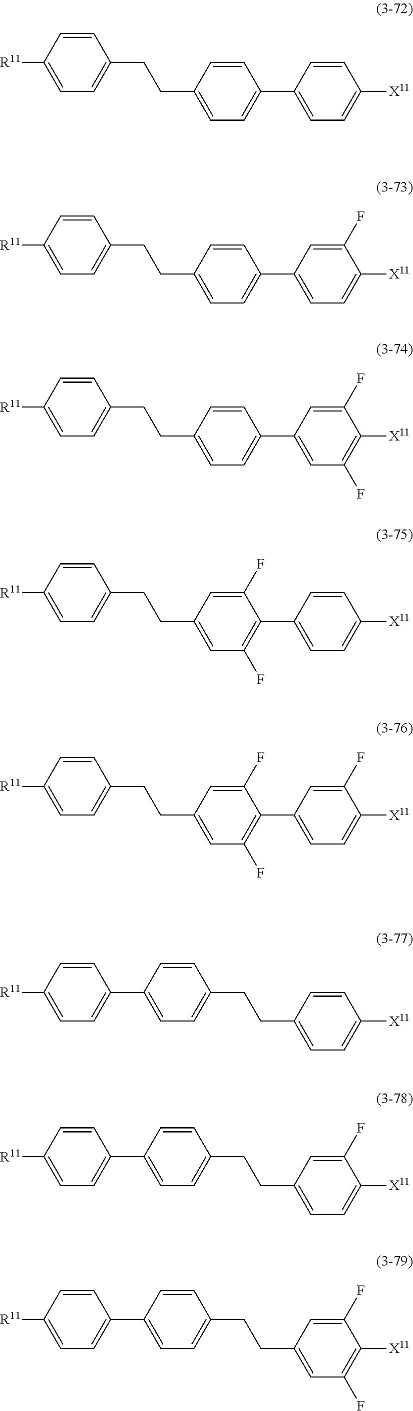

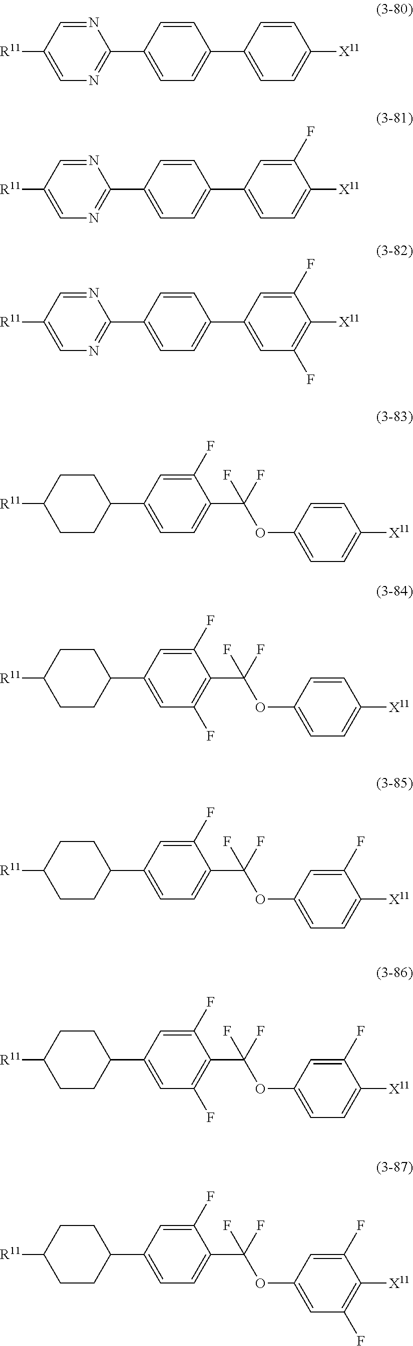

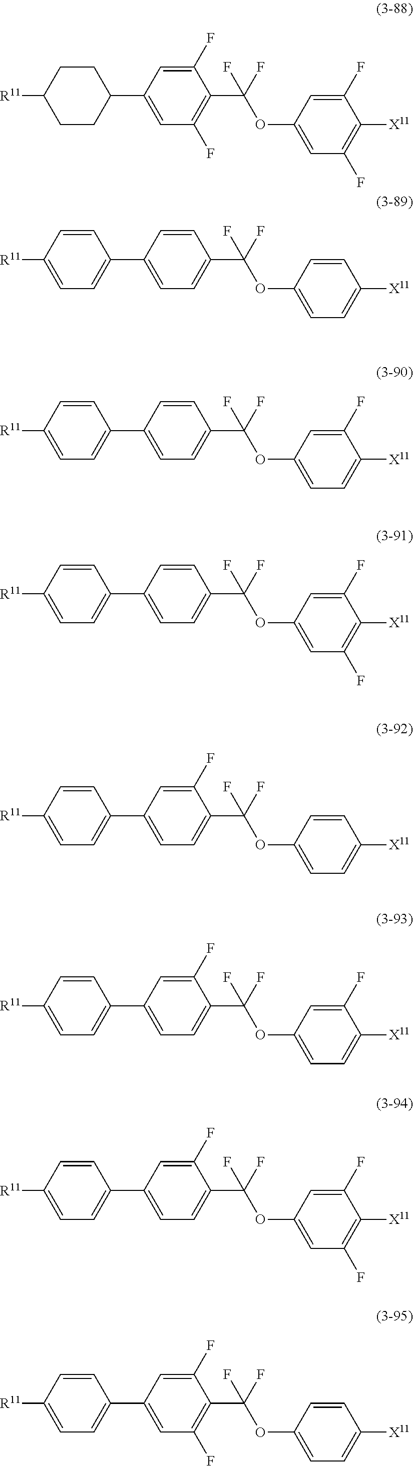

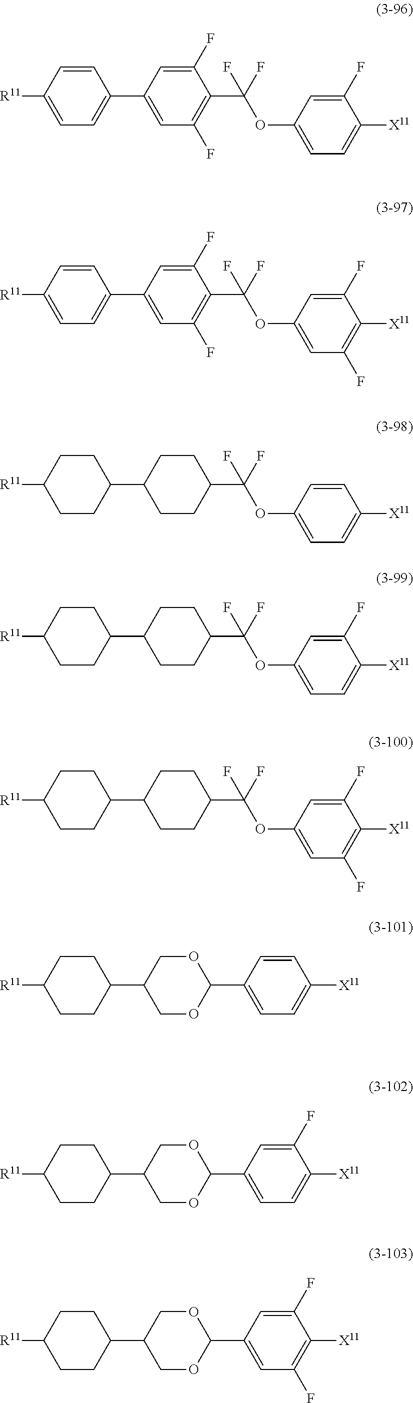

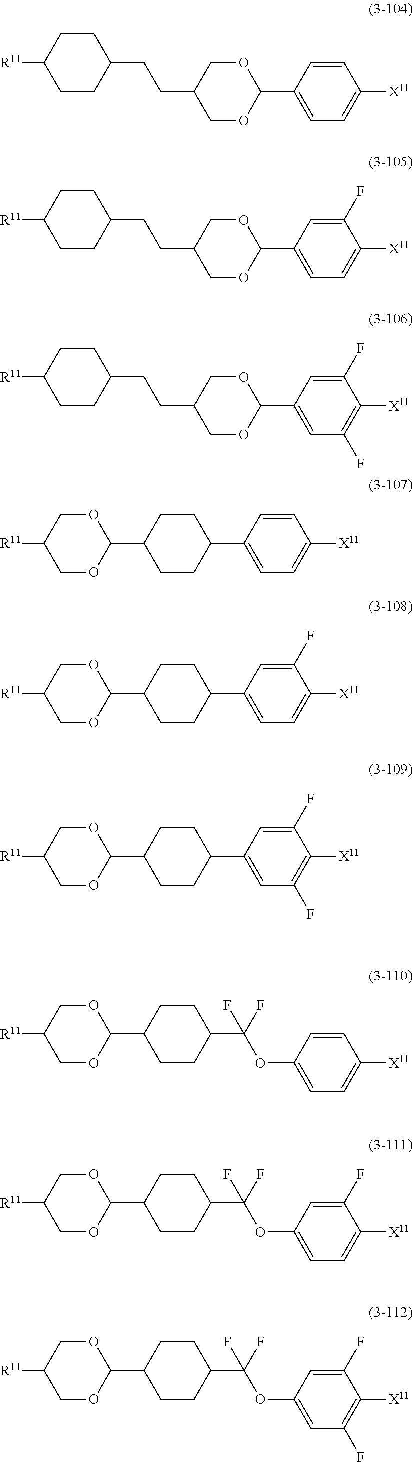

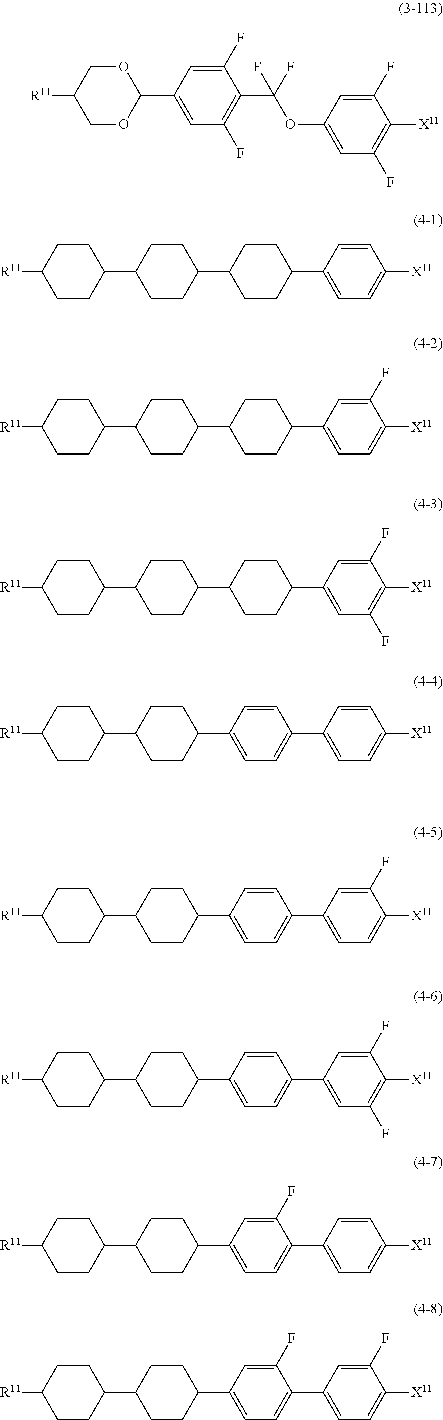

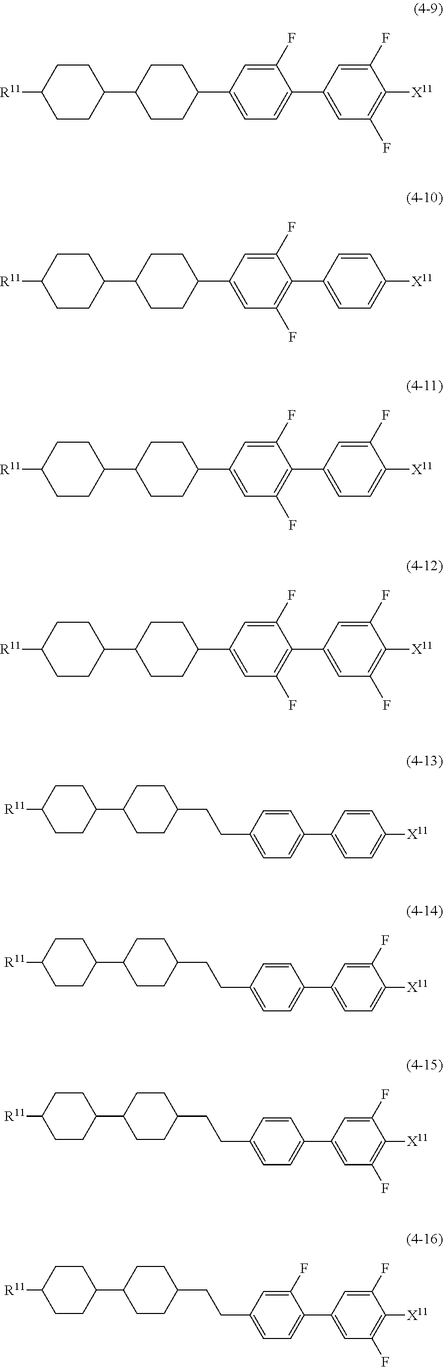

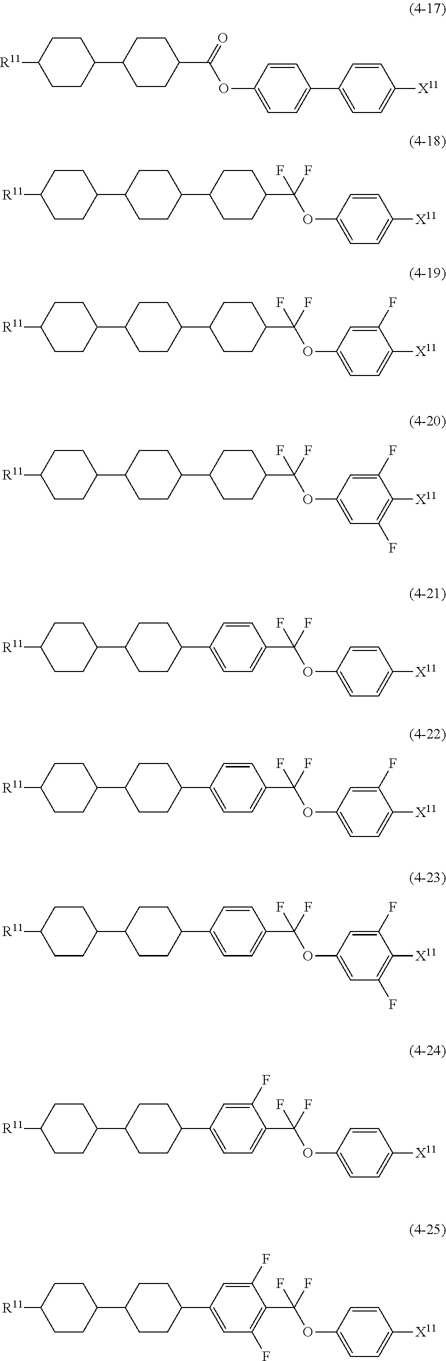

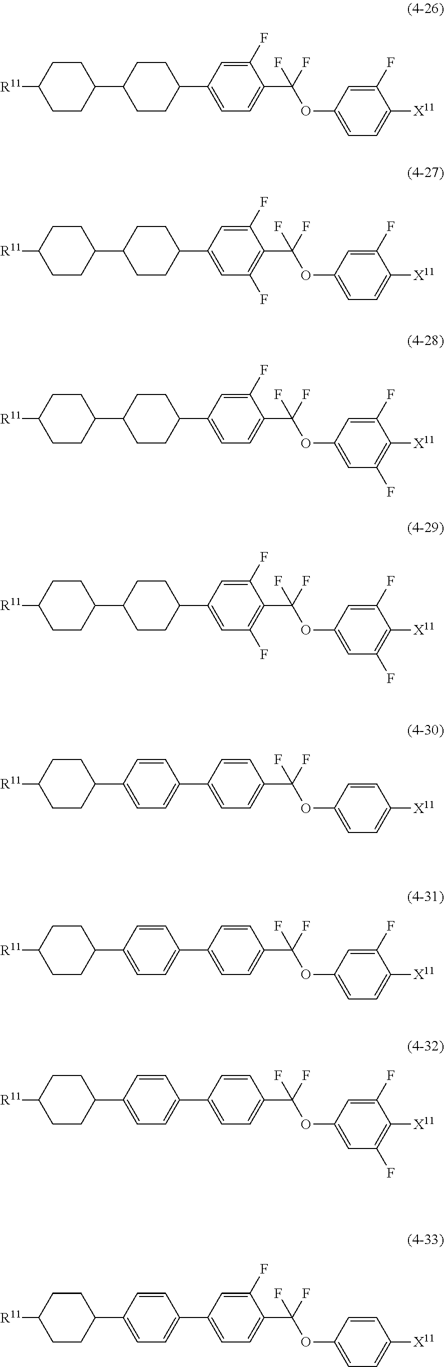

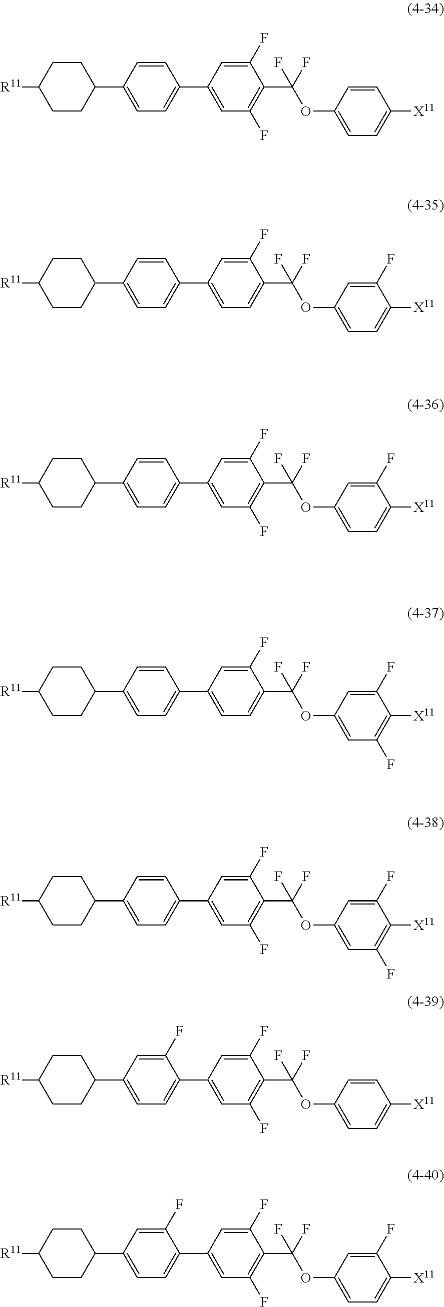

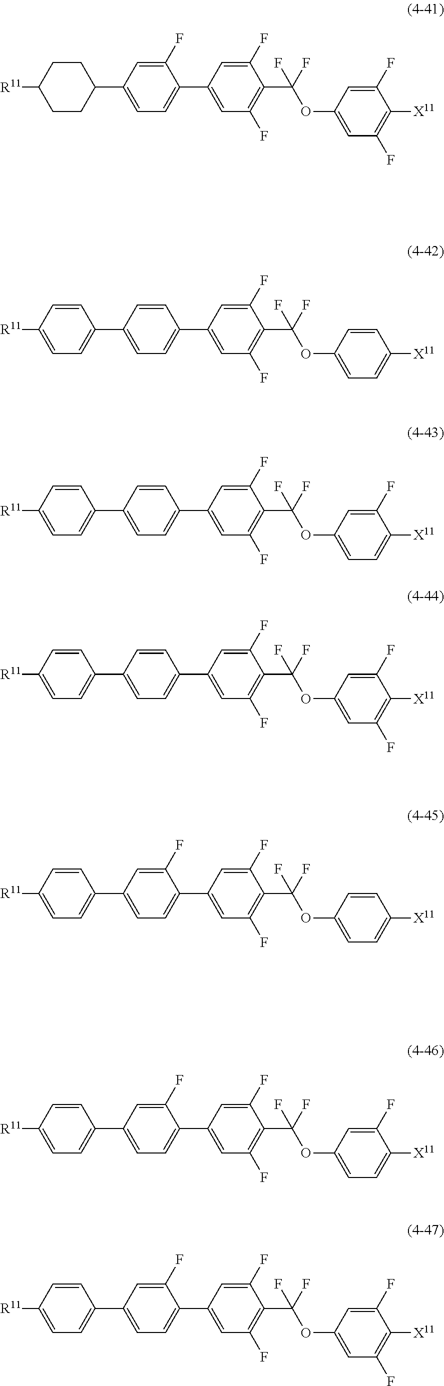

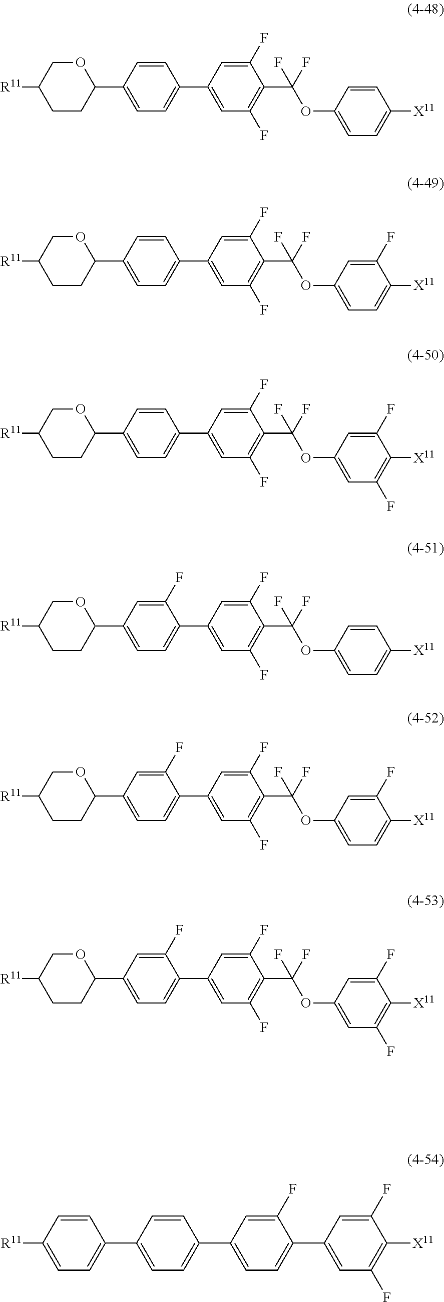

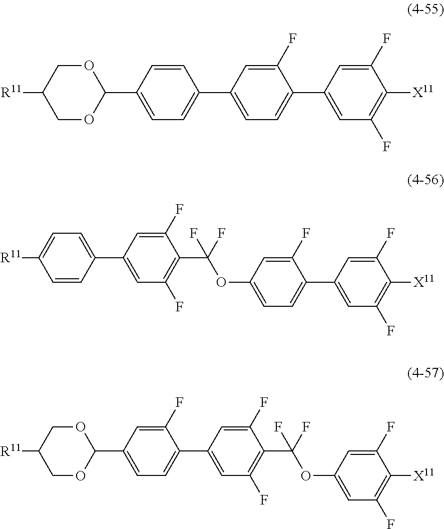

Component B has the positive dielectric anisotropy, and very good stability to heat and light, and therefore is used when a composition for the IPS mode, the FFS mode, the OCB mode or the like is prepared. A content of component B is suitably in the range of about 1% by weight to about 99% by weight, preferably in the range of about 10% by weight to about 97% by weight, and further preferably in the range of about 40% by weight to about 95% by weight, based on the weight of the liquid crystal composition. When component B is added to a composition having the negative dielectric anisotropy, the content of component B is preferably about 30% by weight or less. Addition of component B allows adjustment of the elastic constant of the composition and adjustment of a voltage-transmittance curve of the device.

Component C is compound (5) in which a right-terminal group is —C≡N or —C≡C—C≡N. Specific preferred examples of compound (C) include compounds (5-1) to (5-64). In the groups, R¹² is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine. X¹² is —C≡N or —C≡C—C≡N.

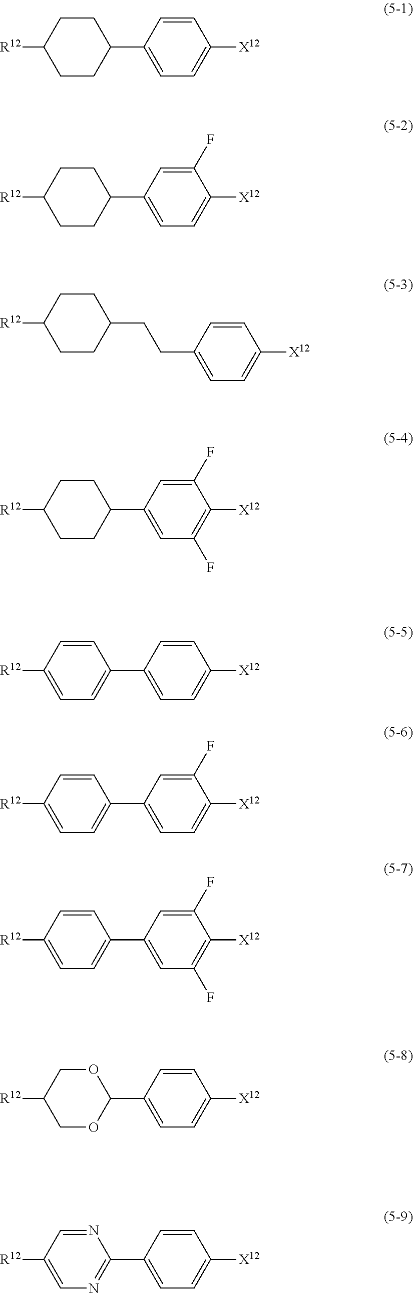

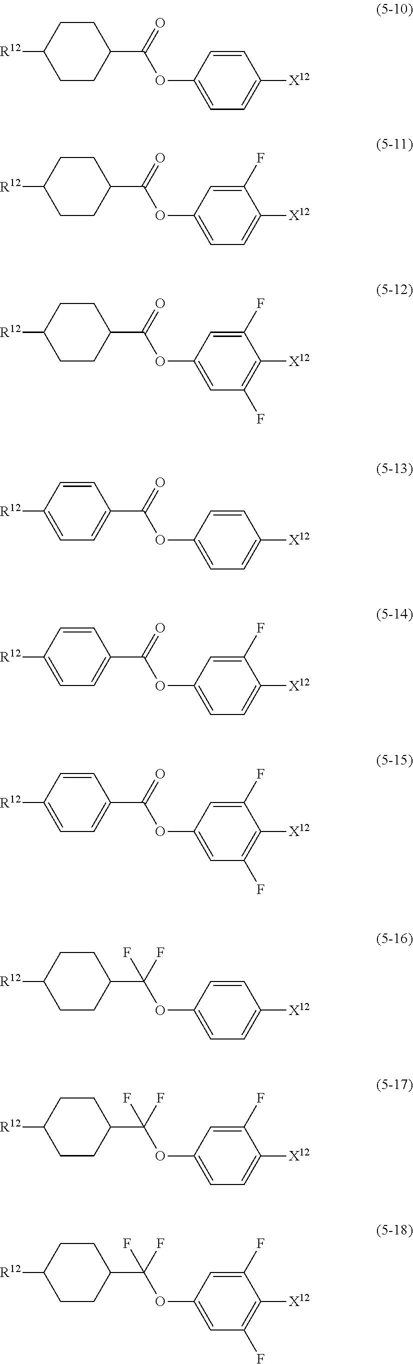

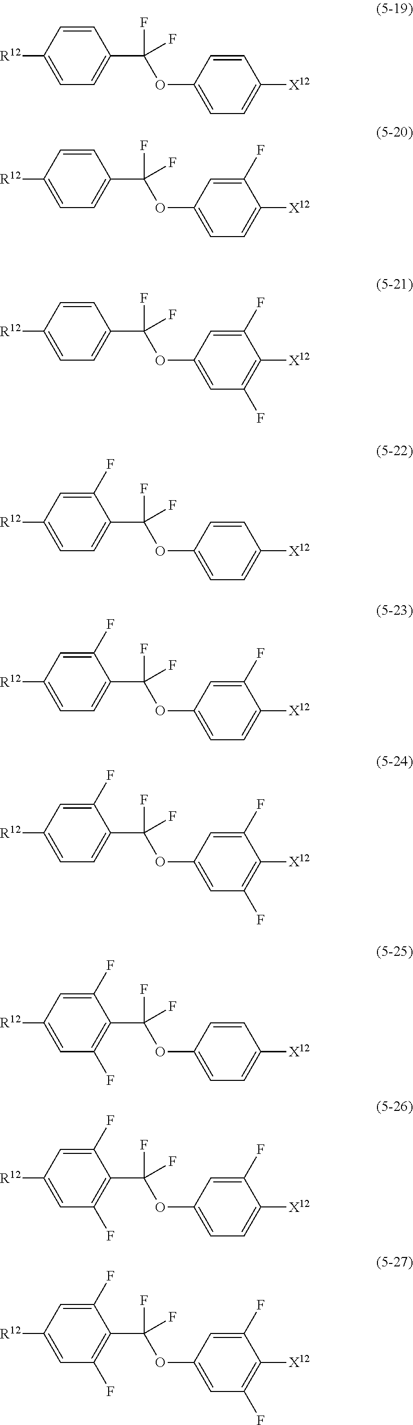

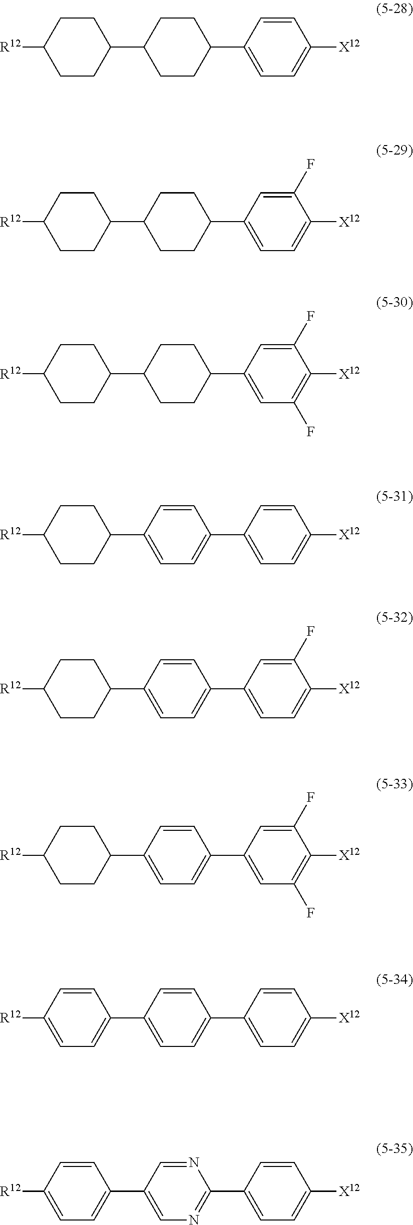

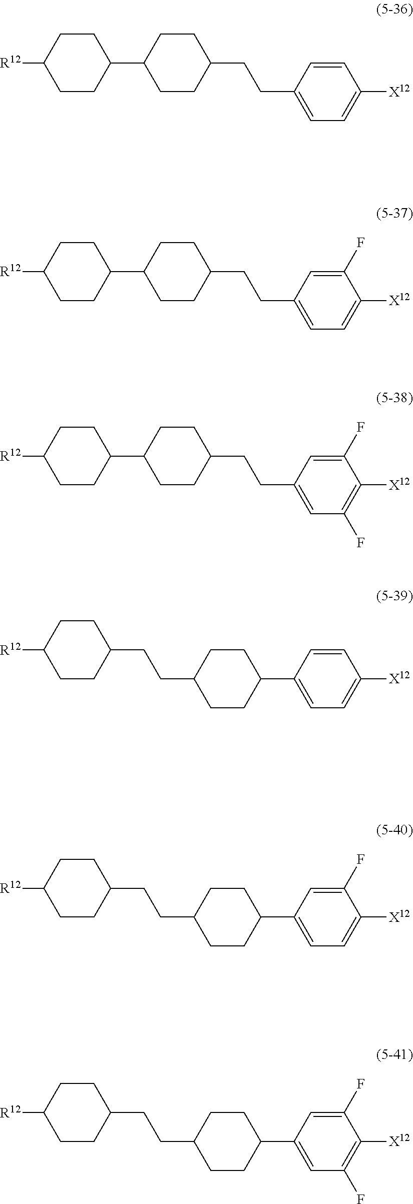

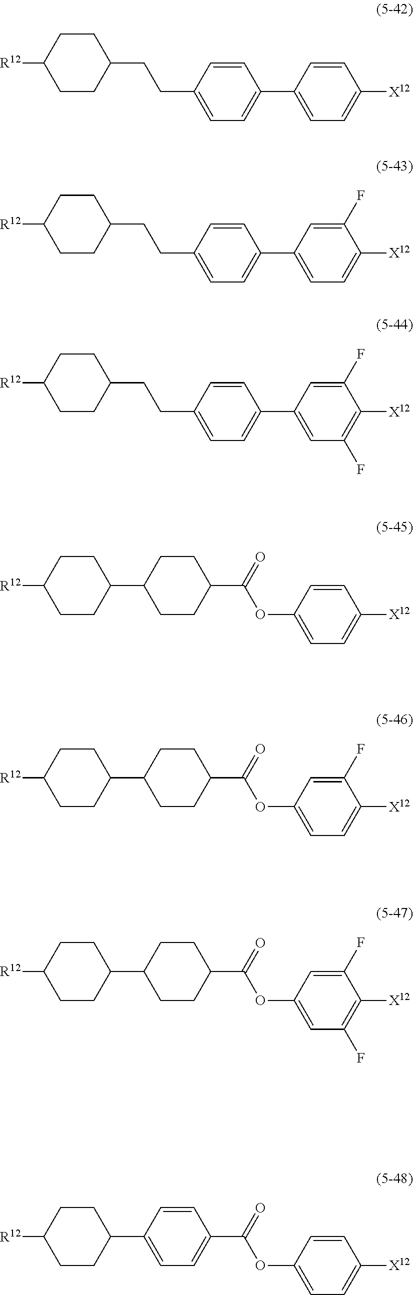

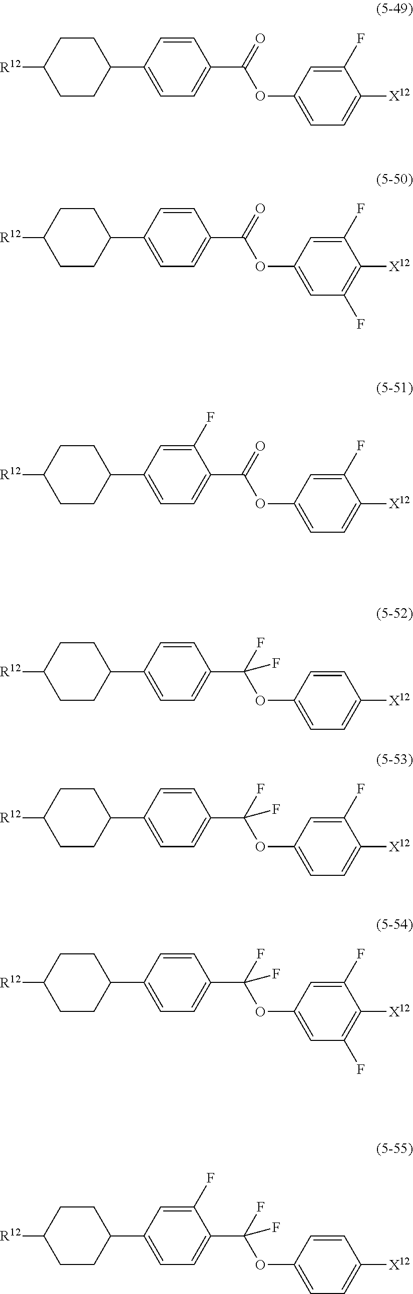

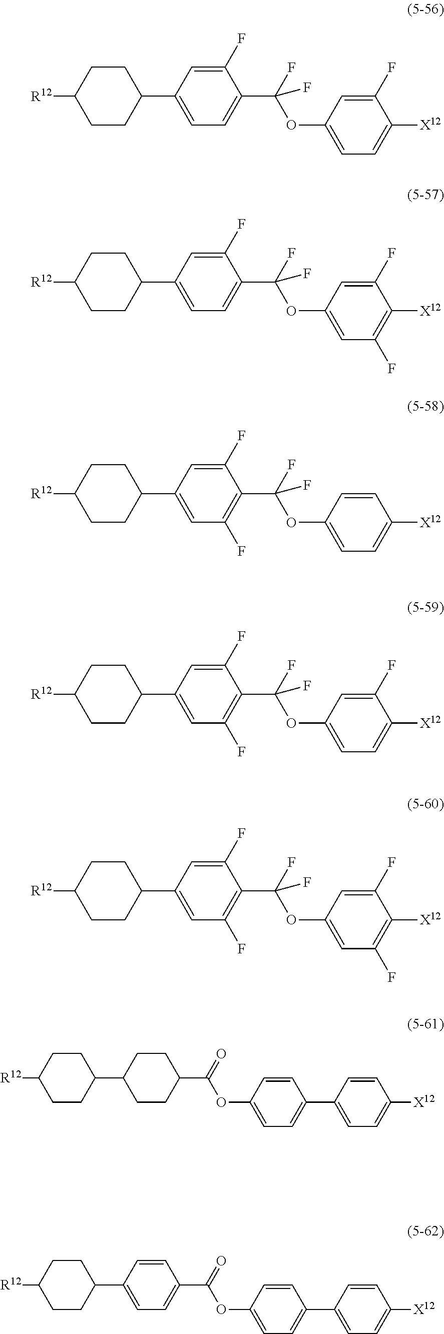

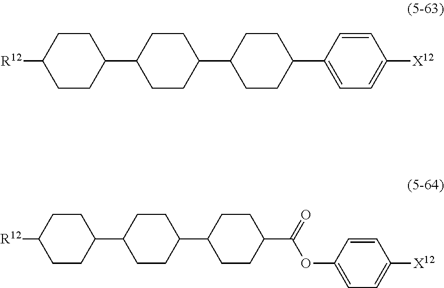

Component C has the positive dielectric anisotropy and a value thereof is large, and therefore is used when a composition for the TN mode or the like is prepared. Addition of component C can increase the dielectric anisotropy of the composition. Component C is effective in extending the temperature range of the liquid crystal phase, adjusting the viscosity or adjusting the optical anisotropy. Component C is also useful for adjustment of the voltage-transmittance curve of the device.

When a composition for the TN mode or the like is prepared, a content of component C is suitably in the range of about 1% by weight to about 99% by weight, preferably in the range of about 10% by weight to about 97% by weight, and further preferably in the range of about 40% by weight to about 95% by weight, based on the weight of the liquid crystal composition. When component C is added to a composition having the negative dielectric anisotropy, the content of component C is preferably about 30% by weight or less. Addition of component C allows adjustment of the elastic constant of the composition and adjustment of the voltage-transmittance curve of the device.

Component D is compounds (6) to (12). The compounds have phenylene in which hydrogen in lateral positions are replaced by two pieces of halogen, such as 2, 3-difluoro-1,4-phenylene. Specific preferred examples of component D include compounds (6-1) to (6-8), compounds (7-1) to (7-17), compound (8-1), compounds (9-1) to (9-3), compounds (10-1) to (10-11), compounds (11-1) to (11-3) and compounds (12-1) to (12-3). In the compounds, R¹³, R¹⁴ and R¹⁵ are independently alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine, and R¹⁵ may be hydrogen or fluorine.

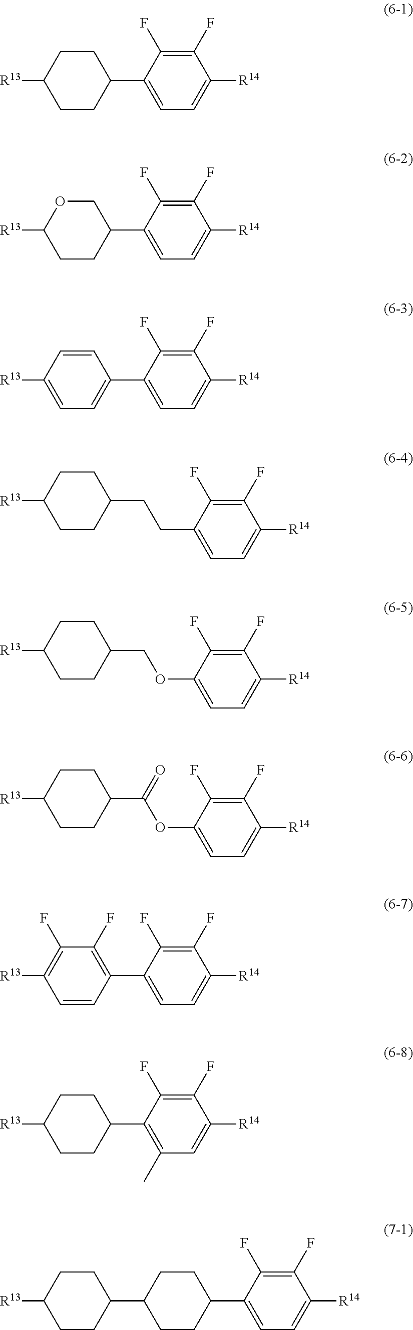

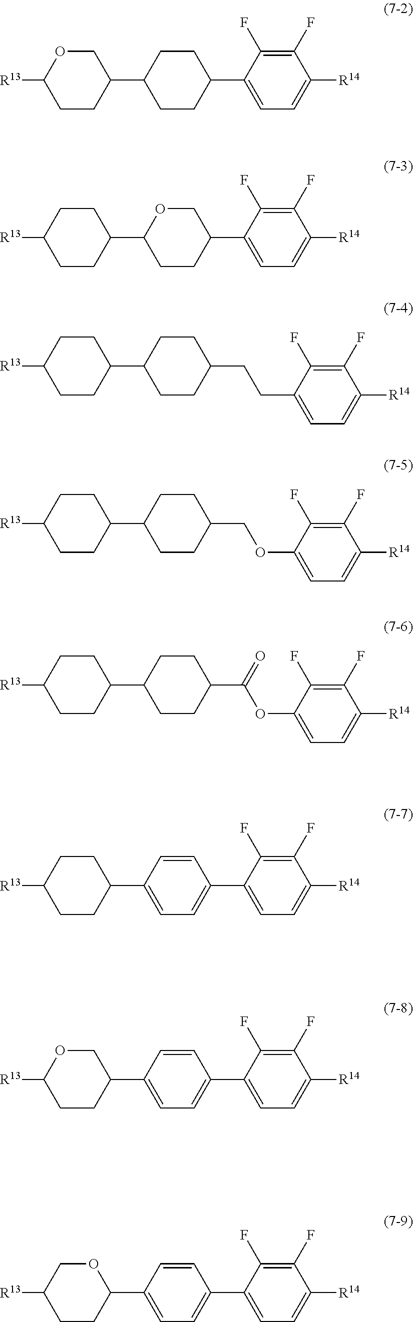

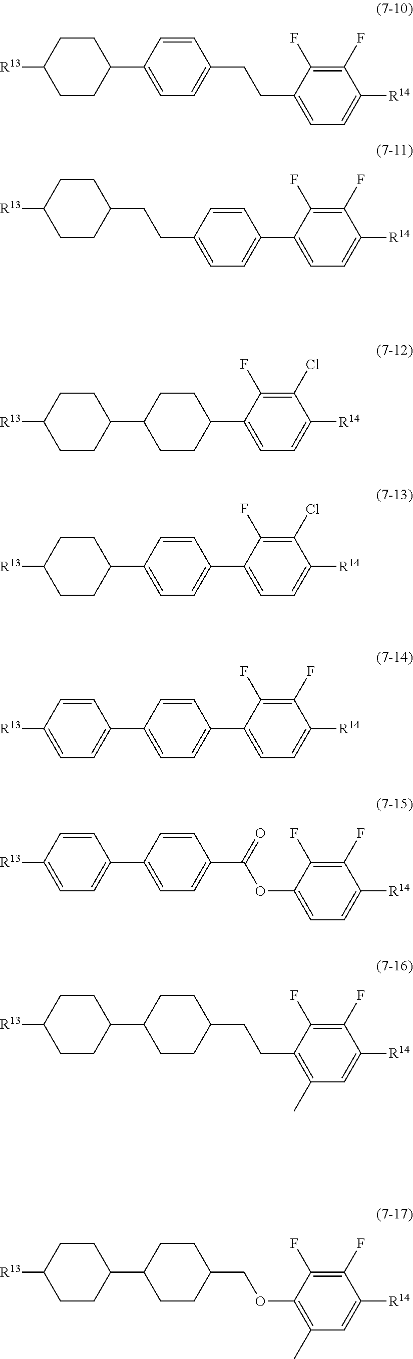

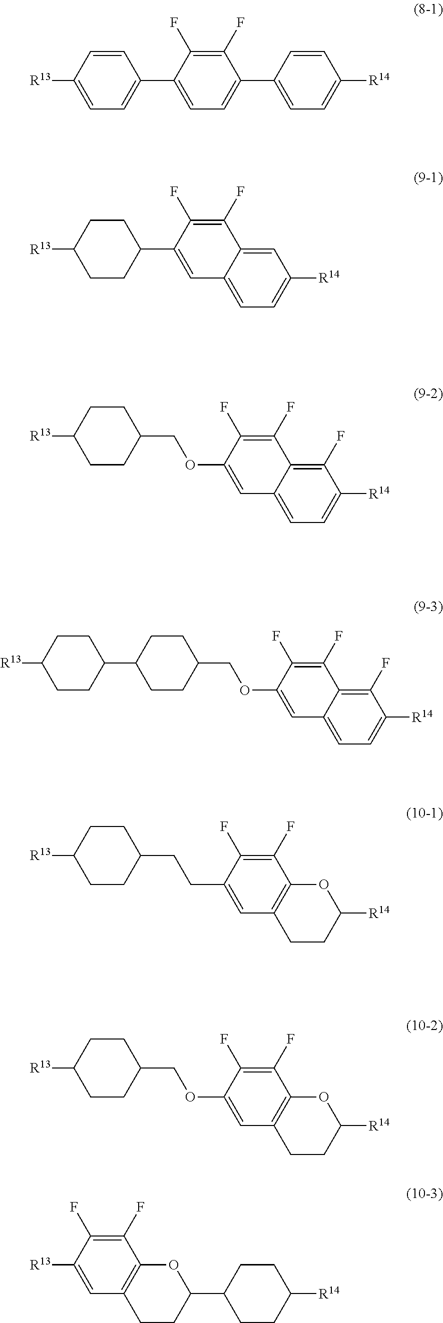

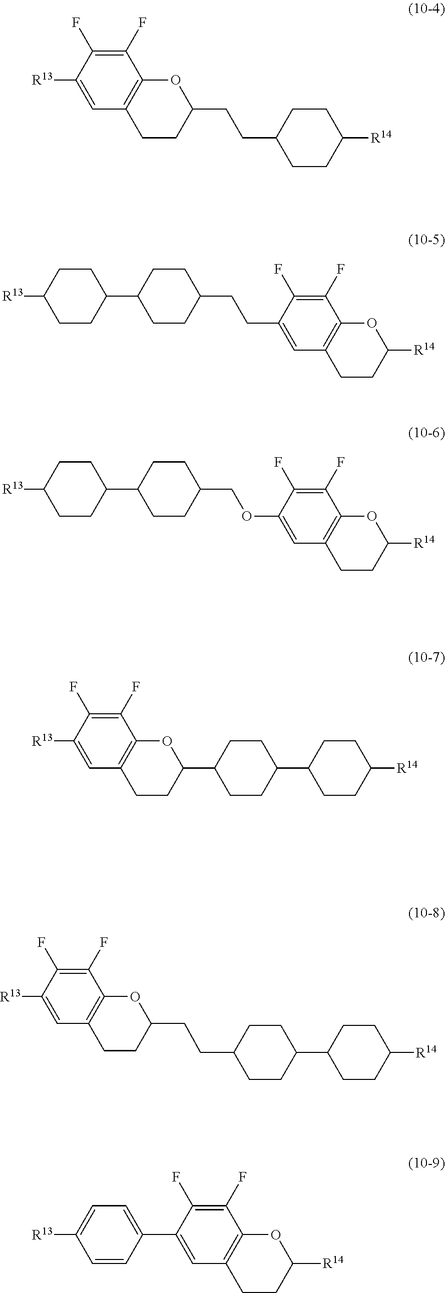

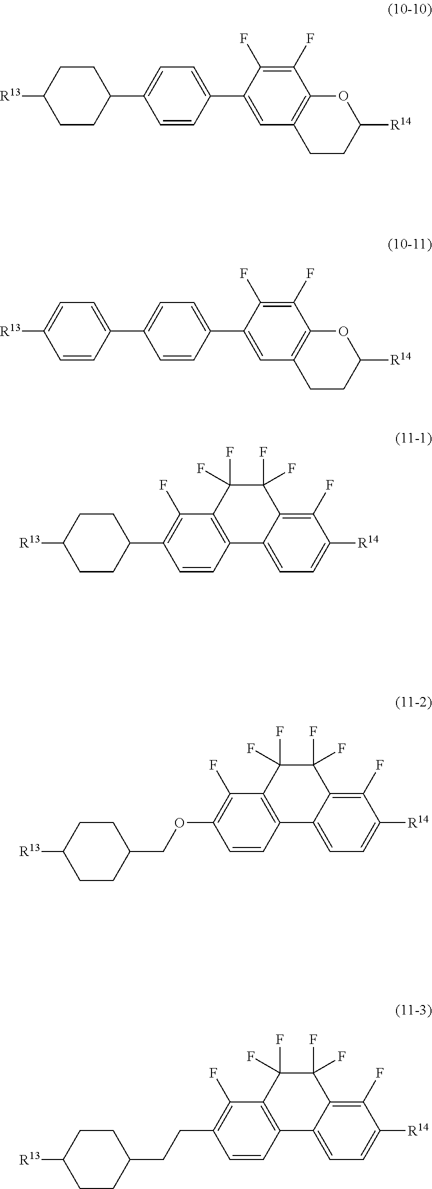

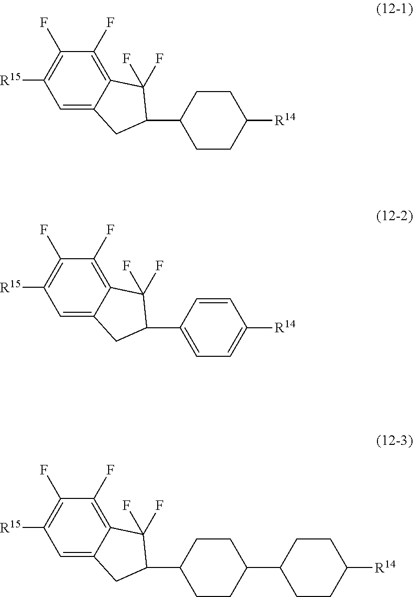

Component D has a large negative dielectric anisotropy. Component D is used when a composition for the IPS mode, the FFS mode, the VA mode or the like is prepared. As a content of component D is increased, the dielectric anisotropy of the composition is negatively increased, but the viscosity is increased. Thus, as long as a desired value of threshold voltage of the device is met, the content is preferably as small as possible. When the dielectric anisotropy at a degree of −5 is taken into account, the content is preferably about 40% by weight or more in order to allow a sufficient voltage driving.

Among types of component D, compound (6) is a bicyclic compound, and therefore is effective in decreasing the viscosity, adjusting the optical anisotropy or increasing the dielectric anisotropy. Compounds (7) and (8) are a tricyclic compound, and therefore are effective in increasing the maximum temperature, the optical anisotropy or the dielectric anisotropy. Compounds (9) to (12) are effective in increasing the dielectric anisotropy.

When a composition for the IPS mode, the FFS mode, the VA mode or the like is prepared, the content of component D is preferably about 40% by weight or more, and further preferably in the range of about 50% by weight to about 95% by weight, based on the weight of the liquid crystal composition. When component D is added to a composition having the positive dielectric anisotropy, the content of component D is preferably about 30% by weight or less. Addition of component D allows adjustment of the elastic constant of the composition and adjustment of a voltage-transmittance curve of the device.

Component E is a compound in which two pieces of a terminal group is alkyl or the like. Specific preferred examples of component E include compounds (13-1) to (13-11), compounds (14-1) to (14-19) and compounds (15-1) to (15-7). In the compounds, R¹⁶ and R¹⁷ are independently alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine.

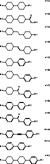

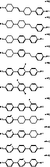

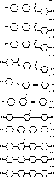

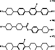

Component E has a small dielectric anisotropy. Component E is close to neutrality. Compound (13) is effective in decreasing the viscosity or adjusting the optical anisotropy. Compounds (14) and (15) are effective in extending the temperature range of the nematic phase by increasing a maximum temperature, or adjusting the optical anisotropy.

As a content of component E is increased, the viscosity of the composition is decreased, but dielectric anisotropy thereof is decreased. Thus, as long as a desired value of threshold voltage of the device is met, the content is preferably as large as possible. When a composition for the IPS mode, the VA mode or the like is prepared, the content of component E is preferably about 30% by weight or more, and further preferably about 40% by weight or more, based on the weight of the liquid crystal composition.

A combination of compound (1) with a compound suitably selected from components B, C, D and E allows preparation of the liquid crystal composition that satisfies at least one of physical properties such as a high stability to heat and light, a high maximum temperature, a low minimum temperature, a small viscosity, a suitable optical anisotropy (namely, a large optical anisotropy or a small optical anisotropy), a large positive or negative dielectric anisotropy, a large specific resistance and a suitable elastic constant (namely, a large elastic constant or a small elastic constant). A device including such a composition has a wide temperature range in which the device can be used, a short response time, a large voltage holding ratio, a low threshold voltage, a large contrast ratio, a small flicker rate and a long service life.

If the device is used for a long period of time, a flicker may be occasionally generated on a display screen. The flicker rate (%) can be represented by a formula (|: luminance when applying a positive voltage−|: luminance when applying a negative voltage)/(average luminance)×100. In a device having the flicker rate in the range of about 0% to about 1%, a flicker is hardly generated on the display screen even if the device is used for a long period of time. The flicker is associated with image persistence, and is presumed to be generated according to a difference in electric potential between a positive frame and a negative frame in driving at alternating current. The composition containing compound (1) is also useful for a decrease in generation of the flicker.

3-2. Additive

A liquid crystal composition is prepared according to a publicly known method. For example, the component compounds are mixed and dissolved in each other by heating. According to an application, an additive may be added to the composition. Specific examples of the additive include the polymerizable compound, the polymerization initiator, the polymerization inhibitor, the optically active compound, the antioxidant, the ultraviolet light absorber, the light stabilizer, the heat stabilizer, the dye and the antifoaming agent. Such additives are well known to those skilled in the art, and described in literature.

In a liquid crystal display device having the polymer sustained alignment (PSA) mode, the composition contains a polymer. The polymerizable compound is added for the purpose of forming the polymer in the composition. First, a composition to which a small amount of polymerizable compound is added is injected into the device. Next, the composition is irradiated with ultraviolet light while voltage is applied between substrates of the device. The polymerizable compound is polymerized to form a network structure of the polymer in the composition. In the composition, alignment of liquid crystal molecules can be controlled by the polymer, and therefore the response time of the device is shortened and also image persistence is improved.

Specific preferred examples of polymerizable compounds include acrylate, methacrylate, a vinyl compound, a vinyloxy compound, propenyl ether, an epoxy compound (oxirane, oxetane) and vinyl ketone. Further preferred examples include a compound having at least one piece of acryloyloxy, and a compound having at least one piece of methacryloyloxy. Still further preferred examples also include a compound having both acryloyloxy and methacryloyloxy.

Still further preferred examples include compounds (M-1) to (M-18). In the compounds, R²⁵ to R³¹ are independently hydrogen or methyl; R³², R³³ and R³⁴ are independently hydrogen or alkyl having 1 to 5 carbons, at least one of R³², R³³ and R³⁴ is alkyl having 1 to 5 carbons; v, w and x are independently 0 or 1; and u and v are independently an integer from 1 to 10. L²¹ to L²⁶ are independently hydrogen or fluorine; and L²⁷ and L²⁸ are independently hydrogen, fluorine or methyl.

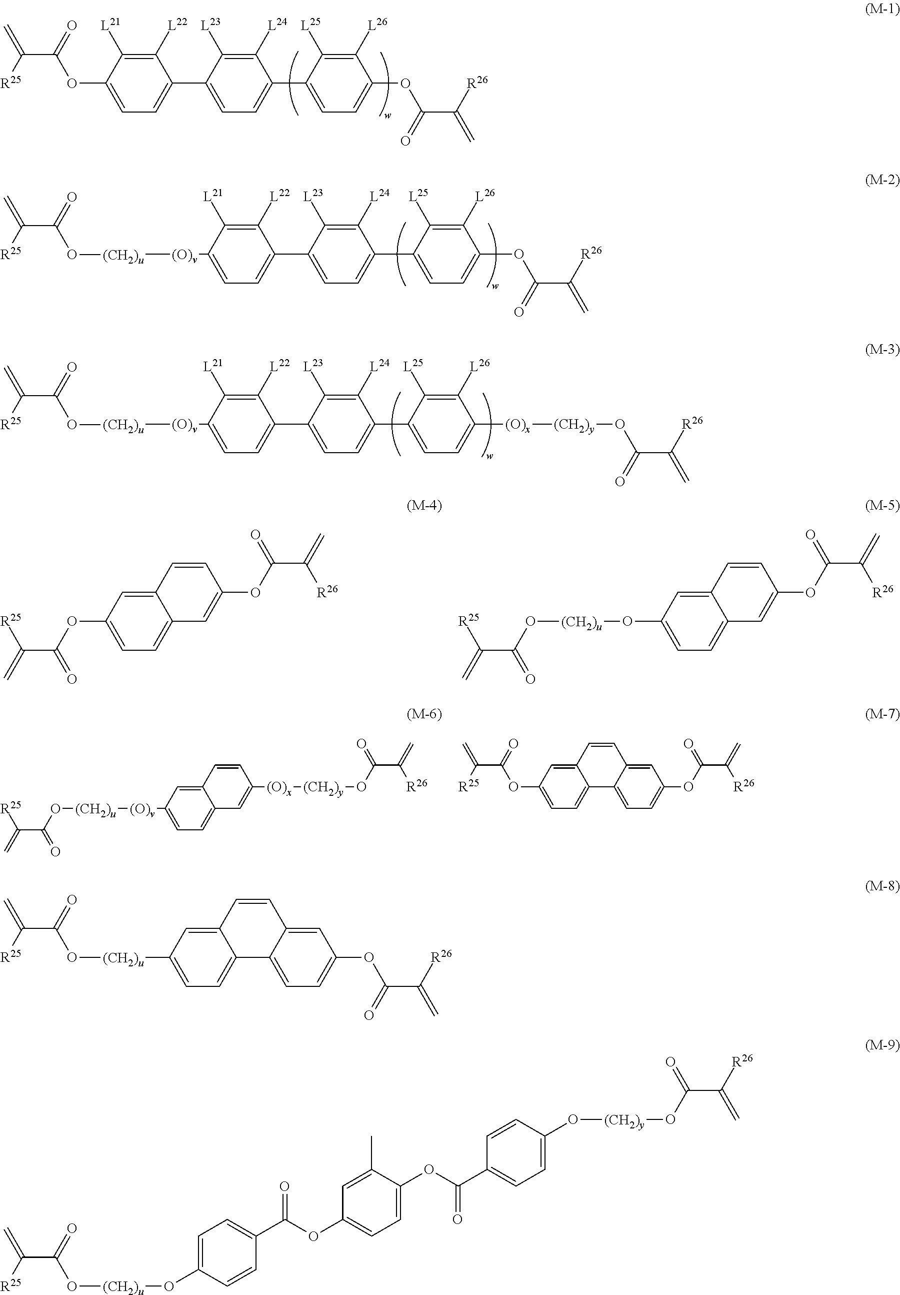

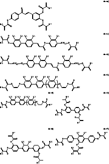

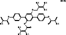

The polymerizable compound can be rapidly polymerized by adding the polymerization initiator. An amount of a remaining polymerizable compound can be decreased by optimizing reaction conditions. Specific examples of a photoradical polymerization initiators include TPO, 1173 and 4265 from Darocur series of BASF SE, and 184, 369, 500, 651, 784, 819, 907, 1300, 1700, 1800, 1850 and 2959 from Irgacure series thereof.

Additional examples of the photoradical polymerization initiator include 4-methoxyphenyl-2,4-bis(trichloromethyl)triazine, 2-(4-butoxystyryl) -5-trichloromethyl-1, 3, 4-oxadiazole, 9-phenylacridine, 9,10-benzphenazine, a benzophenone-Michler's ketone mixture, a hexaarylbiimidazole-mercaptobenzimidazole mixture, 1-(4-isopropylphenyl) -2-hydroxy-2-methylpropane-1-one, benzyl dimethyl ketal, 2-methyl-1-[ 4-(methylthio) phenyl]-2-morpholinopropane-1-one, a mixture of 2,4-diethylxanthone and methyl p-dimethylaminobenzoate, and a mixture of benzophenone and methyltriethanolamine.

After the photoradical polymerization initiator is added to the liquid crystal composition, polymerization can be performed by irradiation with ultraviolet light while an electric field is applied. However, an unreacted polymerization initiator or a decomposition product of the polymerization initiator may cause a poor display such as the image persistence in the device. In order to prevent such an event, photopolymerization may be performed with no addition of the polymerization initiator. A preferred wavelength of irradiation light is in the range of about 150 nanometers to about 500 nanometers. A further preferred wavelength is in the range of about 250 nanometers to about 400 nanometers, and a most preferred wavelength is in the range of about 300 nanometers to about 400 nanometers.

Upon storing the polymerizable compound, the polymerization inhibitor may be added thereto for preventing polymerization. The polymerizable compound is ordinarily added to the composition without removing the polymerization inhibitor. Examples of the polymerization inhibitor include hydroquinone, a hydroquinone derivative such as methylhydroquinone, 4-t-butylcatechol, 4-methoxyphenol and phenothiazine.

The optically active compound is effective in inducing a helical structure in liquid crystal molecules to give a required twist angle, and thereby preventing a reverse twist. A helical pitch can be adjusted by adding the optically active compound thereto. Two or more optically active compounds may be added for the purpose of adjusting temperature dependence of the helical pitch. Specific preferred examples of the optically active compounds include compounds (Op-1) to (Op-18) described below. In compound (Op-18), ring J is 1,4-cyclohexylene or 1, 4-phenylene, and R²⁸ is alkyl having 1 to 10 carbons. The mark “*” in the following compounds represents an asymmetrical carbon.

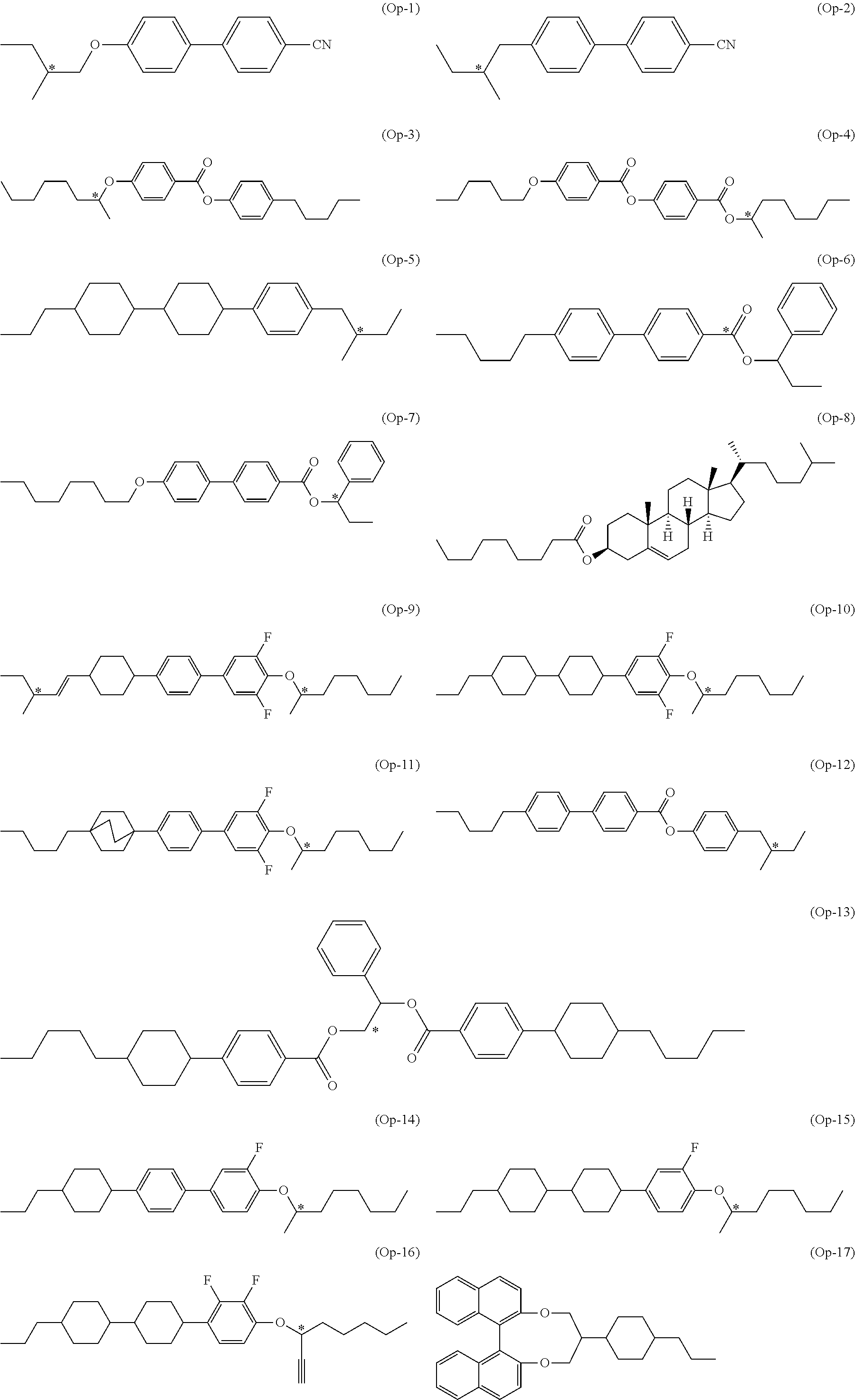

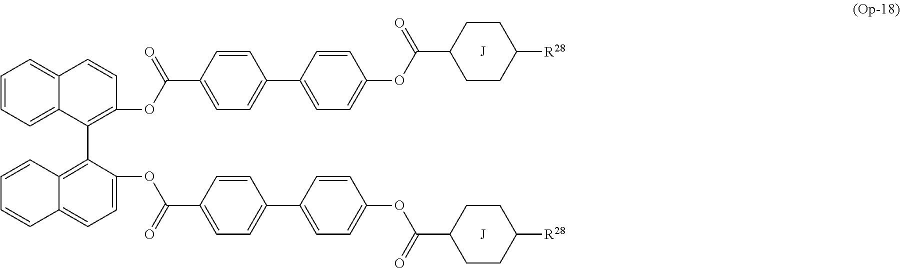

The antioxidant is effective for maintaining the large voltage holding ratio. Specific preferred examples of the antioxidants include compounds (AO-1) and (AO-2) described below; and Irganox 415, Irganox 565, Irganox 1010, Irganox 1035, Irganox 3114 and Irganox 1098 (trade names; BASF SE). The ultraviolet light absorber is effective for preventing a decrease of the maximum temperature. Preferred examples of the ultraviolet light absorbers include a benzophenone derivative, a benzoate derivative and a triazole derivative, and specific examples include compounds (AO-3) and (AO-4) described below; Tinuvin 329, Tinuvin P, Tinuvin 326, Tinuvin 234, Tinuvin 213, Tinuvin 400, Tinuvin 328 and Tinuvin 99-2 (trade names; BASF SE); and 1, 4-diazabicyclo [2.2.2] octane (DABCO)

The light stabilizer such as an amine having steric hindrance is preferred for maintaining the large voltage holding ratio. Specific preferred examples of the light stabilizers include compounds (AO-5), (AO-6) and (AO-7) described below; Tinuvin 144, Tinuvin 765 and Tinuvin 770DF (trade names; BASF SE); and LA-77Y and LA-77G (trade names; ADEKA Corporation). The heat stabilizer is also effective for maintaining the large voltage holding ratio, and specific preferred examples include Irgafos 168 (trade name; BASF SE). A dichroic dye such as an azo dye or an anthraquinone dye is added to the composition to be adapted for a device having a guest host (GH) mode. The antifoaming agent is effective for preventing foam formation. Specific preferred examples of the antifoaming agents include dimethyl silicone oil and methylphenyl silicone oil.

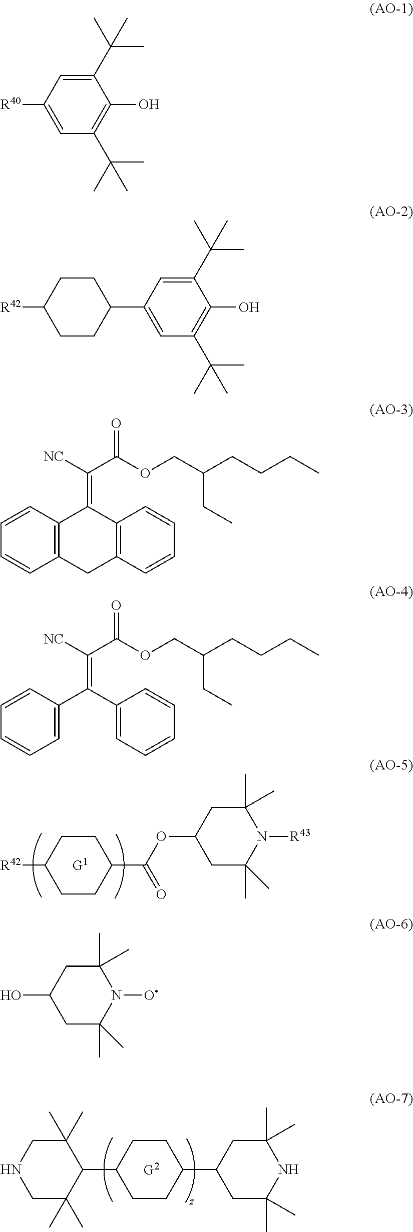

In compound (AO-1), R⁴° is alkyl having 1 to 20 carbons, alkoxy having 1 to 20 carbons, —COOR⁴¹ or —CH₂CH₂COOR⁴¹, in which R⁴¹ is alkyl having 1 to 20 carbons. In compounds (AO-2) and (AO-5), R⁴² is alkyl having 1 to 20 carbons. In compound (AO-5), R⁴³ is hydrogen, methyl or O· (oxygen radical); ring G¹ is 1,4-cyclohexylene or 1,4-phenylene; in compound (AO-7), ring G² is 1, 4-cyclohexylene, 1, 4-phenylene or 1, 4-phenylene in which at least one piece of hydrogen is replaced by fluorine; and in compounds (AO-5) and (AO-7), z is 1, 2 or 3.

4. Liquid Crystal Display Device

The liquid crystal composition can be used for the liquid crystal display device having an operating mode such as the PC mode, the TN mode, the STN mode, the OCB mode and the PSA mode, and driven by an active matrix mode. The composition can also be used for the liquid crystal display device having the operating mode such as the PC mode, the TN mode, the STN mode, the OCB mode, the VA mode and the IPS mode, and driven by a passive matrix mode. The devices can be applied to any of a reflective type, a transmissive type and a transflective type.

The composition is also suitable for a nematic curvilinear aligned phase (NCAP) device, and the composition is microencapsulated herein. The composition can also be used for a polymer dispersed liquid crystal display device (PDLCD) and a polymer network liquid crystal display device (PNLCD). In the compositions, a lot of polymerizable compounds are added. On the other hand, when a proportion of the polymerizable compound is about 10% by weight or less based on the weight of the liquid crystal composition, the liquid crystal display device having the PSA mode can be prepared. A preferred proportion is in the range of about 0.1% by weight to about 2% by weight. A further preferred proportion is in the range of about 0.2% by weight to about 1.0% by weight. The device having the PSA mode can be driven by the driving mode such as the active matrix mode and the passive matrix mode. Such devices can be applied to any of the reflective type, the transmissive type and the transflective type.

### EXAMPLES

1. Example of compound (1)

The invention will be described in greater detail by way of Examples. The Examples include a typical example, and therefore the invention is not limited by the Examples. Compound (1) was prepared according to procedures described below. The synthesized compound was identified by methods such as an NMR analysis. Physical properties of the compound and the composition and characteristics of a device were measured by methods described below.

NMR analysis: For measurement, DRX-500 made by Bruker BioSpin Corporation was used. In ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, CFCl₃ was used as an internal standard, and measurement was carried out under conditions of 24 times of accumulation. In the explanation of a nuclear magnetic resonance spectrum, s, d, t, q, quin, sex and m stand for a singlet, a doublet, a triplet, a quartet, a quintet, a sextet and a multiplet, and br being broad, respectively.

Gas chromatographic analysis: For measurement, GC-2010 Gas Chromatograph made by Shimadzu Corporation was used. As a column, a capillary column DB-1 (length 60 m, bore 0.25 mm, film thickness 0.25 μm) made by Agilent Technologies, Inc. was used. As a carrier gas, helium (1 mL/minute) was used. A temperature of a sample vaporizing chamber and a temperature of a detector (FID) were set to 300° C. and 300° C., respectively. A sample was dissolved in acetone and prepared to be a 1 weight % solution, and then 1 microliter of the solution obtained was injected into the sample vaporizing chamber. As a recorder, GC Solution System made by Shimadzu Corporation or the like was used.

HPLC Analysis: For measurement, Prominence (LC-20AD; SPD-20A) made by Shimadzu Corporation was used. As a column, YMC-Pack ODS-A (length 150 mm, bore 4.6 mm, particle diameter 5 μm) made by YMC Co., Ltd. was used. As an eluate, acetonitrile and water were appropriately mixed and used. As a detector, a UV detector, an RI detector, a CORONA detector or the like was appropriately used. When the UV detector was used, a detection wavelength was set at 254 nanometers. A sample was dissolved in acetonitrile and prepared to be a 0.1 weight% solution, and then 1 microliter of the solution was injected into a sample chamber. As a recorder, C-R7Aplus made by Shimadzu Corporation was used.

Ultraviolet-Visible Spectrophotometry: For measurement, PharmaSpec UV-1700 made by Shimadzu Corporation was used. A detection wavelength was adjusted in the range of 190 nanometers to 700 nanometers. A sample was dissolved in acetonitrile, and prepared to be a solution of 0.01 millimole per liter, and measurement was carried out by putting the solution in a quartz cell (optical path length 1 cm).

Sample for measurement: Upon measuring phase structure and a transition temperature (a clearing point, a melting point, a polymerization starting temperature or the like), a compound itselfwasusedasasample. Upon measuring physical properties such as a maximum temperature of a nematic phase, viscosity, optical anisotropy and dielectric anisotropy, a mixture of a compound and a base liquid crystal was used as a sample.

When the sample prepared by mixing the compound with the base liquid crystal was used, measurement was carried out as follows. The sample was prepared by mixing 15% by weight of the compound and 85% by weight of the base liquid crystal. An extrapolated value was calculated according to the following equation and the calculated value of the sample was described: {Extrapolated value}={100×(measured value of a sample)−(% by weight of a base liquid crystal)×(measured value of the base liquid crystal)}/(% by weight of the compound).

When crystals (or a smectic phase) precipitated at 25° C. at the ratio, a ratio of the compound to base liquid crystal (A) was changed in the order of (10% by weight : 90% by weight), (5% by weight : 95% by weight) and (1% by weight : 99% by weight), and physical properties of the sample were measured at a ratio at which no crystal (or no smectic phase) precipitated at 25° C. In addition, unless otherwise noted, the ratio of the compound to base liquid crystal (A) was (15% by weight : 85% by weight).

When dielectric anisotropy of the compound was zero or plus, base liquid crystal (A) described below was used. A proportion of each component was expressed in terms of % by weight.

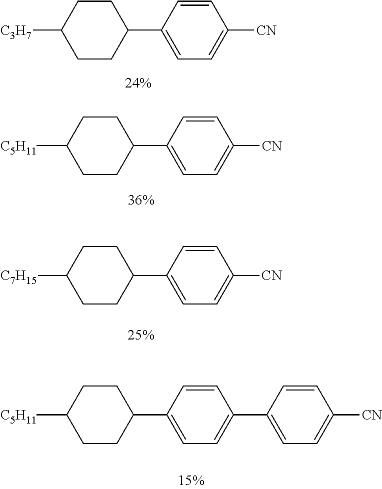

When dielectric anisotropy of the compound was zero or minus, base liquid crystal (B) described below was used. A proportion of each component was expressed in terms of % by weight.

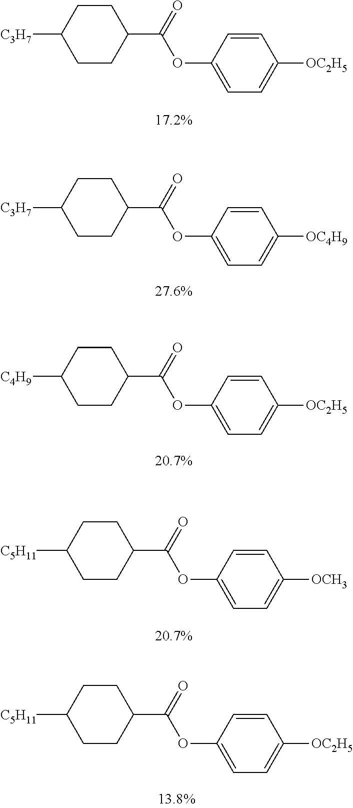

Measuring method: Physical properties were measured according to methods described below. Most of the methods are described in the Standard of Japan Electronics and Information Technology Industries Association (JEITA) discussed and established in JEITA (JEITA ED-2521B). A modified method was also applied. No thin film transistor (TFT) was attached to a TN device used for measurement.

(1) Phase structure: A sample was placed on a hot plate in a melting point apparatus (FP-52 Hot Stage made by Mettler-Toledo International Inc.) equipped with a polarizing microscope. A state of phase and a change thereof were observed with the polarizing microscope while the sample was heated at a rate of 3° C. per minute, and a kind of the phase was specified.

(2) Transition temperature (° C.): For measurement, a differential scanning calorimeter, Diamond DSC System, made by PerkinElmer, Inc., or a high sensitivity differential scanning calorimeter, X-DSC7000, made by SII NanoTechnology Inc. was used. A sample was heated and then cooled at a rate of 3° C. per minute, and a starting point of an endothermic peak or an exothermic peak caused by a phase change of the sample was determined by extrapolation, and thus a transition temperature was determined. A polymerization starting temperature and a melting point of a compound were also measured using the apparatus. Temperature at which a compound undergoes transition from a solid to a liquid crystal phase such as the smectic phase and the nematic phase may be occasionally abbreviated as “minimum temperature of the liquid crystal phase.” Temperature at which the compound undergoes transition from the liquid crystal phase to liquid may be occasionally abbreviated as “clearing point.”

A crystal was expressed as C. When the crystal was able to be distinguished to the two kinds, each was represented as C₁ or C₂. The smectic phase and a nematic phase were expressed as S and N, respectively. When a phase was distinguishable such as smectic A phase, smectic B phase, smectic C phase and smectic F, the phases were expressed as S_{A}, S_{B}, S_{C} and S_{F}, respectively. A liquid (isotropic) was expressed as I. A transition temperature was expressed as “C 50.0 N 100.0 I,” for example. The expression indicates that a transition temperature from the crystals to the nematic phase is 50.0° C., and a transition temperature from the nematic phase to the liquid is 100.0° C.

(3) Compatibility of compound: Samples in which the base liquid crystal and the compound were mixed for proportions of the compounds to be 20% by weight, 15% by weight, 10% by weight, 5% by weight, 3% by weight or 1% by weight were prepared. The samples were put in glass vials, and kept in freezers at −10° C. or −20° C. for a predetermined period of time. Whether a nematic phase of the samples was maintained or crystals (or a smectic phase) precipitated was observed. Conditions on which the nematic phase was maintained were used as a measure of the compatibility. Proportions of the compounds and each temperature in the freezers may be occasionally changed when necessary.

(4) Maximum temperature of nematic phase (T_{NI} or NI; ° C.): A sample was placed on a hot plate of a melting point apparatus equipped with a polarizing microscope, and was heated at a rate of 1° C. per minute. Temperature when part of the sample began to change from a nematic phase to an isotropic liquid was measured. When the sample was a mixture of compound (1) and the base liquid crystal, the maximum temperature was expressed as a symbol T_{NI}. When the sample was a mixture of compound (1) and a compound selected from compounds (2) to (15), a measured value was expressed in terms of a symbol NI. A higher limit of a temperature range of the nematic phase may be occasionally abbreviated as “maximum temperature.”

(5) Minimum temperature of nematic phase (T_{C}; ° C.) : Samples each having a nematic phase were put in glass vials and kept in freezers at temperatures of 0° C., −10° C., −20° C., −30° C. and −40° C. for 10 days, and then liquid crystal phases were observed. For example, when the sample maintained the nematic phase at −20° C. and changed to crystals or a smectic phase at −30° C., T_{c} was expressed as T_{c}<−20° C. A lower limit of the temperature range of the nematic phase may be occasionally abbreviated as “minimum temperature.”

(6) Viscosity (bulk viscosity; η; measured at 20° C.; mPa·s: For measurement, E type rotational viscometer made by Tokyo Keiki Inc. was used.

(7) Optical anisotropy (refractive index anisotropy; measured at 25° C.; An): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when a direction of polarized light was perpendicular to a direction of rubbing. A value of optical anisotropy (Δn) was calculated from an equation: Δn=n∥−n⊥.

(8) Specific resistance (ρ; measured at 25° C.; Ωcm): Into a vessel equipped with electrodes, 1.0 milliliter of a sample was injected. A DC voltage (10 V) was applied to the vessel, and a DC current after 10 seconds was measured. Specific resistance was calculated from the following equation: (specific resistance)={(voltage)×(electric capacity of a vessel)}/{(direct current)×(dielectric constant of vacuum)}.

9) Voltage holding ratio (VHR-1; measured at 25° C.; %): A TN device used for measurement had a polyimide alignment film, and a distance (cell gap) between two glass substrates was 5 micrometers. A sample was put in the device, and then the device was sealed with an ultraviolet-curable adhesive. The device was charged by applying a pulse voltage (60 microseconds at 5 V). A decaying voltage was measured for 16.7 milliseconds with a high-speed voltmeter, and area A between a voltage curve and a horizontal axis in a unit cycle was determined. Area B was an area without decay. A voltage holding ratio was expressed in terms of a percentage of area A to area B.

(10) Voltage holding ratio (VHR-2; measured at 80° C.; %) : A voltage holding ratio was measured by a method described above except that the voltage holding ratio was measured at 80° C. in place of 25° C. The results were expressed in terms of a symbol VHR-2.

(11) Flicker rate (measured at 25° C.; %): For measurement, 3298F Multimedia Display Tester made by Yokogawa Electric Corporation was used. A light source was an LED. A sample was put in a normally black mode FFS device in which a distance (cell gap) between two glass substrates was 3.5 micrometers and a rubbing direction was anti-parallel. The device was sealed with an ultraviolet-curable adhesive. Voltage was applied to the device, and a voltage having a maximum amount of light transmitted through the device was measured. A flicker rate displayed thereon was read by bringing a sensor unit close to the device while voltage was applied to the device.

The measuring method of the characteristics maybe different between a sample having a positive dielectric anisotropy and a sample having a negative dielectric anisotropy. When the dielectric anisotropy was positive, the measuring methods were described in sections (12a) to (16a). When the dielectric anisotropy was negative, the measuring methods were described in sections (12b) to (16b).

(12a) Viscosity (rotational viscosity; Υ1; measured at 25° C.; mPa·s; for a sample having positive dielectric anisotropy): Measurement was carried out according to a method described in M. Imai et al., Molecular Crystals and Liquid Crystals, Vol. 259, 37 (1995). A sample was put in a TN device in which a twist angle was 0 degrees and a distance (cell gap) between two glass substrates was 5 micrometers. A voltage was applied stepwise to the device in the range of 16 V to 19.5 V at an increment of 0.5 V. After a period of 0.2 second with no voltage, a voltage was applied repeatedly under the conditions of only one rectangular wave (rectangular pulse; 0.2 second) and no voltage (2 seconds). A peak current and a peak time of a transient current generated by the applied voltage were measured. A value of the rotational viscosity was obtained from the measured values and a calculation equation (8) on page 40 of the paper presented by M. Imai et al. A dielectric anisotropy value required for the calculation was obtained by the method described below using the device used for measuring the rotation viscosity.

(12b) Viscosity (rotational viscosity; Υ1; measured at 25° C.; mPa·s; for a sample having negative dielectric anisotropy): Measurement was carried out according to a method described in M. Imai et al., Molecular Crystals and Liquid Crystals, Vol. 259, 37 (1995). A sample was put in a VA device in which a distance (cell gap) between two glass substrates was 20 micrometers. Voltage was applied stepwise to the device in the range of 39 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of transient current generated by the applied voltage were measured. A value of rotational viscosity was obtained from the measured values and equation (8) on page 40 of the paper presented by M. Imai et al. In dielectric anisotropy required for the calculation, a value measured according to items of dielectric anisotropy described below was used.

(13a) Dielectric anisotropy (As; measured at 25° C.; for a sample having positive dielectric anisotropy): A sample was put in a TN device in which a distance (cell gap) between two glass substrates was 9 micrometers and a twist angle was 80 degrees. Sine waves (10 V, 1 kHz) were applied to the device, and after 2 seconds, a dielectric constant (ε∥) of liquid crystal molecules in a major axis direction was measured. Sine waves (0.5 V, 1 kHz) were applied to the device, and after 2 seconds, a dielectric constant (ε⊥) of the liquid crystal molecules in a minor axis direction was measured. A value of dielectric anisotropy value was calculated from equation; Δε=ε∥−ε⊥.

(13b) Dielectric anisotropy (Δε; measured at 25° C.; for a sample having negative dielectric anisotropy): A value of dielectric anisotropy was calculated from an equation: Δε=ε∥−ε⊥. A dielectric constant (ε∥ and ε⊥) was measured as follows. (1) Measurement of dielectric constant (ε∥): An ethanol (20 mL) solution of octadecyltriethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5 V, 1 kHz) were applied to the device, and after 2 seconds, a dielectric constant (ε∥) of the liquid crystal molecules in a major axis direction was measured. (2) Measurement of dielectric constant (ε⊥): A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (ε⊥) of the liquid crystal molecules in a minor axis direction was measured.

(14a) Elastic constant (K; measured at 25° C.; pN; for sample having positive dielectric anisotropy): For measurement, HP4284A LCR meter made by Yokogawa-Hewlett-Packard Co. was used. A sample was put in a horizontal alignment device in which a distance between two glass substrates (cell gap) was 20 micrometers. An electric charge from 0 V to 20 V was applied to the device, and electrostatic capacity (C) and applied voltage (V) were measured. The measured values were fitted to equation (2.98) and equation (2.101) on page 75 of “Liquid Crystal Device Handbook” (Ekisho Debaisu Handobukku, in Japanese; Nikkan Kogyo Shimbun, Ltd.), and values of K₁₁ and K₃₃ were obtained from equation (2.99). Next, K₂₂ was calculated by equation (3.18) on page 171 thereof using the previously determined values of K₁₁ and K₃₃. Elastic constant K was expressed using a mean value of the thus determined K₁₁, K₂₂ and K₃₃.

(14b) Elastic constant (K₁₁ and K₃₃ ; measured at 25° C.; pN; for a sample having negative dielectric anisotropy) : For measurement, Elastic Constant Measurement System Model EC-1 made by TOYO Corporation was used. A sample was put in a vertical alignment device in which a distance (cell gap) between two glass substrates was 20 micrometers. An electric charge from 20 V to 0 V was applied to the device, and electrostatic capacity (C) and applied voltage (V) were measured. The measured values were fitted to equation (2.98) and equation (2.101) on page 75 of “Liquid Crystal Device Handbook” (Ekisho Debaisu Handobukku, in Japanese; Nikkan Kogyo Shimbun, Ltd.), and a value of elastic constant was obtained from equation (2.100).

(15a) Threshold voltage (Vth; measured at 25° C.; V; for a sample having positive dielectric anisotropy) : For measurement, an LCD-5100 luminance meter made by Otsuka Electronics Co., Ltd. was used. A light source was a halogen lamp. A sample was put in a normally white mode TN device in which a distance between two glass substrates (cell gap) was 0.45/Δn (μm) and a twist angle was 80 degrees. A voltage (32 Hz, rectangular waves) to be applied to the device was stepwise increased from 0 V to 10 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage was expressed in terms of voltage at 90% transmittance.

(15b) Threshold voltage (Vth; measured at 25° C.; V; for a sample having negative dielectric anisotropy) : For measurement, an LCD-5100 luminance meter made by Otsuka Electronics Co., Ltd. was used. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 Vat an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage was expressed in terms of a voltage at 10% transmittance.

(16a) Response time (τ; measured at 25° C.; ms; for a sample having positive dielectric anisotropy): For measurement, an LCD-5100 luminance meter made by Otsuka Electronics Co., Ltd. was used. A light source was a halogen lamp. A low-pass filter was set to 5 kHz. A sample was put in a normally white mode TN device in which a distance between two glass substrates (cell gap) was 5.0 micrometers and a twist angle was 80 degrees. Rectangular waves (60 Hz, 5 V, 0.5 second) were applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. Arise time (τr: rise time; millisecond) was expressed in terms of time required for a change from 90% transmittance to 10% transmittance. A fall time (τf: fall time; millisecond) was expressed in terms of time required for a change from 10% transmittance to 90% transmittance. A response time was expressed by a sum of the rise time and the fall time thus obtained.

(16b) Response time (τ; measured at 25° C.; ms; for sample having negative dielectric anisotropy): For measurement, an LCD-5100 luminance meter made by Otsuka Electronics Co., Ltd. was used. A light source was a halogen lamp. A low-pass filter was set to 5 kHz. A sample was put in a normally black mode PVA device in which a distance (cell gap) between two glass substrates was 3.2 micrometers and a rubbing direction was anti-parallel. The device was sealed with an ultraviolet-curable adhesive. The device was applied with a voltage of a little exceeding a threshold voltage for 1 minute, and then was irradiated with an ultraviolet light of 23.5 mW/cm² for 8 minutes, while applying a voltage of 5.6 V. Rectangular waves (60 Hz, 10 V, 0.5 second) were applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A response time was expressed in terms of time required for a change from 90% transmittance to 10% transmittance (fall time; millisecond).

Raw material: Solmix (registered trade name) A-11 is a mixture of ethanol (85.5%), methanol (13.4%) and isopropanol (1.1%), and was purchased from Japan Alcohol Trading Co., Ltd.

### Synthesis Example 1

### Synthesis of Compound (No. 261)

First Step:

Into a 300 mL flask, a toluene (90 mL) solution of 4-bromobenzaldehyde (22.0 g, 0.119 mol) was put, and ethylene glycol (33 g, 0.532 mol) and p-toluene sulfonic acid monohydrate (1.1 g, 5.783mmol) were added thereto, and the resulting mixture was stirred at 100° C. to 110° C. for 5 hours. The reaction mixture was poured into saturated aqueous solution of sodium hydrogencarbonate (100 mL), and stirred for 10 minutes. The organic layer separated was washed with saturated brine (20 mL) and dried over anhydrous magnesium sulfate. Then, the organic layer was concentrated under reduced pressure to obtain compound (261-b) (27.2 g, 0.119 mol, yield: 100%).

Second Step:

Into a 500 mL flask, compound (261-b) (27.2 g, 0.119 mol), 4-formylphenylboronic acid (27.2 g, 0.136 mol), potassium carbonate (32.8 g, 0.237 mol), tetrabutylammonium bromide (11.5 g, 0.036 mol), Pd-132 (84 mg, 0.119 mmol) and water (272 mL) were put, and the resulting mixture was stirred at 90° C. to 100° C. for 3 hours. The reaction mixture was returned to room temperature, and subjected to extraction with toluene (100 mL×3). The extract was washed with saturated brine, dried over anhydrous magnesium sulfate, and concentrated under reduced pressure. The residue was purified by silica gel chromatography (Kieselgel 60; toluene) to obtain aldehyde (261-c) (22.3 g, 0.0879 mol; yield: 73.9%).

Third Step:

Into a 1,000 mL flask, a methylene chloride (500 mL) solution of 4-hydroxymethylbenzaldehyde (70.5 g, 0.518 mol) was put, and thionyl chloride (80.1 g, 0.673 mol) was added dropwise thereto at 0° C. to 10° C., and the resulting mixture was stirred at 0° C. to 10° C. for 3 hours. The reaction mixture was concentrated under reduced pressure, and further subjected to azeotropy with toluene (50 mL×3). The residue was purified by silica gel chromatography (Kieselgel 60; n-heptane/toluene) to obtain chloride (261-e) (36.4 g, 0.235 mol; yield: 45.5%).

Fourth Step:

Into a 500 mL flask, a toluene (218 mL) solution of chloride (261-e) (36.4 g, 0.235 mol) was put, and ethylene glycol (21.880 g, 0.353 mol) and p-toluene sulfonic acid monohydrate (1.82 g, 9.569 mmol) were added thereto, and the resulting mixture was stirred at 100° C. to 110° C. for 4 hours. The reaction mixture was poured into saturated sodium hydrogencarbonate aqueous solution (200 mL), and stirred for 10 minutes. The organic layer separated was washed with saturated brine (20 mL), dried over anhydrous magnesium sulfate, and concentrated under reduced pressure to obtain compound (261-f) (32.4 g, 0.163 mol, yield: 69.2%).

Fifth Step:

Into a 300 mL flask, a toluene (100 mL) solution of compound (261-f) (32.4 g, 0.163 mol) was put, and triphenyl phosphine (51.3 g, 0.196 mol) was added thereto, and the resulting mixture was stirred at 100° C. to 110° C. for 6 hours. The reaction mixture was returned to room temperature, and filtered thereof to obtain phosphonium salt (261-g) (58.7 g, 0.127 mol; yield: 78.1%).

Sixth Step:

Into a 500 mL flask, phosphonium salt (261-g) (58.7 g, 0.127 mol) and THF (180 mL) were put, and t-butoxypotassium (16.1 g, 0.132 mol) was added to the resulting suspension at −10° C. After 1 hour, a THF (30 mL) solution of aldehyde (261-c) (22.3 g, 0.0879 mol) was added dropwise thereto at 0° C. or lower, and the resulting mixture was further stirred at 15° C. to 25° C. for 2 hours. The reaction mixture was poured into water, and subjected to extraction with toluene (100 mL×3). The extract was washed with saturated brine (50 mL×2), dried over anhydrous magnesium sulfate, and concentrated under reduced pressure. The residue was purified by silica gel chromatography (Kieselgel 60; toluene) to obtain compound (261-h) (E : Z=1 : 3; 31.5 g, 0.0787 mol; yield: 89.5%).

Seventh Step:

Into a 1,000 mL flask, a THF (630 mL) solution of compound (261-h) (E : Z=1 : 3; 31.5 g, 0.0787 mol) was put, and 5% Pd-C (1.58g) was further added thereto, and the resulting mixture was stirred under a hydrogen atmosphere at 35° C. to 45° C. for 10 hours. Pd-C was filtered off, and the reaction mixture was concentrated under reduced pressure. The residue was purified by silica gel chromatography (Kieselgel 60; toluene) to obtain compound (261-i) (31.5 g, 0.0783 mol; yield: 99.5%).

Eighth Step:

Into a 500 mL flask, a toluene (250 mL) solution of Compound (261-i) (31.5 g, 0.0783 mol) was out, and formic acid (126g) was added thereto, and resulting mixture was stirred at 45° C. to 55° C. for 2 hours. The reaction mixture was poured into saturated sodium hydrogencarbonate aqueous solution (200 mL), and stirred for 10 minutes. The organic layer separated was washed with saturated brine (50 mL), dried over anhydrous magnesium sulfate, and concentrated under reduced pressure to obtain compound (261-j) (19.5 g, 0.0620 mol; yield: 79.1%)

Ninth Step:

Into a 1,000 mL flask, sodium borohydride (SBH; 13.93 g, 0.372 mol) and THF (300 mL) were put, and a THF (100 mL) solution of aldehyde (261-j) (19.5 g, 0.0620 mol) was added dropwise to the resulting suspension at 5° C. or lower, and the resulting mixture was stirred at 20° C. to 30° C. for 3 hours. Saturated ammonium chloride aqueous solution (200 mL) was added dropwise to the reaction mixture at 10° C. or lower, and the resulting mixture was quenched. The resulting mixture was subjected to extraction with ethyl acetate (200m1×3). The extract was washed with saturated brine (100 mL×2), and dried over anhydrous magnesium sulfate. The residue was purified by silica gel chromatography (Kieselgel 60; toluene/ethyl acetate) to obtain diol (261-k) (19.8g; 0.0620 mol; yield: 100%).

Tenth Step:

Into a 1,000 mL flask, a dichloroethane (600 mL) solution of diol (261-k) (19.8 g, 0.0620 mol) was put, and thionyl chloride (19.2 g, 0.162 mol) was added dropwise thereto, and then the resulting mixture was stirred at 0° C. to 10° C. for 2 hours. The reaction mixture was concentrated under reduced pressure, and further subjected to azeotropy with toluene (50 mL×3). The residue was purified by silica gel chromatography (Kieselgel 60; n-heptane/toluene) to obtain chloride (261-1) (22.0 g, 0.0619 mol; yield: 97.4%)

Eleventh Step:

Into a 500 mL flask, magnesium (14.237g; 0.619 mol) and THF (50 mL) were put, and a THF (200 mL) solution of 3-chloroprop-1-en (56.84 g, 0.743 mol) was added dropwise to the resulting suspension at 40° C. or lower. After 1 hour, a THF (50 mL) solution of compound (261-l) (22.0 g, 0.0619 mol) was added dropwise thereto at 10° C. or lower, and then the resulting mixture was stirred at 10° C. to 20° C. for 3 hours. Saturated ammonium chloride aqueous solution (300 mL) was added dropwise to the reaction mixture at 10° C. or lower, and the resulting mixture was quenched. The resulting mixture was subjected to extraction with toluene (200m1×3). The extract was washed with saturated brine (100 mL×2), dried over anhydrous magnesium sulfate, and concentrated under reduced pressure. The residue was purified by silica gel chromatography (Kieselgel 60; n-heptane) to obtain compound (261) (5.16 g, 0.014 mol; yield: 22.7%).

¹H-NMR (δ ppm; CDCl₃) : 7.28 (dd, J=8.2 Hz, J=2.2 Hz, 2Hx2), 7.26 (d, J=8.1 Hz, 2H), 7.25 (d, J=8.2 Hz, 2H), 7.13 (dd, J=8.2 Hz, J=8.1 Hz, 4H), 5.89 (ddt, J=17.0 Hz, J=10.1 Hz, J=6.5 Hz, 1H), 5.88 (ddt, J=17.3 Hz, J=10.1 Hz, J=6.5 Hz, 1H), 5.08 (dd, J=17.0 Hz, J=1.5 Hz, 1H), 5.05 (dd, J=17.3 Hz, J=1.5 Hz, 1H), 5.00 (dd, J=10.1 Hz, J=1.5 Hz, 1H), 4.98 (dd, J=10.1 Hz, J=1.5 Hz, 1H), 2.97-2.90 (m, 2Hx2), 2.75 (t, J=7.5 Hz, 2H), 2.69 (t, J=7.5 Hz, 2H), 2.41 (dt, J=7.5 Hz, J=6.5 Hz, 2H), 2.36 (dt, J=7.5 Hz, J=6.5 Hz, 2H).

Transition temperature: C 51.3 SE 143.0 I. Maximum temperature (T_{NI})=122.4° C.; dielectric anisotropy (Δε)=6.2; optical anisotropy (Δn)=0.217; viscosity (η)=3.3 MPa·s.

### Synthesis Example 2

### Synthesis of Compound (No. 273)

First Step:

Into a 1,000 mL flask, 1-bromo-2-fluoro-4-iodobenzene (37.0 g, 0.123 mol), 4-formyl phenylboronic acid (18.443 g, 0.123 mol), potassium carbonate (36.944 g, 0.369 mol), tetrabutylammonium bromide (11.896 g, 0.0369 mol), Pd(Ph₃P)₄ (711 mg, 0.615 mmol), toluene (300 mL) and n-butanol (100 mL) were put, and the resulting mixture was stirred at 84° C. to 85° C. for 5 hours. The reaction mixture was poured into water, and the resulting mixture was stirred for a while. Then, the resulting mixture was separated into an organic layer and an aqueous layer. The aqueous layer was subjected to extraction with toluene (200 ml×2). The organic layer combined was washed with saturated brine (200 mL×2), dried over anhydrous magnesium sulfate, and concentrated under reduced pressure. The residue was purified by silica gel chromatography (Kieselgel 60; n-heptane/toluene) to obtain aldehyde (273-b) (23.132 g, 0.0829 mol; yield: 67.4%)

Second Step:

Into a 300 mL flask, a toluene (100 mL) solution of aldehyde (273-b) (23.132 g, 0.0829 mol) was put, and ethylene glycol (10.291 g, 0.166 mol) and p-toluene sulfonic acid monohydrate (0.788 g, 4.145 mmol) were added thereto, and the resulting mixture was stirred at 101° C. to 110° C. for 1 hour. The reaction mixture was poured into saturated sodium hydrogencarbonate aqueous solution (100 mL), and stirred for 10 minutes. The organic layer separated was washed with saturated brine (20 mL), dried over anhydrous magnesium sulfate, and concentrated under reduced pressure to obtain compound (273-c) (19.980 g, 0.0618 mol; yield: 74.6%).

Third Step:

Into a 500 mL flask, a THF (200 mL) solution of compound (273-c) (19.980 g, 0.0618 mol) was put, and n-butyllithium (a hexane solution of 1.63 mol/L; 45.5 ml, 0.0742 mol) was added dropwise thereto at −80° C. to −90° C. After 1 hour, a THF (10 mL) solution of DMF (6.775 g, 0.0927 mol) was added dropwise thereto at −80° C. to −90° C. After 30 minutes, the reaction mixture was poured into water (100 mL), and subjected to extraction with toluene (100 mL×3). The extract was washed with saturated brine (50 mL×2), dried over anhydrous magnesium sulfate, and concentrated under reduced pressure. The residue was purified by silica gel chromatography (Kieselgel 60; toluene) to obtain aldehyde (273-d) (12.255 g, 0.0450 mol; yield: 72.8%)

Fourth Step to Sixth Step:

Phosphonium salt (261-g) was prepared from chloride (261-e) in a manner similar to the method of fourth step to sixth step in Synthesis Example 1.

Seventh Step:

Into a 500 mL flask, phosphonium salt (261-g) (30.083 g, 0.0653 mol) and THF (90 mL)) were put, and into the suspension, t-butoxypotassium (7.574 g, 0.0675 mol) was added at −10° C. or lower. After 1 hour, a THF (10 mL) solution of aldehyde (273-d) (12.255g, 0.0450 mol) was added dropwise thereto at 0° C. or lower, and the resulting mixture was further stirred at 15° C. to 25° C. for 2 hours. Then, the reaction mixture was poured into water, and subjected to extraction with toluene (100 mL×3). The extract was washed with saturated brine (50 mL×2), dried over anhydrous magnesium sulfate, and concentrated under reduced pressure. The residue was purified by silica gel chromatography (Kieselgel 60; toluene) to obtain compound (273-e) (17.158 g, 0.0410 mol; yield: 91.1%).

Eighth Step:

Into a 1,000 mL flask, a THF (350 mL) solution of compound (273-e) (17.158 g, 0.0410 mol) was put, and 5% Pd-C(0.858 g) was added thereto, and the resulting mixture was stirred under a hydrogen atmosphere at 20° C. to 25° C. for 5 hours. Then, Pd-C was filtered off, and the filtrate was concentrated under reduced pressure. The residue was purified by silica gel chromatography (Kieselgel 60; toluene) to obtain compound (273-f) (17.240 g, 0.0410 mol; yield: 100%).

Ninth Step:

Into a 300 mL flask, a toluene (150 mL) solution of compound (273-f) (17.240 g, 0.0410 mol) was put, and formic acid (68.96 g) was added thereto, and the resulting mixture was stirred at 45° C. to 55° C. for 1 hour. The reaction mixture was poured into saturated sodium hydrogencarbonate aqueous solution (100 mL), and stirred for 10 minutes. The organic layer separated was washed with saturated brine (30 mL), dried over anhydrous magnesium sulfate, and concentrated under reduced pressure to obtain compound (273-g) (13.627 g, 0.0410 mol; yield: 100%).

Tenth Step:

Into a 500 mL flask, sodium borohydride (3.412 g, 0.0902 mol) and THF (200 mL) were put, and into the suspension, a THF (70 mL) solution of aldehyde (261-j) (13.627 g, 0.0410 mol) was added dropwise at 5° C. or lower, and the resulting mixture was further stirred at 20° C. to 30° C. for 30 minutes. Saturated ammonium chloride aqueous solution (100 mL) was added dropwise to the reaction mixture at 10° C. or lower, and the resulting mixture was quenched. Then, the mixture was subjected to extraction with toluene (100 mL×3). The extract was washed with saturated brine (50 mL×2), dried over anhydrous magnesium sulfate, and concentrated under reduced pressure. The residue was purified by silica gel chromatography (Kieselgel 60; toluene/ethyl acetate) to obtain diol (273-h) (13.793 g, 0.0410 mol; yield: 100%).

Eleventh Step:

Into a 1,000 mL flask, a dichloroethane (400 mL) solution of diol (273-h) (13.793 g, 0.0410 mol) was put, and thionyl chloride (11.706 g, 0.0984 mol) was added dropwise thereto at 0° C. to 10° C., and the resulting mixture was further stirred for 2 hours. The reaction mixture was concentrated under reduced pressure, and further subjected to azeotropy with toluene (50 mL×3). The residue was purified by silica gel chromatography (Kieselgel 60; n-heptane/toluene) to obtain chloride (273-i) (12.734 g, 0.0341 mol; yield: 83.2%).

Twelfth Step:

Into a 500 mL flask, magnesium (4.706 g, 0.205 mol) and THF (30 mL) were put, and into the suspension, a THF (100 mL) solution of 3-chloroprop-1-en (16.96 g, 0.222 mol) was added dropwise at 40° C. or lower. After 1 hour, a THF (30 mL) solution of compound (273-i) (12.734 g, 0.0341 mol) was added dropwise thereto at 10° C. or lower, and the resulting mixture was further stirred at 20° C. to 30° C. for 3 hours. Saturated ammonium chloride aqueous solution (200 mL) was added dropwise to the reaction mixture at 10° C. or lower, and the resulting mixture was quenched. Then, the mixture was subjected to extraction with toluene (100 mL×3). The extract was washed with saturated brine (50 mL×2), dried over anhydrous magnesium sulfate, and concentrated under reduced pressure. The residue was purified by silica gel chromatography (Kieselgel 60; n-heptane) to obtain compound (273) (5.08 g, 0.0132 mol; yield: 38.7%).

¹H-NMR (δ ppm; CDCl₃): 7.49 (d, J=8.2 Hz, 2H), 7.28-7.24 (m, 4H), 7.18 (dd, J=8.3 Hz, J=7.8, 1H), 7.14 (d, J=8.2 Hz, 2H), 7.12 (d, J=8.1 Hz, 1H), 5.88 (ddt, J=17.3 Hz, J=10.3 Hz, J=6.5 Hz, 1H), 5.86 (ddt, J=17.0 Hz, J=10.1 Hz, J=6.5 Hz, 1H), 5.07 (dd, J=17.3 Hz, J=1.7 Hz, 1H), 5.05 (dd, J=17.0 Hz, J=1.7 Hz, 1H), 5.00 (dd, J=10.3 Hz, J=1.7 Hz, 1H), 4.98 (dd, J=10.1 Hz, J=1.7 Hz, 1H), 2.97-2.88 (m, 2Hx2), 2.75 (t, J=7.5 Hz, 2H), 2.69 (t, J=7.5 Hz, 2H), 2.41 (dt, J=7.5 Hz, J=6.5 Hz, 2H), 2.37 (dt, J=7.5 Hz, J=6.5 Hz, 2H). ¹⁹F-NMR (δ ppm; CDCl₃): −119.51 (dd, J=10.9 Hz, J=8.3 Hz, 1F).

Transition temperature: C 43.8 SB 53.0 N 89.2 I. Maximum temperature (T_{NI})=91.7° C.; dielectric anisotropy (Δε)=5.2; optical anisotropy (Δn)=0.210; viscosity (η)=9.1 MPa·s.

Compounds (No.285) and (No.286) were prepared in a manner similar to the above-described methods.

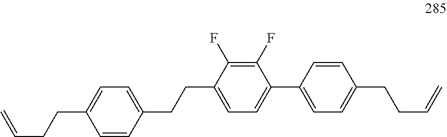 [SMILES: C=CCCc1ccc(CCc2ccc(-c3ccc(CCC=C)cc3)c(F)c2F)cc1]

¹H-NMR (δ ppm; CDCl₃) : 7.46 (dd, J=8.1 Hz, J=1.3 Hz, 2H), 7.27 (d, J=8.1 Hz, 2H), 7.13 (s, 4H), 7.10 (dt, J=7.7 Hz, J=1.0 Hz, 1H), 6.98 (dt, J=7.7 Hz, J=1.0 Hz, 1H), 5.89 (ddt, J=17.0 Hz, J=10.1 Hz, J=6.5 Hz, 1H), 5.88 (ddt, J=17.3 Hz, J=10.1 Hz, J=6.5 Hz, 1H), 5.08 (dd, J=17.0 Hz, J=1.5 Hz, 1H), 5.05 (dd, J=17.3 Hz, J=1.5 Hz, 1H), 5.00 (dd, J=10.1 Hz, J=1.5 Hz, 1H), 4.98 (dd, J=10.1 Hz, J=1.5 Hz, 1H), 2.97-2.90 (m, 2Hx2), 2.75 (t, J=7.5 Hz, 2H), 2.69 (t, J=7.5 Hz, 2H)2.41 (dt, J=7.5 Hz, J=6.5 Hz, 2H), 2.36 (dt, J=7.5 Hz, J=6.5 Hz, 2H).

Transition temperature: C 46.2 SA 50.6 N 67.5 I.

Maximum temperature (T_{NI})=68.4° C.; dielectric anisotropy (Δε)=3.4; optical anisotropy (Δn)=0.177; viscosity (η)=16.0 MPa·s.

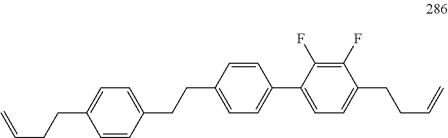 [SMILES: C=CCCc1ccc(CCc2ccc(-c3ccc(CCC=C)c(F)c3F)cc2)cc1]

¹H-NMR (δ ppm; CDCl₃): 7.46 (d, J=7.9 Hz, 2H), 7.27 (d, J=7.9 Hz, 2H), 7.13 (s, 4H), 7.08 (t, J=7.8 Hz, 1H), 6.93 (t, J=7.8 Hz, 1H), 5.88 (ddt, J=17.0 Hz, J=10.1 Hz, J=6.5 Hz, 1H), 5.87 (ddt, J=17.3 Hz, J=10.1 Hz, J=6.5 Hz, 1H), 5.08 (dd, J=17.0 Hz, J=1.5 Hz, 1H), 5.05 (dd, J=17.3 Hz, J=1.5 Hz, 1H), 5.00 (dd, J=10.1 Hz, J=1.5 Hz, 1H), 4.98 (dd, J=10.1 Hz, J=1.5 Hz, 1H), 2.99-2.89 (m, 2Hx2), 2.76 (t, J=7.5 Hz, 2H), 2.69 (t, J=7.5 Hz, 2H), 2.41 (dt, J=7.5 Hz, J=6.5 Hz, 2H), 2.36 (dt, J=7.5 Hz, J=6.5 Hz, 2H).

Transition temperature: C 33.1 N 68.1 I.

Maximum temperature (T_{NI})=65.7° C.; dielectric anisotropy (Δε)=4.1; optical anisotropy (Δn)=0.184; viscosity (η)=12.7 MPa·s.

### Comparative Example 1

### Comparison of Viscosity

Then, 15% by weight of compound (1) or a comparative compound was mixed with 85% by weight of base liquid crystal (A) to prepare a sample, and viscosity (bulk viscosity; η) was measured according to the measuring method (6). Viscosity of compound (261) was 3.3 MPa·s. In order to compare with compound (1), comparative compound (s-1) was selected. The comparative compound (s-1) is different from compound (261) by which bonding groups Z¹ and Z² are both a single bond. Viscosity of comparative compound (s-1) was 72.6 MPa·s. With regard to compound (273), results are summarized in Table 2 in comparison with similar compounds. Viscosity of compound (273) was 9.1 MPa·s, and was smaller than the viscosity of comparative compounds (s-2) to (s-4). Therefore, compound (1) can be concluded to have a smaller viscosity rather than a triphenyl derivative that corresponds to compound (1).

TABLE 2
Viscosity of liquid crystal compounds

| Liquid crystal | | |
|---|---|---|
| compounds | Structure formulas | Viscosity |
| Compound (261) | 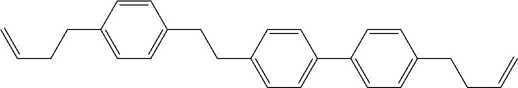 [SMILES: C=CCCc1ccc(CCc2ccc(-c3ccc(CCC=C)cc3)cc2)cc1] | 3.3 |
| Comparative compound s-1 | 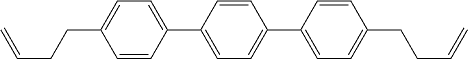 [SMILES: C=CCCc1ccc(-c2ccc(-c3ccc(CCC=C)cc3)cc2)cc1] | 72.6 |
| Compound (273) | 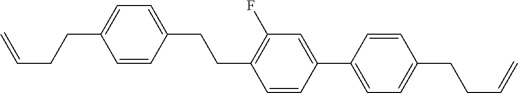 [SMILES: C=CCCc1ccc(CCc2ccc(-c3ccc(CCC=C)cc3)cc2F)cc1] | 9.1 |
| Comparative compound s-2 | 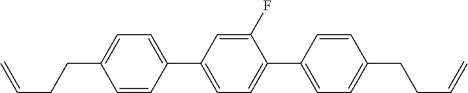 [SMILES: C=CCCc1ccc(-c2ccc(-c3ccc(CCC=C)cc3)c(F)c2)cc1] | 16.9 |
| Comparative compound s-3 | 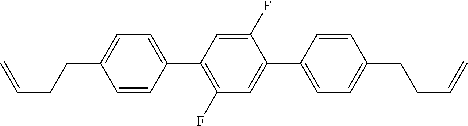 [SMILES: C=CCCc1ccc(-c2cc(F)c(-c3ccc(CCC=C)cc3)cc2F)cc1] | 25.1 |
| Comparative compound s-4 | 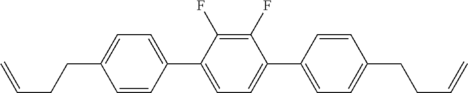 [SMILES: C=CCCc1ccc(-c2ccc(-c3ccc(CCC=C)cc3)c(F)c2F)cc1] | 27.1 |

Compound (1) is prepared according to the above-described “2. Synthesis of compound (1) ” and Synthesis Examples. Specific examples of such a compound (1) include compounds (No. 1) to (No. 284) shown below.

| No. | |
|---|---|
| 1 | 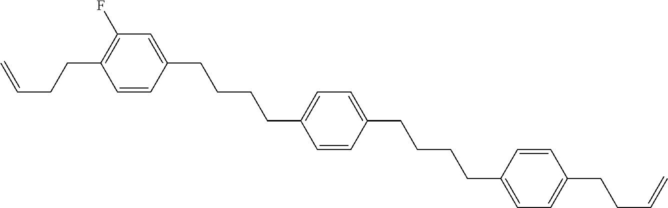 [SMILES: C=CCCc1ccc(CCCCc2ccc(CCCCc3ccc(CCC=C)c(F)c3)cc2)cc1] |
| 2 | 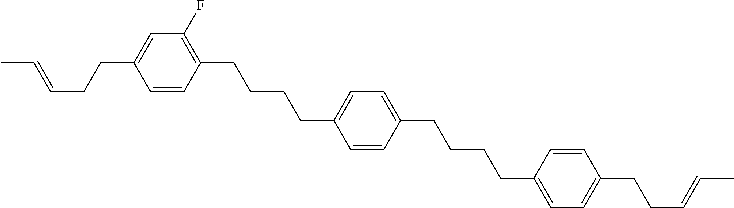 [SMILES: C/C=C/CCc1ccc(CCCCc2ccc(CCCCc3ccc(CC/C=C/C)cc3F)cc2)cc1] |
| 3 | 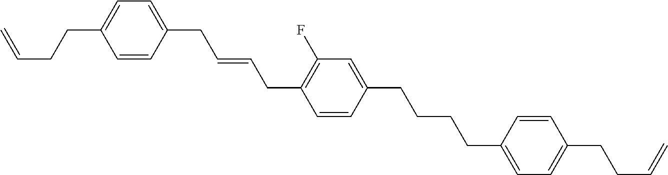 [SMILES: C=CCCc1ccc(C/C=C/Cc2ccc(CCCCc3ccc(CCC=C)cc3)cc2F)cc1] |
| 4 | 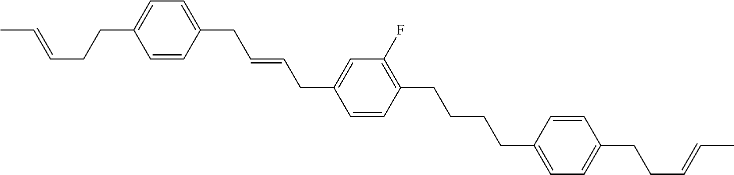 [SMILES: C/C=C/CCc1ccc(C/C=C/Cc2ccc(CCCCc3ccc(CC/C=C/C)cc3)c(F)c2)cc1] |
| 5 | 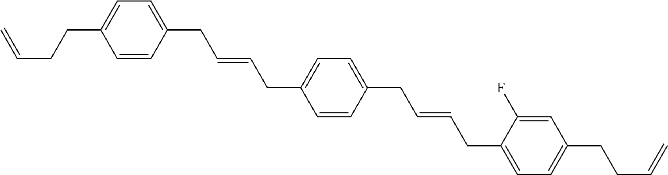 [SMILES: C=CCCc1ccc(C/C=C/Cc2ccc(C/C=C/Cc3ccc(CCC=C)cc3F)cc2)cc1] |
| 6 | 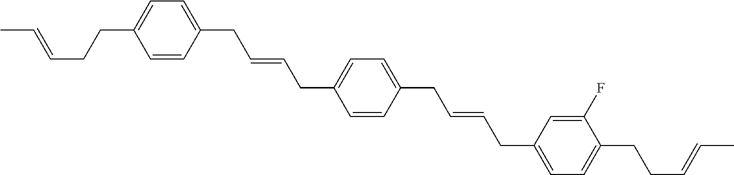 [SMILES: C/C=C/CCc1ccc(C/C=C/Cc2ccc(C/C=C/Cc3ccc(CC/C=C/C)c(F)c3)cc2)cc1] |
| 7 | 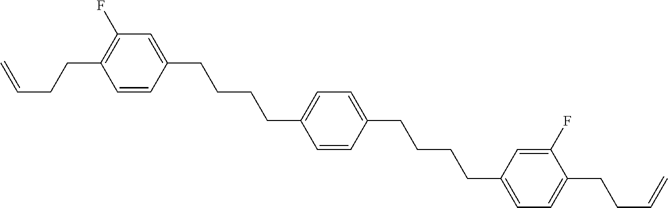 [SMILES: C=CCCc1ccc(CCCCc2ccc(CCCCc3ccc(CCC=C)c(F)c3)cc2)cc1F] |
| 8 | 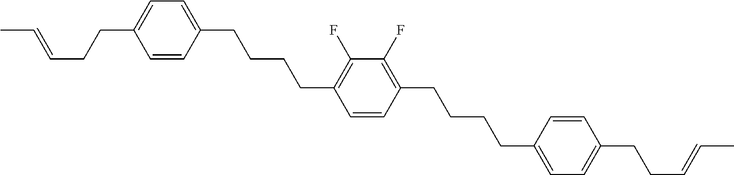 [SMILES: C/C=C/CCc1ccc(CCCCc2ccc(CCCCc3ccc(CC/C=C/C)cc3)c(F)c2F)cc1] |
| 9 | 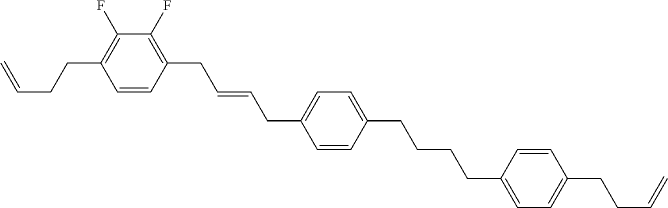 [SMILES: C=CCCc1ccc(CCCCc2ccc(C/C=C/Cc3ccc(CCC=C)c(F)c3F)cc2)cc1] |
| 10 | 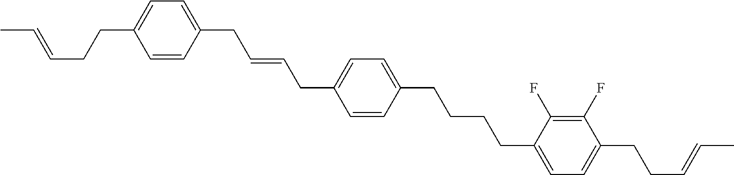 [SMILES: C/C=C/CCc1ccc(C/C=C/Cc2ccc(CCCCc3ccc(CC/C=C/C)c(F)c3F)cc2)cc1] |
| 11 | 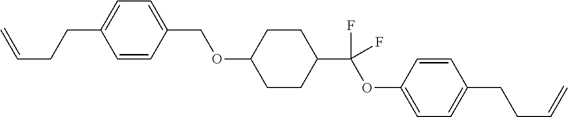 [SMILES: C=CCCc1ccc(COC2CCC(C(F)(F)Oc3ccc(CCC=C)cc3)CC2)cc1] |
| 12 | 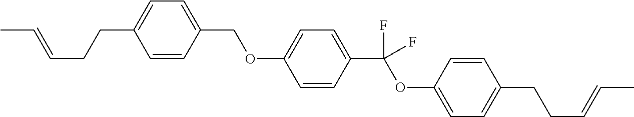 [SMILES: C/C=C/CCc1ccc(COc2ccc(C(F)(F)Oc3ccc(CC/C=C/C)cc3)cc2)cc1] |
| 13 | 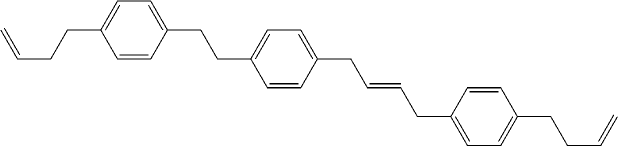 [SMILES: C=CCCc1ccc(C/C=C/Cc2ccc(CCc3ccc(CCC=C)cc3)cc2)cc1] |
| 14 | 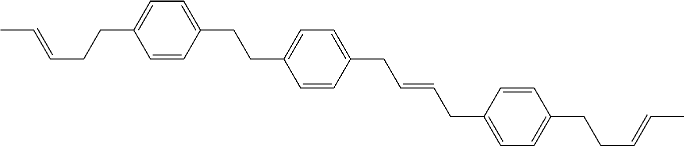 [SMILES: C/C=C/CCc1ccc(C/C=C/Cc2ccc(CCc3ccc(CC/C=C/C)cc3)cc2)cc1] |
| 15 | 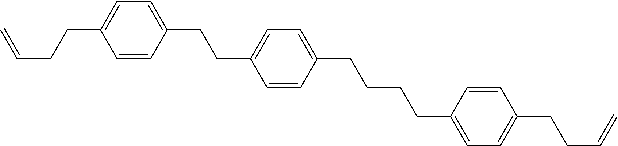 [SMILES: C=CCCc1ccc(CCCCc2ccc(CCc3ccc(CCC=C)cc3)cc2)cc1] |
| 16 | 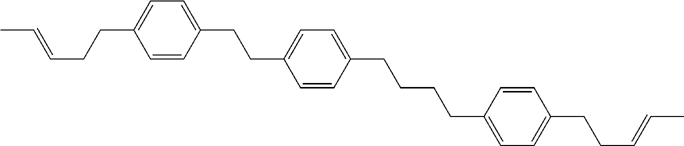 [SMILES: C/C=C/CCc1ccc(CCCCc2ccc(CCc3ccc(CC/C=C/C)cc3)cc2)cc1] |
| 17 | 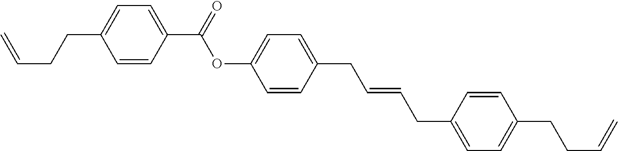 [SMILES: C=CCCc1ccc(C/C=C/Cc2ccc(OC(=O)c3ccc(CCC=C)cc3)cc2)cc1] |
| 18 | 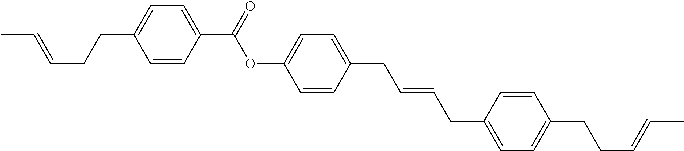 [SMILES: C/C=C/CCc1ccc(C/C=C/Cc2ccc(OC(=O)c3ccc(CC/C=C/C)cc3)cc2)cc1] |
| 19 | 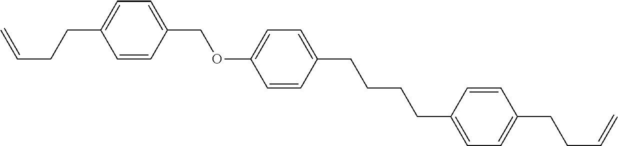 [SMILES: C=CCCc1ccc(CCCCc2ccc(OCc3ccc(CCC=C)cc3)cc2)cc1] |
| 20 | 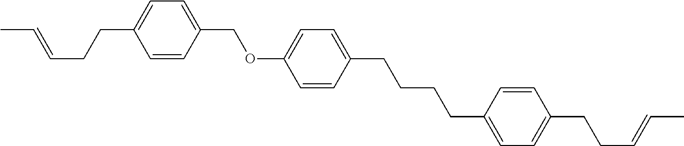 [SMILES: C/C=C/CCc1ccc(CCCCc2ccc(OCc3ccc(CC/C=C/C)cc3)cc2)cc1] |
| 21 | 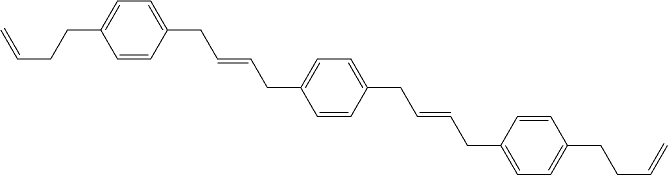 [SMILES: C=CCCc1ccc(C/C=C/Cc2ccc(C/C=C/Cc3ccc(CCC=C)cc3)cc2)cc1] |
| 22 | 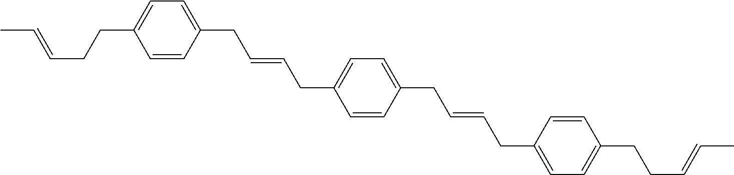 [SMILES: C/C=C/CCc1ccc(C/C=C/Cc2ccc(C/C=C/Cc3ccc(CC/C=C/C)cc3)cc2)cc1] |
| 23 | 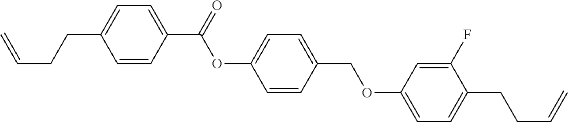 [SMILES: C=CCCc1ccc(C(=O)Oc2ccc(COc3ccc(CCC=C)c(F)c3)cc2)cc1] |
| 24 | 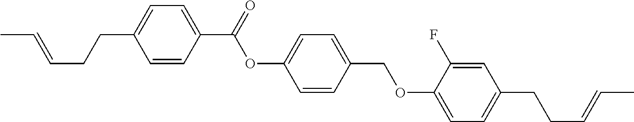 [SMILES: C/C=C/CCc1ccc(C(=O)Oc2ccc(COc3ccc(CC/C=C/C)cc3F)cc2)cc1] |
| 25 | 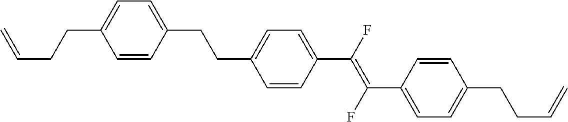 [SMILES: C=CCCc1ccc(CCc2ccc(/C(F)=C(\F)c3ccc(CCC=C)cc3)cc2)cc1] |
| 26 | 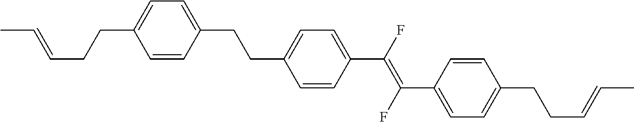 [SMILES: C/C=C/CCc1ccc(CCc2ccc(/C(F)=C(\F)c3ccc(CC/C=C/C)cc3)cc2)cc1] |
| 27 | 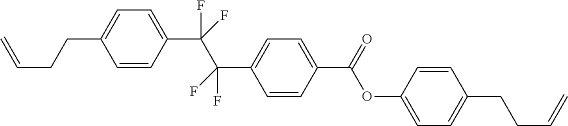 [SMILES: C=CCCc1ccc(OC(=O)c2ccc(C(F)(F)C(F)(F)c3ccc(CCC=C)cc3)cc2)cc1] |
| 28 | 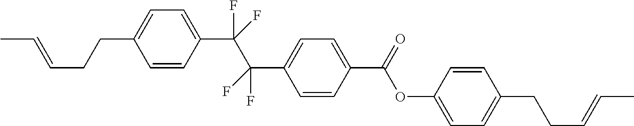 [SMILES: C/C=C/CCc1ccc(OC(=O)c2ccc(C(F)(F)C(F)(F)c3ccc(CC/C=C/C)cc3)cc2)cc1] |
| 29 | 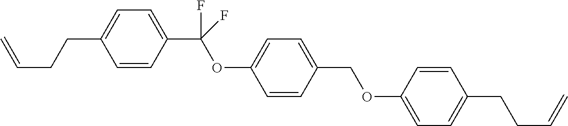 [SMILES: C=CCCc1ccc(OCc2ccc(OC(F)(F)c3ccc(CCC=C)cc3)cc2)cc1] |
| 30 | 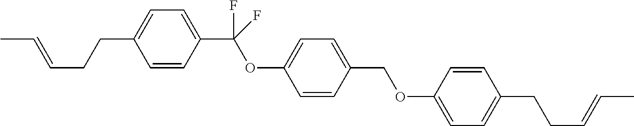 [SMILES: C/C=C/CCc1ccc(OCc2ccc(OC(F)(F)c3ccc(CC/C=C/C)cc3)cc2)cc1] |
| 31 | 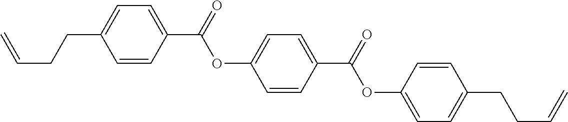 [SMILES: C=CCCc1ccc(OC(=O)c2ccc(OC(=O)c3ccc(CCC=C)cc3)cc2)cc1] |
| 32 | 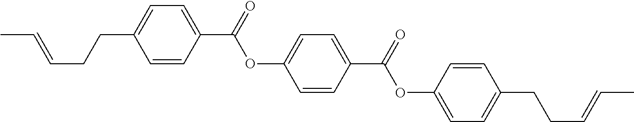 [SMILES: C/C=C/CCc1ccc(OC(=O)c2ccc(OC(=O)c3ccc(CC/C=C/C)cc3)cc2)cc1] |
| 33 | 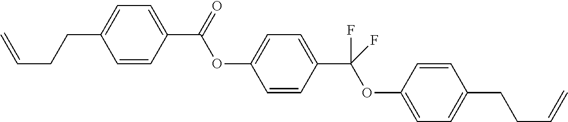 [SMILES: C=CCCc1ccc(OC(F)(F)c2ccc(OC(=O)c3ccc(CCC=C)cc3)cc2)cc1] |
| 34 | 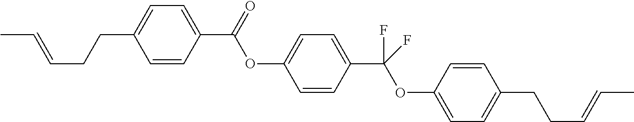 [SMILES: C/C=C/CCc1ccc(OC(F)(F)c2ccc(OC(=O)c3ccc(CC/C=C/C)cc3)cc2)cc1] |
| 35 | 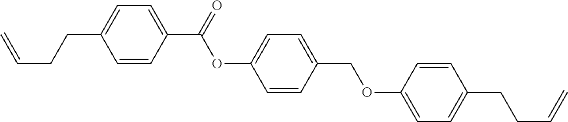 [SMILES: C=CCCc1ccc(OCc2ccc(OC(=O)c3ccc(CCC=C)cc3)cc2)cc1] |
| 36 | 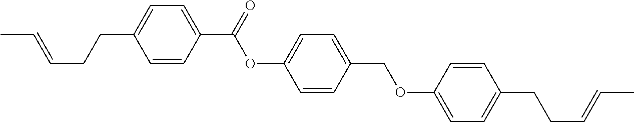 [SMILES: C/C=C/CCc1ccc(OCc2ccc(OC(=O)c3ccc(CC/C=C/C)cc3)cc2)cc1] |
| 37 | 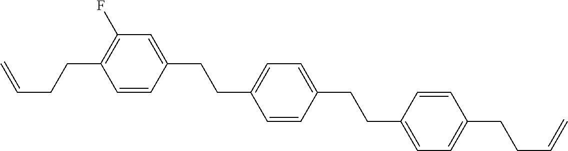 [SMILES: C=CCCc1ccc(CCc2ccc(CCc3ccc(CCC=C)c(F)c3)cc2)cc1] |
| 38 | 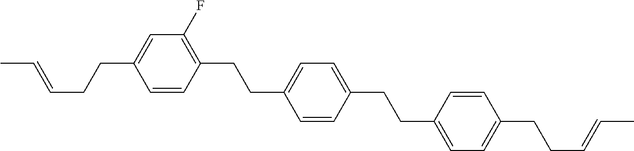 [SMILES: C/C=C/CCc1ccc(CCc2ccc(CCc3ccc(CC/C=C/C)cc3F)cc2)cc1] |
| 39 | 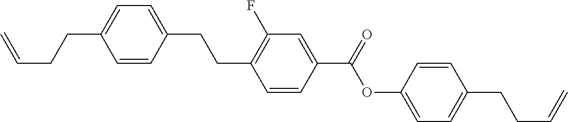 [SMILES: C=CCCc1ccc(CCc2ccc(C(=O)Oc3ccc(CCC=C)cc3)cc2F)cc1] |
| 40 | 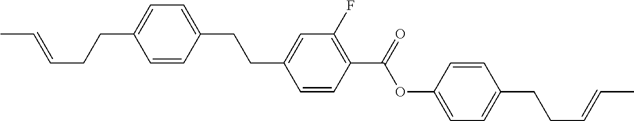 [SMILES: C/C=C/CCc1ccc(CCc2ccc(C(=O)Oc3ccc(CC/C=C/C)cc3)c(F)c2)cc1] |
| 41 | 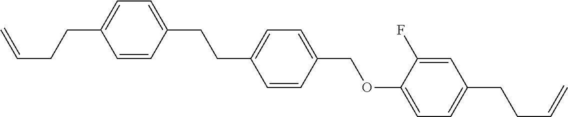 [SMILES: C=CCCc1ccc(CCc2ccc(COc3ccc(CCC=C)cc3F)cc2)cc1] |
| 42 | 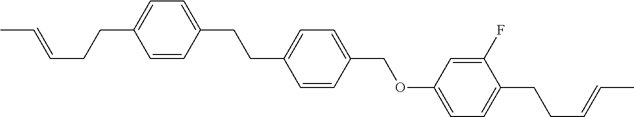 [SMILES: C/C=C/CCc1ccc(CCc2ccc(COc3ccc(CC/C=C/C)c(F)c3)cc2)cc1] |
| 43 | 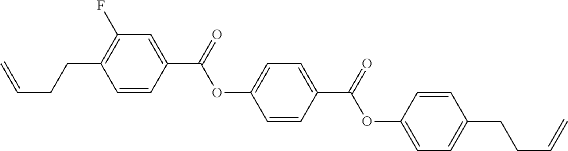 [SMILES: C=CCCc1ccc(OC(=O)c2ccc(OC(=O)c3ccc(CCC=C)c(F)c3)cc2)cc1] |
| 44 | 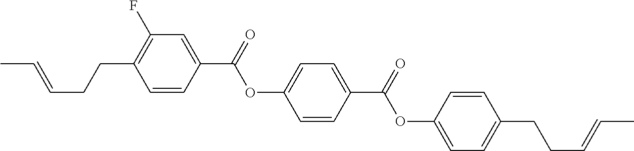 [SMILES: C/C=C/CCc1ccc(OC(=O)c2ccc(OC(=O)c3ccc(CC/C=C/C)c(F)c3)cc2)cc1] |
| 45 | 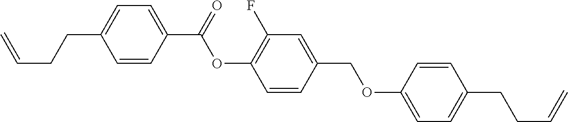 [SMILES: C=CCCc1ccc(OCc2ccc(OC(=O)c3ccc(CCC=C)cc3)c(F)c2)cc1] |
| 46 | 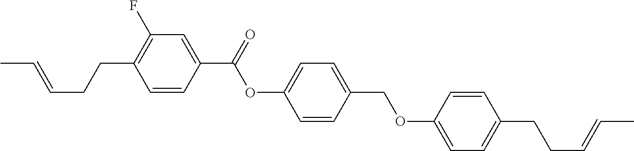 [SMILES: C/C=C/CCc1ccc(OCc2ccc(OC(=O)c3ccc(CC/C=C/C)c(F)c3)cc2)cc1] |
| 47 | 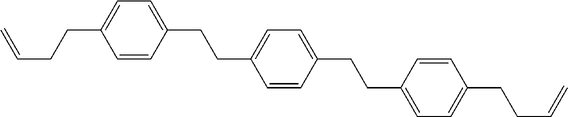 [SMILES: C=CCCc1ccc(CCc2ccc(CCc3ccc(CCC=C)cc3)cc2)cc1] |
| 48 | 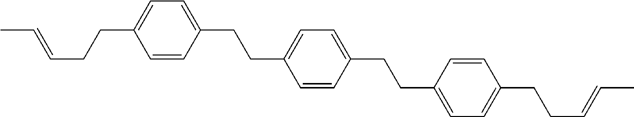 [SMILES: C/C=C/CCc1ccc(CCc2ccc(CCc3ccc(CC/C=C/C)cc3)cc2)cc1] |
| 49 | 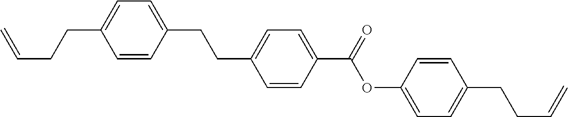 [SMILES: C=CCCc1ccc(CCc2ccc(C(=O)Oc3ccc(CCC=C)cc3)cc2)cc1] |
| 50 | 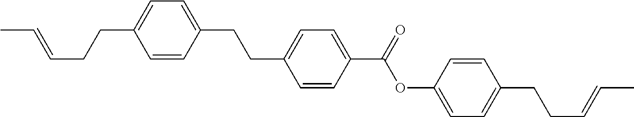 [SMILES: C/C=C/CCc1ccc(CCc2ccc(C(=O)Oc3ccc(CC/C=C/C)cc3)cc2)cc1] |
| 51 | 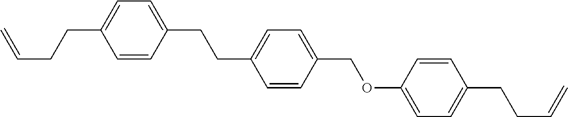 [SMILES: C=CCCc1ccc(CCc2ccc(COc3ccc(CCC=C)cc3)cc2)cc1] |
| 52 | 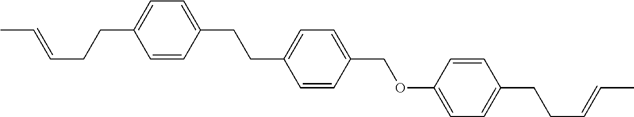 [SMILES: C/C=C/CCc1ccc(CCc2ccc(COc3ccc(CC/C=C/C)cc3)cc2)cc1] |
| 53 | 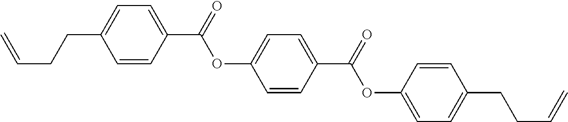 [SMILES: C=CCCc1ccc(OC(=O)c2ccc(OC(=O)c3ccc(CCC=C)cc3)cc2)cc1] |
| 54 | 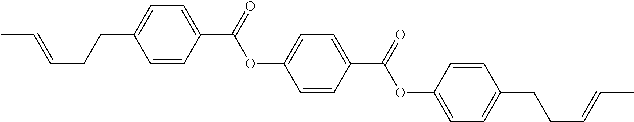 [SMILES: C/C=C/CCc1ccc(OC(=O)c2ccc(OC(=O)c3ccc(CC/C=C/C)cc3)cc2)cc1] |
| 55 | 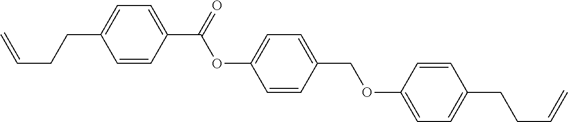 [SMILES: C=CCCc1ccc(OCc2ccc(OC(=O)c3ccc(CCC=C)cc3)cc2)cc1] |
| 56 | 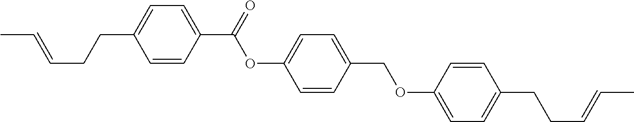 [SMILES: C/C=C/CCc1ccc(OCc2ccc(OC(=O)c3ccc(CC/C=C/C)cc3)cc2)cc1] |
| 57 | 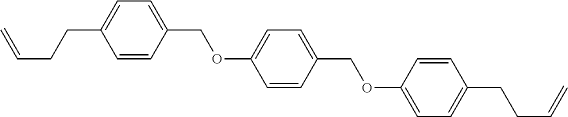 [SMILES: C=CCCc1ccc(COc2ccc(COc3ccc(CCC=C)cc3)cc2)cc1] |
| 58 | 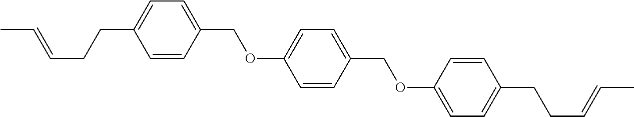 [SMILES: C/C=C/CCc1ccc(COc2ccc(COc3ccc(CC/C=C/C)cc3)cc2)cc1] |
| 59 | 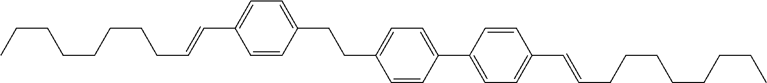 [SMILES: CCCCCCCC/C=C/c1ccc(CCc2ccc(-c3ccc(/C=C/CCCCCCCC)cc3)cc2)cc1] |
| 60 | 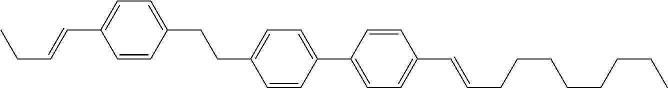 [SMILES: CC/C=C/c1ccc(CCc2ccc(-c3ccc(/C=C/CCCCCCCC)cc3)cc2)cc1] |
| 61 | 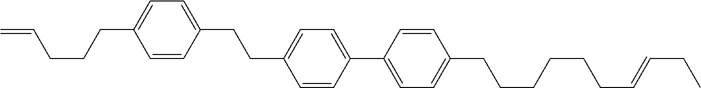 [SMILES: C=CCCCc1ccc(CCc2ccc(-c3ccc(CCCCCC/C=C/CC)cc3)cc2)cc1] |
| 62 | 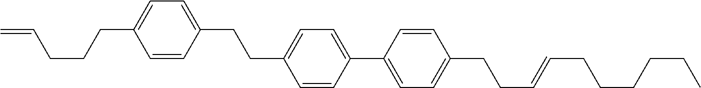 [SMILES: C=CCCCc1ccc(CCc2ccc(-c3ccc(CC/C=C/CCCCCC)cc3)cc2)cc1] |
| 63 | 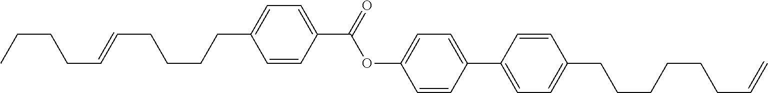 [SMILES: C=CCCCCCCc1ccc(-c2ccc(OC(=O)c3ccc(CCCC/C=C/CCCC)cc3)cc2)cc1] |
| 64 | 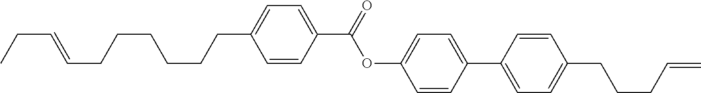 [SMILES: C=CCCCc1ccc(-c2ccc(OC(=O)c3ccc(CCCCCC/C=C/CC)cc3)cc2)cc1] |
| 65 | 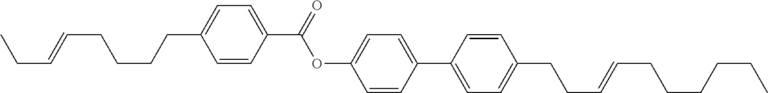 [SMILES: CC/C=C/CCCCc1ccc(C(=O)Oc2ccc(-c3ccc(CC/C=C/CCCCCC)cc3)cc2)cc1] |
| 66 | 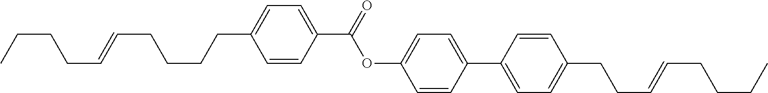 [SMILES: CCCC/C=C/CCCCc1ccc(C(=O)Oc2ccc(-c3ccc(CC/C=C/CCCC)cc3)cc2)cc1] |
| 67 | 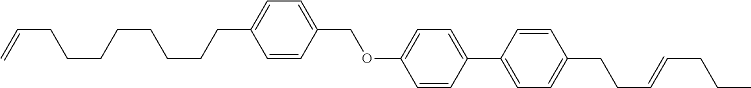 [SMILES: C=CCCCCCCCCc1ccc(COc2ccc(-c3ccc(CC/C=C/CCC)cc3)cc2)cc1] |
| 68 | 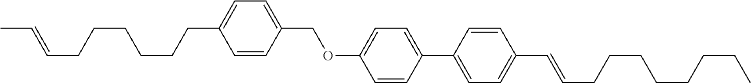 [SMILES: C/C=C/CCCCCCc1ccc(COc2ccc(-c3ccc(/C=C/CCCCCCCC)cc3)cc2)cc1] |
| 69 | 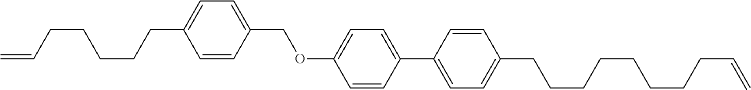 [SMILES: C=CCCCCCCCCc1ccc(-c2ccc(OCc3ccc(CCCCCC=C)cc3)cc2)cc1] |
| 70 | 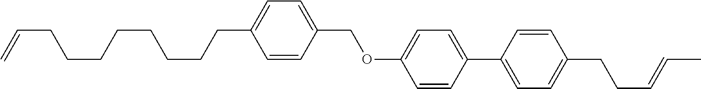 [SMILES: C=CCCCCCCCCc1ccc(COc2ccc(-c3ccc(CC/C=C/C)cc3)cc2)cc1] |
| 71 | 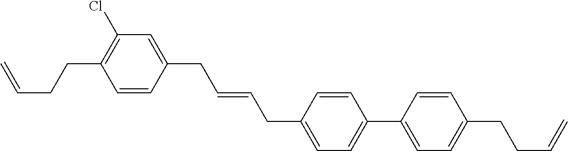 [SMILES: C=CCCc1ccc(-c2ccc(C/C=C/Cc3ccc(CCC=C)c(Cl)c3)cc2)cc1] |
| 72 | 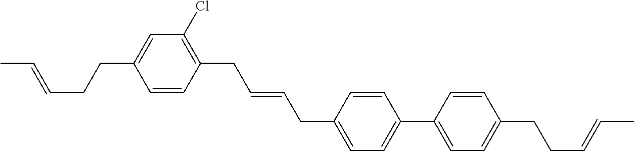 [SMILES: C/C=C/CCc1ccc(-c2ccc(C/C=C/Cc3ccc(CC/C=C/C)cc3Cl)cc2)cc1] |
| 73 | 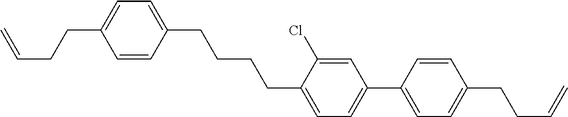 [SMILES: C=CCCc1ccc(CCCCc2ccc(-c3ccc(CCC=C)cc3)cc2Cl)cc1] |
| 74 | 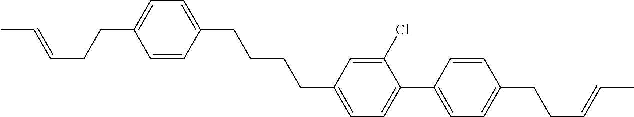 [SMILES: C/C=C/CCc1ccc(CCCCc2ccc(-c3ccc(CC/C=C/C)cc3)c(Cl)c2)cc1] |
| 75 | 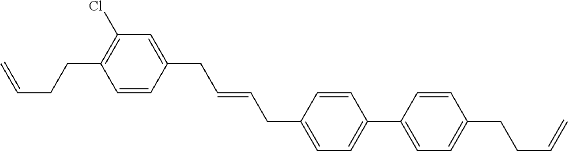 [SMILES: C=CCCc1ccc(-c2ccc(C/C=C/Cc3ccc(CCC=C)c(Cl)c3)cc2)cc1] |
| 76 | 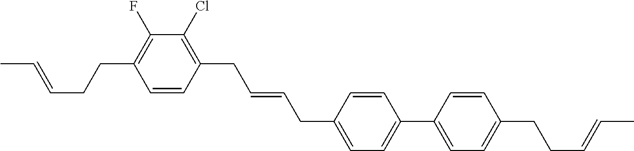 [SMILES: C/C=C/CCc1ccc(-c2ccc(C/C=C/Cc3ccc(CC/C=C/C)c(F)c3Cl)cc2)cc1] |
| 77 | 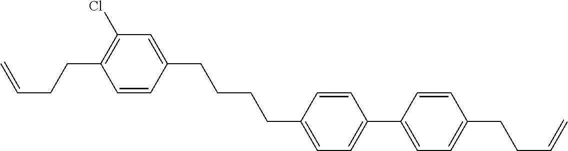 [SMILES: C=CCCc1ccc(-c2ccc(CCCCc3ccc(CCC=C)c(Cl)c3)cc2)cc1] |
| 78 | 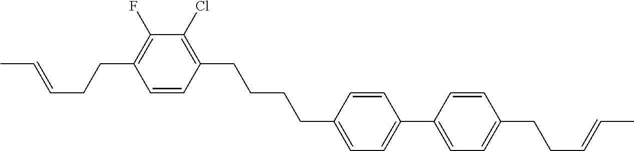 [SMILES: C/C=C/CCc1ccc(-c2ccc(CCCCc3ccc(CC/C=C/C)c(F)c3Cl)cc2)cc1] |
| 79 | 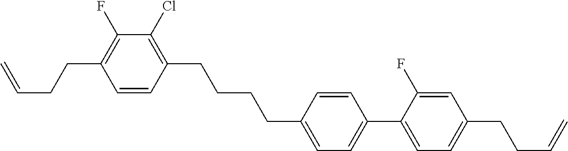 [SMILES: C=CCCc1ccc(-c2ccc(CCCCc3ccc(CCC=C)c(F)c3Cl)cc2)c(F)c1] |
| 80 | 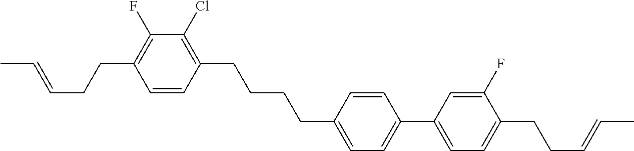 [SMILES: C/C=C/CCc1ccc(-c2ccc(CCCCc3ccc(CC/C=C/C)c(F)c3Cl)cc2)cc1F] |
| 81 | 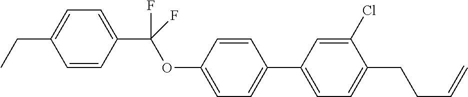 [SMILES: C=CCCc1ccc(-c2ccc(OC(F)(F)c3ccc(CC)cc3)cc2)cc1Cl] |
| 82 | 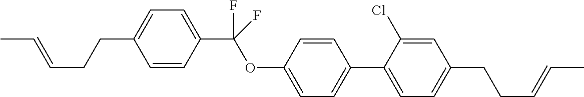 [SMILES: C/C=C/CCc1ccc(C(F)(F)Oc2ccc(-c3ccc(CC/C=C/C)cc3Cl)cc2)cc1] |
| 83 | 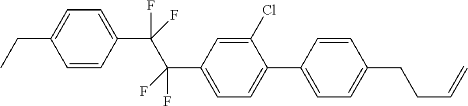 [SMILES: C=CCCc1ccc(-c2ccc(C(F)(F)C(F)(F)c3ccc(CC)cc3)cc2Cl)cc1] |
| 84 | 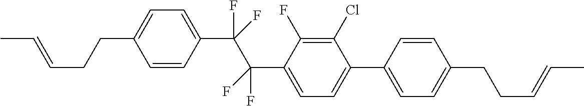 [SMILES: C/C=C/CCc1ccc(-c2ccc(C(F)(F)C(F)(F)c3ccc(CC/C=C/C)cc3)c(F)c2Cl)cc1] |
| 85 | 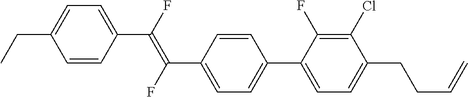 [SMILES: C=CCCc1ccc(-c2ccc(/C(F)=C(\F)c3ccc(CC)cc3)cc2)c(F)c1Cl] |
| 86 | 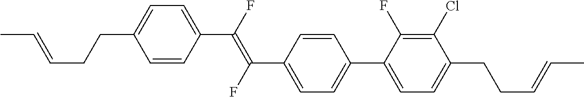 [SMILES: C/C=C/CCc1ccc(/C(F)=C(\F)c2ccc(-c3ccc(CC/C=C/C)c(Cl)c3F)cc2)cc1] |
| 87 | 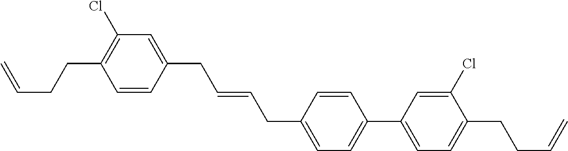 [SMILES: C=CCCc1ccc(C/C=C/Cc2ccc(-c3ccc(CCC=C)c(Cl)c3)cc2)cc1Cl] |
| 88 | 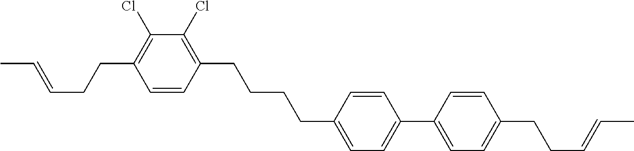 [SMILES: C/C=C/CCc1ccc(-c2ccc(CCCCc3ccc(CC/C=C/C)c(Cl)c3Cl)cc2)cc1] |
| 89 | 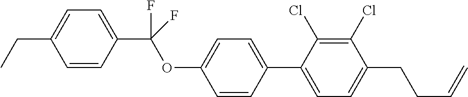 [SMILES: C=CCCc1ccc(-c2ccc(OC(F)(F)c3ccc(CC)cc3)cc2)c(Cl)c1Cl] |
| 90 | 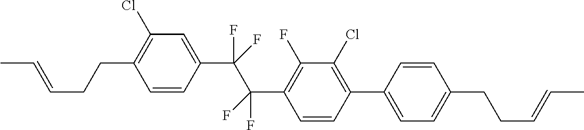 [SMILES: C/C=C/CCc1ccc(-c2ccc(C(F)(F)C(F)(F)c3ccc(CC/C=C/C)c(Cl)c3)c(F)c2Cl)cc1] |
| 91 | 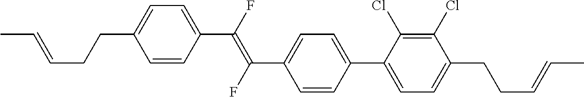 [SMILES: C/C=C/CCc1ccc(/C(F)=C(\F)c2ccc(-c3ccc(CC/C=C/C)c(Cl)c3Cl)cc2)cc1] |
| 92 | 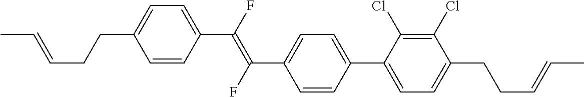 [SMILES: C/C=C/CCc1ccc(/C(F)=C(\F)c2ccc(-c3ccc(CC/C=C/C)c(Cl)c3Cl)cc2)cc1] |
| 93 | 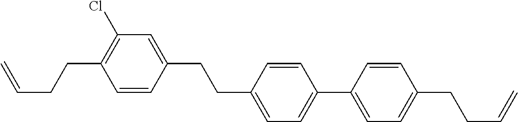 [SMILES: C=CCCc1ccc(-c2ccc(CCc3ccc(CCC=C)c(Cl)c3)cc2)cc1] |
| 94 | 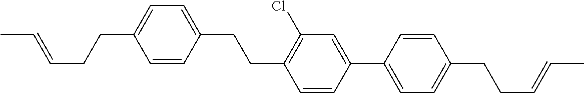 [SMILES: C/C=C/CCc1ccc(CCc2ccc(-c3ccc(CC/C=C/C)cc3)cc2Cl)cc1] |
| 95 | 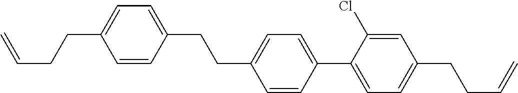 [SMILES: C=CCCc1ccc(CCc2ccc(-c3ccc(CCC=C)cc3Cl)cc2)cc1] |
| 96 | 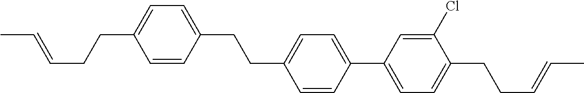 [SMILES: C/C=C/CCc1ccc(CCc2ccc(-c3ccc(CC/C=C/C)c(Cl)c3)cc2)cc1] |
| 97 | 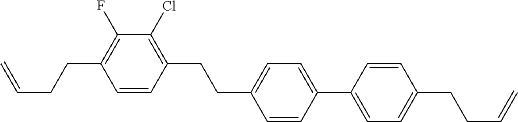 [SMILES: C=CCCc1ccc(-c2ccc(CCc3ccc(CCC=C)c(F)c3Cl)cc2)cc1] |
| 98 | 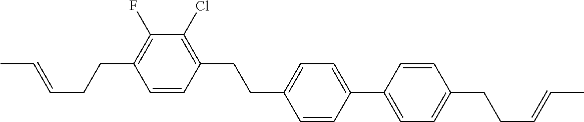 [SMILES: C/C=C/CCc1ccc(-c2ccc(CCc3ccc(CC/C=C/C)c(F)c3Cl)cc2)cc1] |
| 99 | 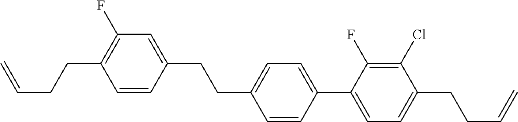 [SMILES: C=CCCc1ccc(CCc2ccc(-c3ccc(CCC=C)c(Cl)c3F)cc2)cc1F] |
| 100 | 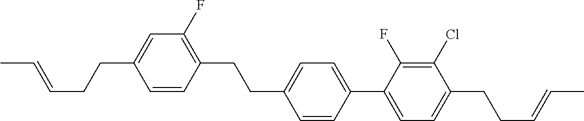 [SMILES: C/C=C/CCc1ccc(CCc2ccc(-c3ccc(CC/C=C/C)c(Cl)c3F)cc2)c(F)c1] |
| 101 | 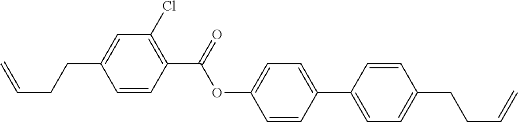 [SMILES: C=CCCc1ccc(-c2ccc(OC(=O)c3ccc(CCC=C)cc3Cl)cc2)cc1] |
| 102 | 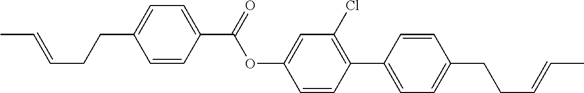 [SMILES: C/C=C/CCc1ccc(C(=O)Oc2ccc(-c3ccc(CC/C=C/C)cc3)c(Cl)c2)cc1] |
| 103 | 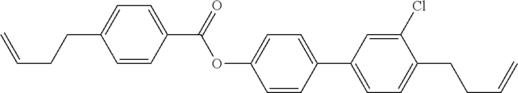 [SMILES: C=CCCc1ccc(C(=O)Oc2ccc(-c3ccc(CCC=C)c(Cl)c3)cc2)cc1] |
| 104 | 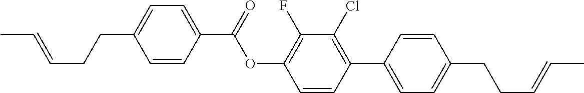 [SMILES: C/C=C/CCc1ccc(C(=O)Oc2ccc(-c3ccc(CC/C=C/C)cc3)c(Cl)c2F)cc1] |
| 105 | 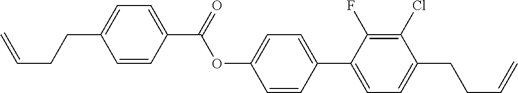 [SMILES: C=CCCc1ccc(C(=O)Oc2ccc(-c3ccc(CCC=C)c(Cl)c3F)cc2)cc1] |
| 106 | 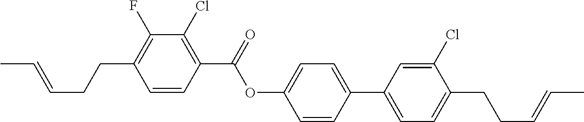 [SMILES: C/C=C/CCc1ccc(-c2ccc(OC(=O)c3ccc(CC/C=C/C)c(F)c3Cl)cc2)cc1Cl] |
| 107 | 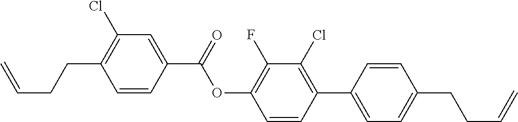 [SMILES: C=CCCc1ccc(-c2ccc(OC(=O)c3ccc(CCC=C)c(Cl)c3)c(F)c2Cl)cc1] |
| 108 | 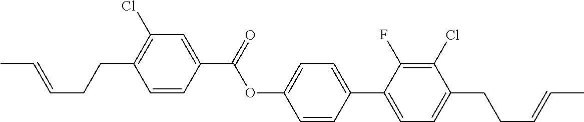 [SMILES: C/C=C/CCc1ccc(C(=O)Oc2ccc(-c3ccc(CC/C=C/C)c(Cl)c3F)cc2)cc1Cl] |
| 109 | 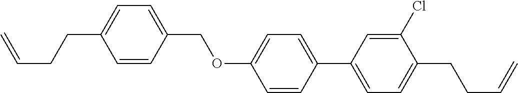 [SMILES: C=CCCc1ccc(COc2ccc(-c3ccc(CCC=C)c(Cl)c3)cc2)cc1] |
| 110 | 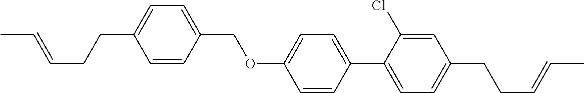 [SMILES: C/C=C/CCc1ccc(COc2ccc(-c3ccc(CC/C=C/C)cc3Cl)cc2)cc1] |
| 111 | 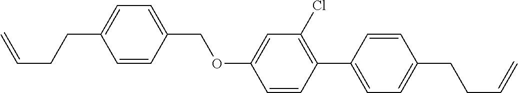 [SMILES: C=CCCc1ccc(COc2ccc(-c3ccc(CCC=C)cc3)c(Cl)c2)cc1] |
| 112 | 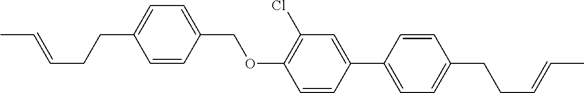 [SMILES: C/C=C/CCc1ccc(COc2ccc(-c3ccc(CC/C=C/C)cc3)cc2Cl)cc1] |
| 113 | 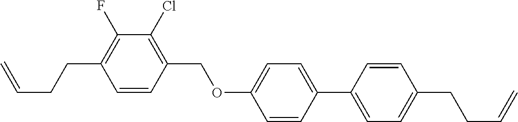 [SMILES: C=CCCc1ccc(-c2ccc(OCc3ccc(CCC=C)c(F)c3Cl)cc2)cc1] |
| 114 | 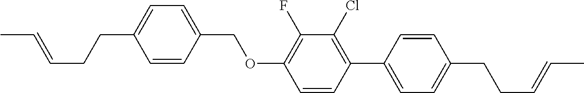 [SMILES: C/C=C/CCc1ccc(COc2ccc(-c3ccc(CC/C=C/C)cc3)c(Cl)c2F)cc1] |
| 115 | 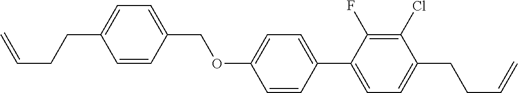 [SMILES: C=CCCc1ccc(COc2ccc(-c3ccc(CCC=C)c(Cl)c3F)cc2)cc1] |
| 116 | 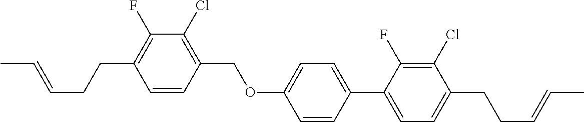 [SMILES: C/C=C/CCc1ccc(COc2ccc(-c3ccc(CC/C=C/C)c(Cl)c3F)cc2)c(Cl)c1F] |
| 117 | 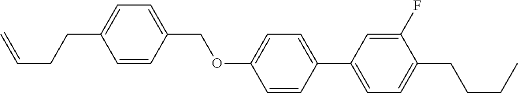 [SMILES: C=CCCc1ccc(COc2ccc(-c3ccc(CCCC)c(F)c3)cc2)cc1] |
| 118 | 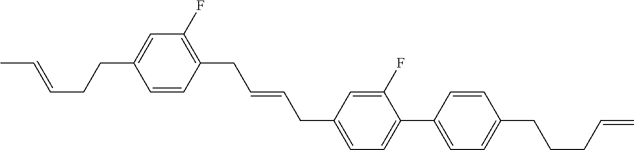 [SMILES: C=CCCCc1ccc(-c2ccc(C/C=C/Cc3ccc(CC/C=C/C)cc3F)cc2F)cc1] |
| 119 | 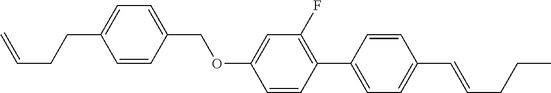 [SMILES: C=CCCc1ccc(COc2ccc(-c3ccc(/C=C/CCC)cc3)c(F)c2)cc1] |
| 120 | 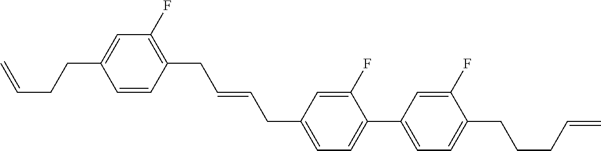 [SMILES: C=CCCCc1ccc(-c2ccc(C/C=C/Cc3ccc(CCC=C)cc3F)cc2F)cc1F] |
| 121 | 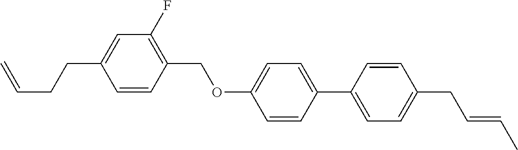 [SMILES: C=CCCc1ccc(COc2ccc(-c3ccc(C/C=C/C)cc3)cc2)c(F)c1] |
| 122 | 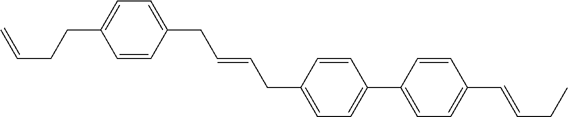 [SMILES: C=CCCc1ccc(C/C=C/Cc2ccc(-c3ccc(/C=C/CC)cc3)cc2)cc1] |
| 123 | 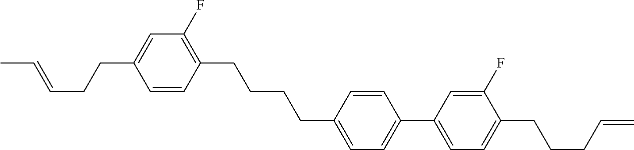 [SMILES: C=CCCCc1ccc(-c2ccc(CCCCc3ccc(CC/C=C/C)cc3F)cc2)cc1F] |
| 124 | 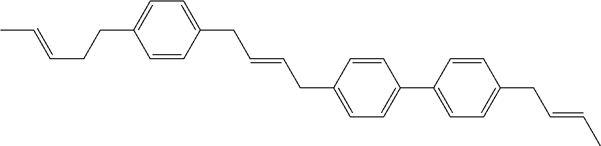 [SMILES: C/C=C/CCc1ccc(C/C=C/Cc2ccc(-c3ccc(C/C=C/C)cc3)cc2)cc1] |
| 125 | 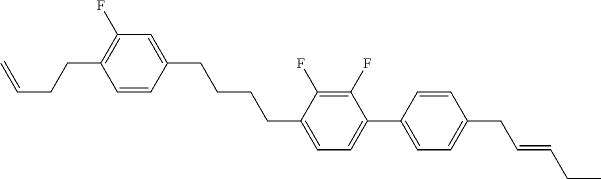 [SMILES: C=CCCc1ccc(CCCCc2ccc(-c3ccc(C/C=C/CC)cc3)c(F)c2F)cc1F] |
| 126 | 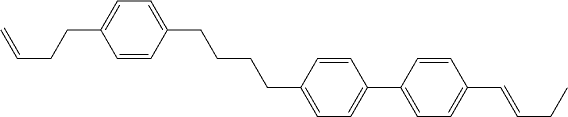 [SMILES: C=CCCc1ccc(CCCCc2ccc(-c3ccc(/C=C/CC)cc3)cc2)cc1] |
| 127 | 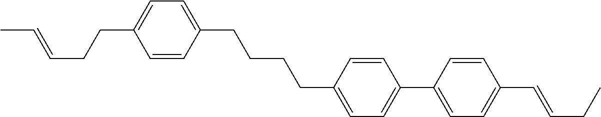 [SMILES: C/C=C/CCc1ccc(CCCCc2ccc(-c3ccc(/C=C/CC)cc3)cc2)cc1] |
| 128 | 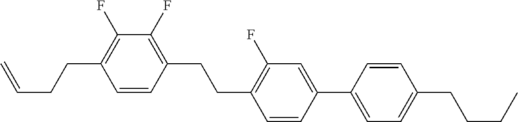 [SMILES: C=CCCc1ccc(CCc2ccc(-c3ccc(CCCC)cc3)cc2F)c(F)c1F] |
| 129 | 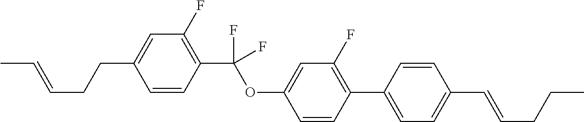 [SMILES: C/C=C/CCc1ccc(C(F)(F)Oc2ccc(-c3ccc(/C=C/CCC)cc3)c(F)c2)c(F)c1] |
| 130 | 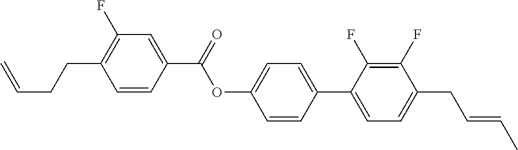 [SMILES: C=CCCc1ccc(C(=O)Oc2ccc(-c3ccc(C/C=C/C)c(F)c3F)cc2)cc1F] |
| 131 | 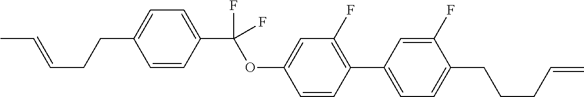 [SMILES: C=CCCCc1ccc(-c2ccc(OC(F)(F)c3ccc(CC/C=C/C)cc3)cc2F)cc1F] |
| 132 | 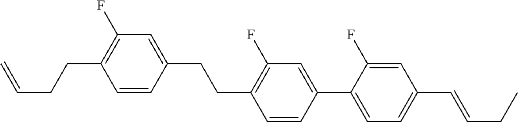 [SMILES: C=CCCc1ccc(CCc2ccc(-c3ccc(/C=C/CC)cc3F)cc2F)cc1F] |
| 133 | 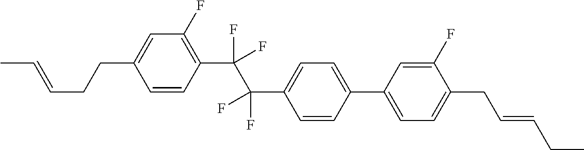 [SMILES: C/C=C/CCc1ccc(C(F)(F)C(F)(F)c2ccc(-c3ccc(C/C=C/CC)c(F)c3)cc2)c(F)c1] |
| 134 | 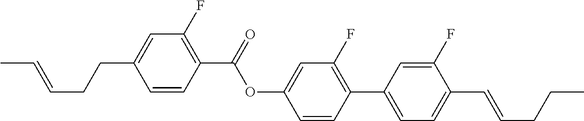 [SMILES: C/C=C/CCc1ccc(C(=O)Oc2ccc(-c3ccc(/C=C/CCC)c(F)c3)c(F)c2)c(F)c1] |
| 135 | 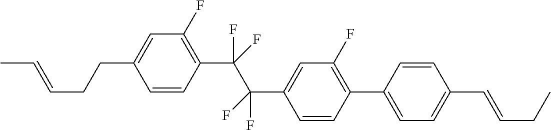 [SMILES: C/C=C/CCc1ccc(C(F)(F)C(F)(F)c2ccc(-c3ccc(/C=C/CC)cc3)c(F)c2)c(F)c1] |
| 136 | 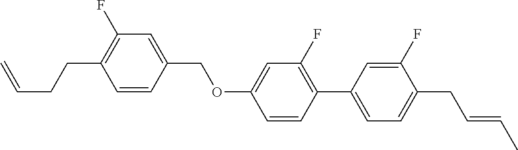 [SMILES: C=CCCc1ccc(COc2ccc(-c3ccc(C/C=C/C)c(F)c3)c(F)c2)cc1F] |
| 137 | 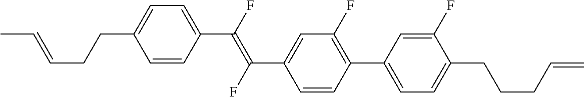 [SMILES: C=CCCCc1ccc(-c2ccc(/C(F)=C(\F)c3ccc(CC/C=C/C)cc3)cc2F)cc1F] |
| 138 | 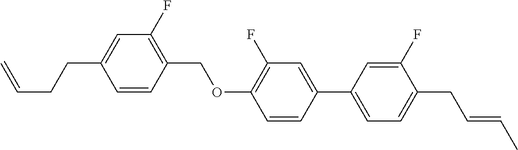 [SMILES: C=CCCc1ccc(COc2ccc(-c3ccc(C/C=C/C)c(F)c3)cc2F)c(F)c1] |
| 139 | 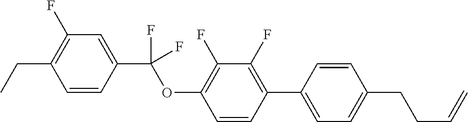 [SMILES: C=CCCc1ccc(-c2ccc(OC(F)(F)c3ccc(CC)c(F)c3)c(F)c2F)cc1] |
| 140 | 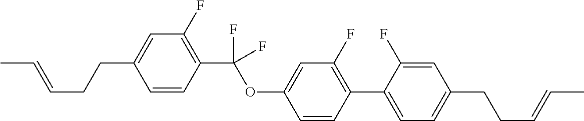 [SMILES: C/C=C/CCc1ccc(-c2ccc(OC(F)(F)c3ccc(CC/C=C/C)cc3F)cc2F)c(F)c1] |
| 141 | 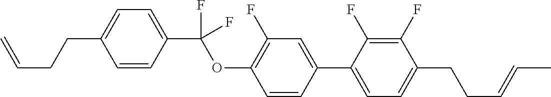 [SMILES: C=CCCc1ccc(C(F)(F)Oc2ccc(-c3ccc(CC/C=C/C)c(F)c3F)cc2F)cc1] |
| 142 | 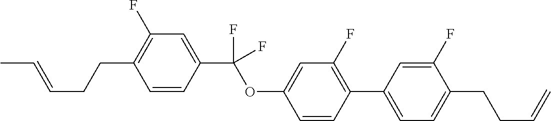 [SMILES: C=CCCc1ccc(-c2ccc(OC(F)(F)c3ccc(CC/C=C/C)c(F)c3)cc2F)cc1F] |
| 143 | 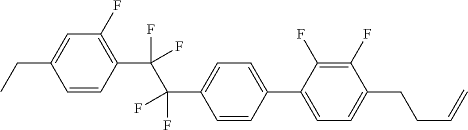 [SMILES: C=CCCc1ccc(-c2ccc(C(F)(F)C(F)(F)c3ccc(CC)cc3F)cc2)c(F)c1F] |
| 144 | 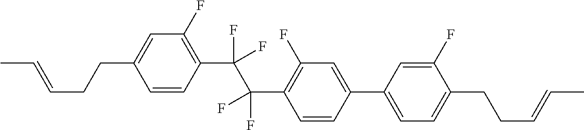 [SMILES: C/C=C/CCc1ccc(C(F)(F)C(F)(F)c2ccc(-c3ccc(CC/C=C/C)c(F)c3)cc2F)c(F)c1] |
| 145 | 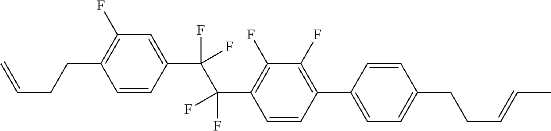 [SMILES: C=CCCc1ccc(C(F)(F)C(F)(F)c2ccc(-c3ccc(CC/C=C/C)cc3)c(F)c2F)cc1F] |
| 146 | 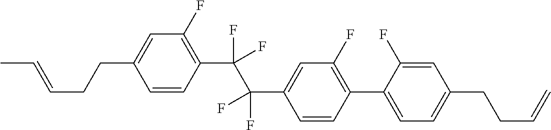 [SMILES: C=CCCc1ccc(-c2ccc(C(F)(F)C(F)(F)c3ccc(CC/C=C/C)cc3F)cc2F)c(F)c1] |
| 147 | 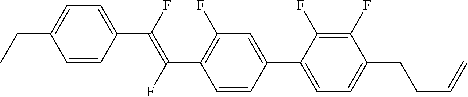 [SMILES: C=CCCc1ccc(-c2ccc(/C(F)=C(\F)c3ccc(CC)cc3)c(F)c2)c(F)c1F] |
| 148 | 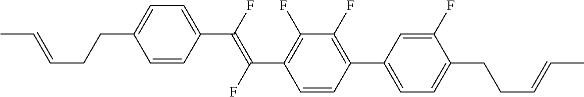 [SMILES: C/C=C/CCc1ccc(/C(F)=C(\F)c2ccc(-c3ccc(CC/C=C/C)c(F)c3)c(F)c2F)cc1] |
| 149 | 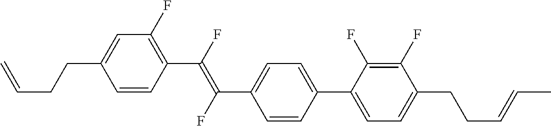 [SMILES: C=CCCc1ccc(/C(F)=C(\F)c2ccc(-c3ccc(CC/C=C/C)c(F)c3F)cc2)c(F)c1] |
| 150 | 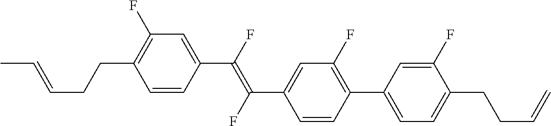 [SMILES: C=CCCc1ccc(-c2ccc(/C(F)=C(\F)c3ccc(CC/C=C/C)c(F)c3)cc2F)cc1F] |
| 151 | 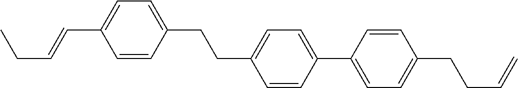 [SMILES: C=CCCc1ccc(-c2ccc(CCc3ccc(/C=C/CC)cc3)cc2)cc1] |
| 152 | 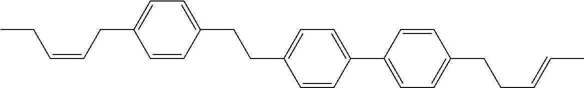 [SMILES: C/C=C/CCc1ccc(-c2ccc(CCc3ccc(C/C=C\CC)cc3)cc2)cc1] |
| 153 | 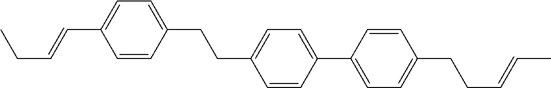 [SMILES: C/C=C/CCc1ccc(-c2ccc(CCc3ccc(/C=C/CC)cc3)cc2)cc1] |
| 154 | 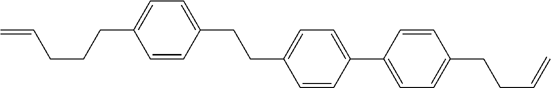 [SMILES: C=CCCCc1ccc(CCc2ccc(-c3ccc(CCC=C)cc3)cc2)cc1] |
| 155 | 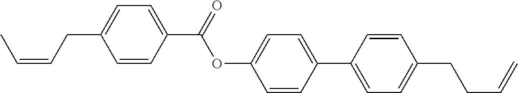 [SMILES: C=CCCc1ccc(-c2ccc(OC(=O)c3ccc(C/C=C\C)cc3)cc2)cc1] |
| 156 | 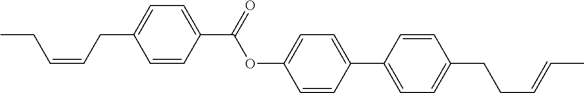 [SMILES: C/C=C/CCc1ccc(-c2ccc(OC(=O)c3ccc(C/C=C\CC)cc3)cc2)cc1] |
| 157 | 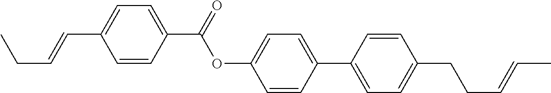 [SMILES: C/C=C/CCc1ccc(-c2ccc(OC(=O)c3ccc(/C=C/CC)cc3)cc2)cc1] |
| 158 | 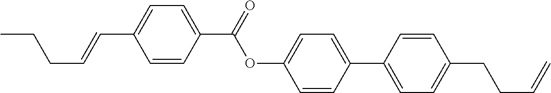 [SMILES: C=CCCc1ccc(-c2ccc(OC(=O)c3ccc(/C=C/CCC)cc3)cc2)cc1] |
| 159 | 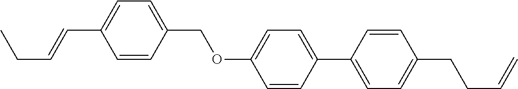 [SMILES: C=CCCc1ccc(-c2ccc(OCc3ccc(/C=C/CC)cc3)cc2)cc1] |
| 160 | 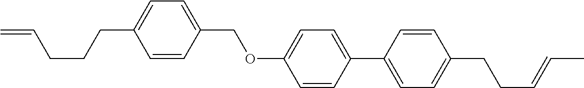 [SMILES: C=CCCCc1ccc(COc2ccc(-c3ccc(CC/C=C/C)cc3)cc2)cc1] |
| 161 | 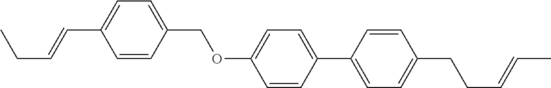 [SMILES: C/C=C/CCc1ccc(-c2ccc(OCc3ccc(/C=C/CC)cc3)cc2)cc1] |
| 162 | 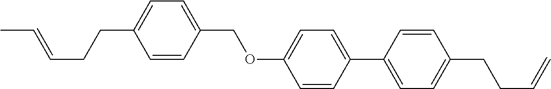 [SMILES: C=CCCc1ccc(-c2ccc(OCc3ccc(CC/C=C/C)cc3)cc2)cc1] |
| 163 | 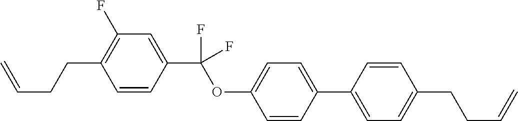 [SMILES: C=CCCc1ccc(-c2ccc(OC(F)(F)c3ccc(CCC=C)c(F)c3)cc2)cc1] |
| 164 | 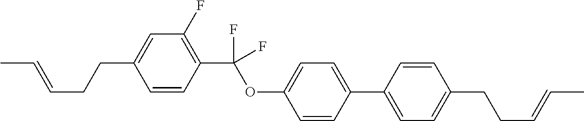 [SMILES: C/C=C/CCc1ccc(-c2ccc(OC(F)(F)c3ccc(CC/C=C/C)cc3F)cc2)cc1] |
| 165 | 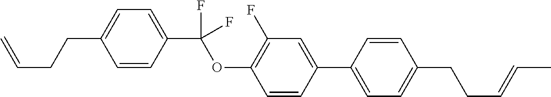 [SMILES: C=CCCc1ccc(C(F)(F)Oc2ccc(-c3ccc(CC/C=C/C)cc3)cc2F)cc1] |
| 166 | 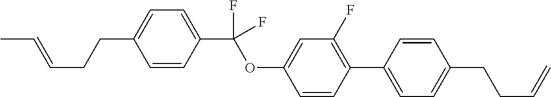 [SMILES: C=CCCc1ccc(-c2ccc(OC(F)(F)c3ccc(CC/C=C/C)cc3)cc2F)cc1] |
| 167 | 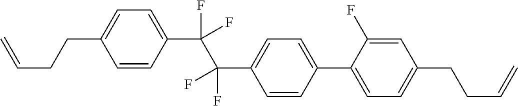 [SMILES: C=CCCc1ccc(C(F)(F)C(F)(F)c2ccc(-c3ccc(CCC=C)cc3F)cc2)cc1] |
| 168 | 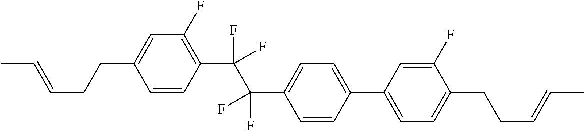 [SMILES: C/C=C/CCc1ccc(C(F)(F)C(F)(F)c2ccc(-c3ccc(CC/C=C/C)c(F)c3)cc2)c(F)c1] |
| 169 | 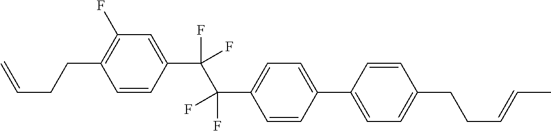 [SMILES: C=CCCc1ccc(C(F)(F)C(F)(F)c2ccc(-c3ccc(CC/C=C/C)cc3)cc2)cc1F] |
| 170 | 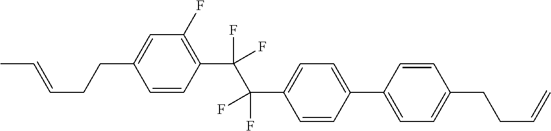 [SMILES: C=CCCc1ccc(-c2ccc(C(F)(F)C(F)(F)c3ccc(CC/C=C/C)cc3F)cc2)cc1] |
| 171 | 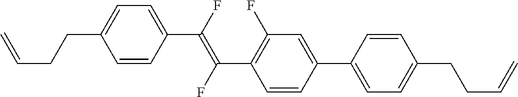 [SMILES: C=CCCc1ccc(/C(F)=C(\F)c2ccc(-c3ccc(CCC=C)cc3)cc2F)cc1] |
| 172 | 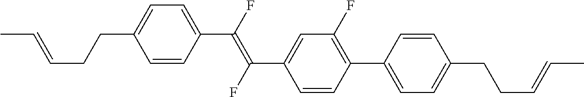 [SMILES: C/C=C/CCc1ccc(/C(F)=C(\F)c2ccc(-c3ccc(CC/C=C/C)cc3)c(F)c2)cc1] |
| 173 | 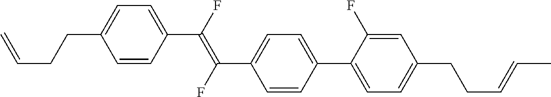 [SMILES: C=CCCc1ccc(/C(F)=C(\F)c2ccc(-c3ccc(CC/C=C/C)cc3F)cc2)cc1] |
| 174 | 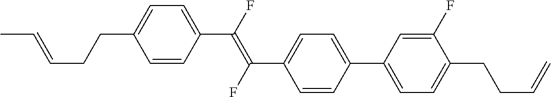 [SMILES: C=CCCc1ccc(-c2ccc(/C(F)=C(\F)c3ccc(CC/C=C/C)cc3)cc2)cc1F] |
| 175 | 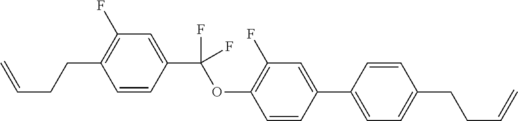 [SMILES: C=CCCc1ccc(-c2ccc(OC(F)(F)c3ccc(CCC=C)c(F)c3)c(F)c2)cc1] |
| 176 | 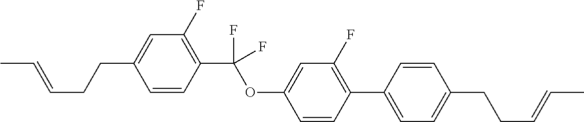 [SMILES: C/C=C/CCc1ccc(-c2ccc(OC(F)(F)c3ccc(CC/C=C/C)cc3F)cc2F)cc1] |
| 177 | 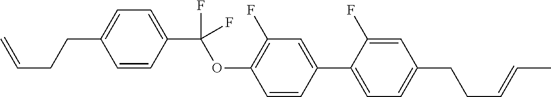 [SMILES: C=CCCc1ccc(C(F)(F)Oc2ccc(-c3ccc(CC/C=C/C)cc3F)cc2F)cc1] |
| 178 | 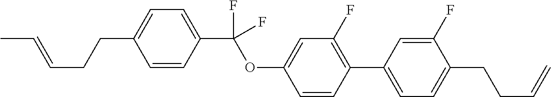 [SMILES: C=CCCc1ccc(-c2ccc(OC(F)(F)c3ccc(CC/C=C/C)cc3)cc2F)cc1F] |
| 179 | 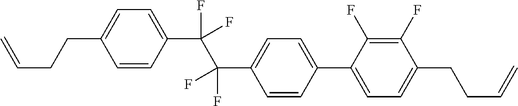 [SMILES: C=CCCc1ccc(C(F)(F)C(F)(F)c2ccc(-c3ccc(CCC=C)c(F)c3F)cc2)cc1] |
| 180 | 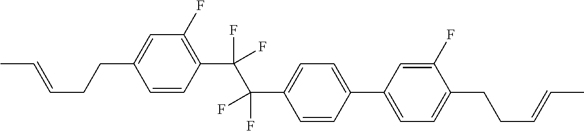 [SMILES: C/C=C/CCc1ccc(C(F)(F)C(F)(F)c2ccc(-c3ccc(CC/C=C/C)c(F)c3)cc2)c(F)c1] |
| 181 | 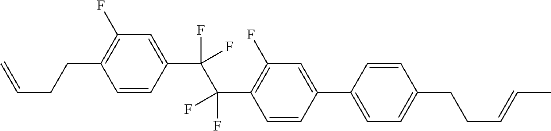 [SMILES: C=CCCc1ccc(C(F)(F)C(F)(F)c2ccc(-c3ccc(CC/C=C/C)cc3)cc2F)cc1F] |
| 182 | 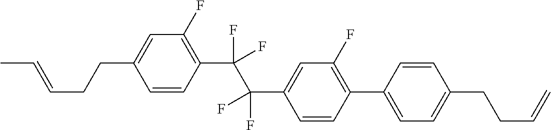 [SMILES: C=CCCc1ccc(-c2ccc(C(F)(F)C(F)(F)c3ccc(CC/C=C/C)cc3F)cc2F)cc1] |
| 183 | 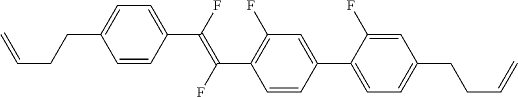 [SMILES: C=CCCc1ccc(/C(F)=C(\F)c2ccc(-c3ccc(CCC=C)cc3F)cc2F)cc1] |
| 184 | 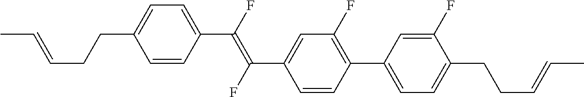 [SMILES: C/C=C/CCc1ccc(/C(F)=C(\F)c2ccc(-c3ccc(CC/C=C/C)c(F)c3)c(F)c2)cc1] |
| 185 | 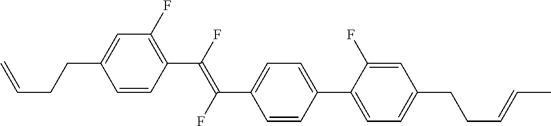 [SMILES: C=CCCc1ccc(/C(F)=C(\F)c2ccc(-c3ccc(CC/C=C/C)cc3F)cc2)c(F)c1] |
| 186 | 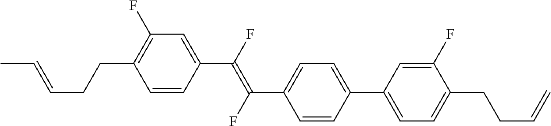 [SMILES: C=CCCc1ccc(-c2ccc(/C(F)=C(\F)c3ccc(CC/C=C/C)c(F)c3)cc2)cc1F] |
| 187 | 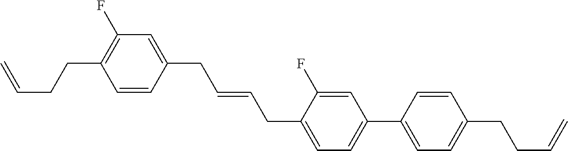 [SMILES: C=CCCc1ccc(-c2ccc(C/C=C/Cc3ccc(CCC=C)c(F)c3)c(F)c2)cc1] |
| 188 | 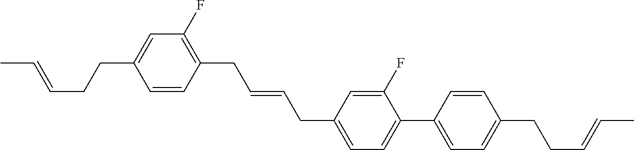 [SMILES: C/C=C/CCc1ccc(-c2ccc(C/C=C/Cc3ccc(CC/C=C/C)cc3F)cc2F)cc1] |
| 189 | 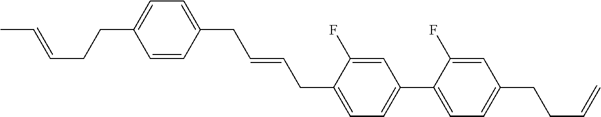 [SMILES: C=CCCc1ccc(-c2ccc(C/C=C/Cc3ccc(CC/C=C/C)cc3)c(F)c2)c(F)c1] |
| 190 | 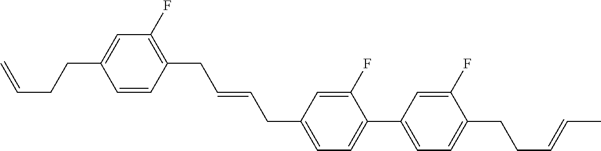 [SMILES: C=CCCc1ccc(C/C=C/Cc2ccc(-c3ccc(CC/C=C/C)c(F)c3)c(F)c2)c(F)c1] |
| 191 | 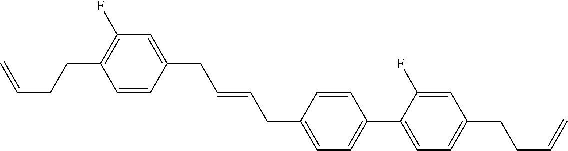 [SMILES: C=CCCc1ccc(-c2ccc(C/C=C/Cc3ccc(CCC=C)c(F)c3)cc2)c(F)c1] |
| 192 | 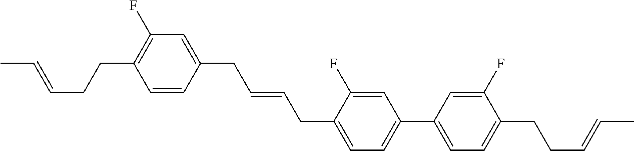 [SMILES: C/C=C/CCc1ccc(C/C=C/Cc2ccc(-c3ccc(CC/C=C/C)c(F)c3)cc2F)cc1F] |
| 193 | 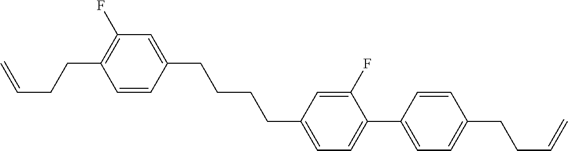 [SMILES: C=CCCc1ccc(-c2ccc(CCCCc3ccc(CCC=C)c(F)c3)cc2F)cc1] |
| 194 | 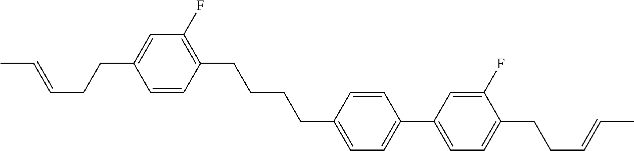 [SMILES: C/C=C/CCc1ccc(CCCCc2ccc(-c3ccc(CC/C=C/C)c(F)c3)cc2)c(F)c1] |
| 195 | 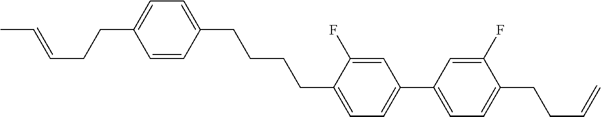 [SMILES: C=CCCc1ccc(-c2ccc(CCCCc3ccc(CC/C=C/C)cc3)c(F)c2)cc1F] |
| 196 | 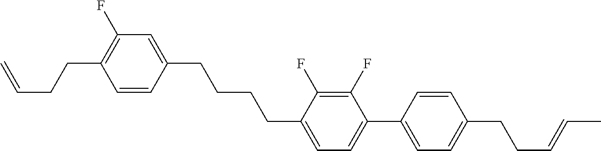 [SMILES: C=CCCc1ccc(CCCCc2ccc(-c3ccc(CC/C=C/C)cc3)c(F)c2F)cc1F] |
| 197 | 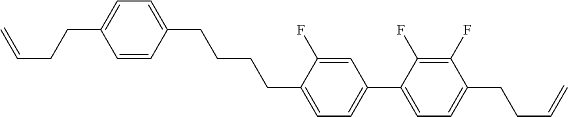 [SMILES: C=CCCc1ccc(CCCCc2ccc(-c3ccc(CCC=C)c(F)c3F)cc2F)cc1] |
| 198 | 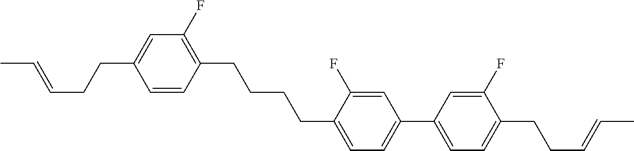 [SMILES: C/C=C/CCc1ccc(CCCCc2ccc(-c3ccc(CC/C=C/C)c(F)c3)cc2F)c(F)c1] |
| 199 | 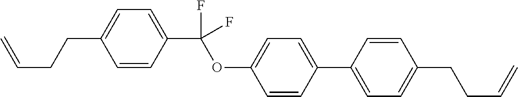 [SMILES: C=CCCc1ccc(-c2ccc(OC(F)(F)c3ccc(CCC=C)cc3)cc2)cc1] |
| 200 | 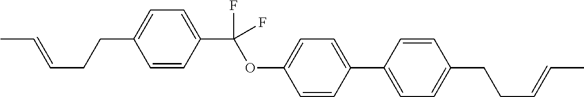 [SMILES: C/C=C/CCc1ccc(-c2ccc(OC(F)(F)c3ccc(CC/C=C/C)cc3)cc2)cc1] |
| 201 | 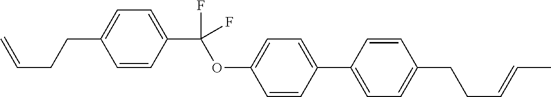 [SMILES: C=CCCc1ccc(C(F)(F)Oc2ccc(-c3ccc(CC/C=C/C)cc3)cc2)cc1] |
| 202 | 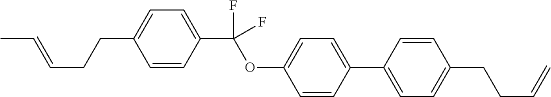 [SMILES: C=CCCc1ccc(-c2ccc(OC(F)(F)c3ccc(CC/C=C/C)cc3)cc2)cc1] |
| 203 | 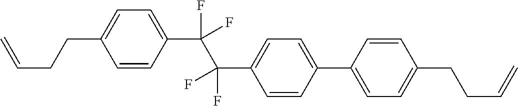 [SMILES: C=CCCc1ccc(-c2ccc(C(F)(F)C(F)(F)c3ccc(CCC=C)cc3)cc2)cc1] |
| 204 | 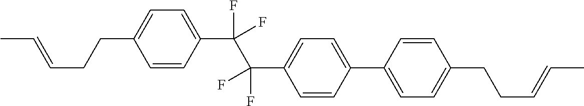 [SMILES: C/C=C/CCc1ccc(-c2ccc(C(F)(F)C(F)(F)c3ccc(CC/C=C/C)cc3)cc2)cc1] |
| 205 | 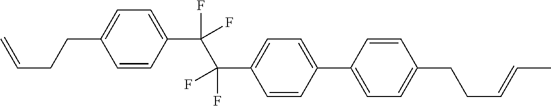 [SMILES: C=CCCc1ccc(C(F)(F)C(F)(F)c2ccc(-c3ccc(CC/C=C/C)cc3)cc2)cc1] |
| 206 | 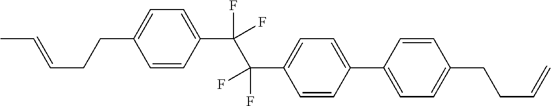 [SMILES: C=CCCc1ccc(-c2ccc(C(F)(F)C(F)(F)c3ccc(CC/C=C/C)cc3)cc2)cc1] |
| 207 | 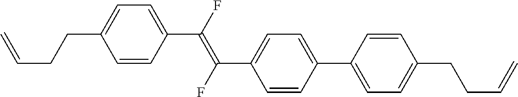 [SMILES: C=CCCc1ccc(/C(F)=C(\F)c2ccc(-c3ccc(CCC=C)cc3)cc2)cc1] |
| 208 | 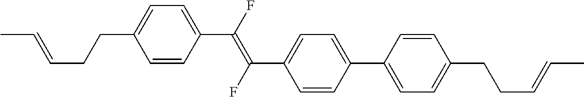 [SMILES: C/C=C/CCc1ccc(/C(F)=C(\F)c2ccc(-c3ccc(CC/C=C/C)cc3)cc2)cc1] |
| 209 | 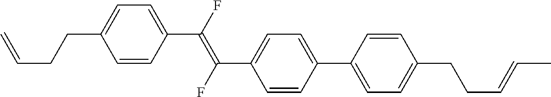 [SMILES: C=CCCc1ccc(/C(F)=C(\F)c2ccc(-c3ccc(CC/C=C/C)cc3)cc2)cc1] |
| 210 | 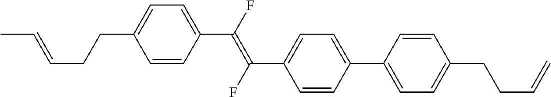 [SMILES: C=CCCc1ccc(-c2ccc(/C(F)=C(\F)c3ccc(CC/C=C/C)cc3)cc2)cc1] |
| 211 | 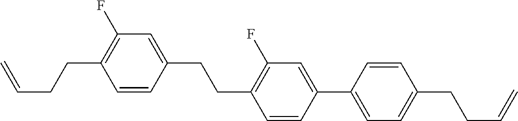 [SMILES: C=CCCc1ccc(-c2ccc(CCc3ccc(CCC=C)c(F)c3)c(F)c2)cc1] |
| 212 | 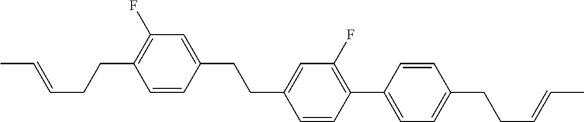 [SMILES: C/C=C/CCc1ccc(-c2ccc(CCc3ccc(CC/C=C/C)c(F)c3)cc2F)cc1] |
| 213 | 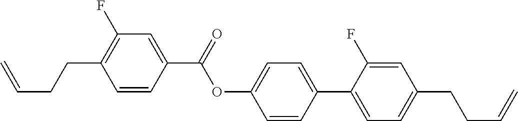 [SMILES: C=CCCc1ccc(-c2ccc(OC(=O)c3ccc(CCC=C)c(F)c3)cc2)c(F)c1] |
| 214 | 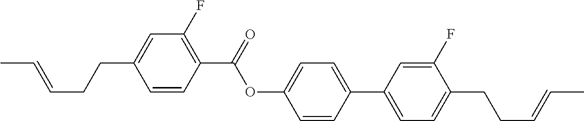 [SMILES: C/C=C/CCc1ccc(C(=O)Oc2ccc(-c3ccc(CC/C=C/C)c(F)c3)cc2)c(F)c1] |
| 215 | 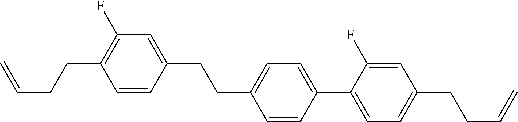 [SMILES: C=CCCc1ccc(-c2ccc(CCc3ccc(CCC=C)c(F)c3)cc2)c(F)c1] |
| 216 | 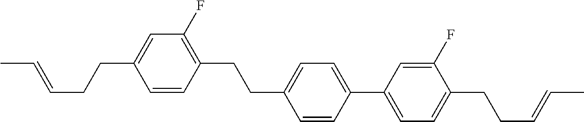 [SMILES: C/C=C/CCc1ccc(CCc2ccc(-c3ccc(CC/C=C/C)c(F)c3)cc2)c(F)c1] |
| 217 | 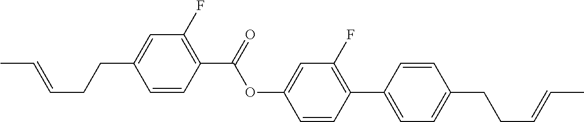 [SMILES: C/C=C/CCc1ccc(-c2ccc(OC(=O)c3ccc(CC/C=C/C)cc3F)cc2F)cc1] |
| 218 | 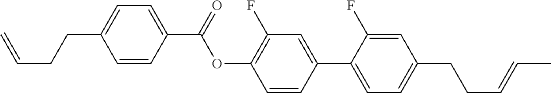 [SMILES: C=CCCc1ccc(C(=O)Oc2ccc(-c3ccc(CC/C=C/C)cc3F)cc2F)cc1] |
| 219 | 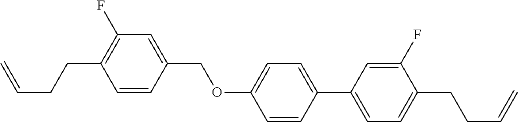 [SMILES: C=CCCc1ccc(COc2ccc(-c3ccc(CCC=C)c(F)c3)cc2)cc1F] |
| 220 | 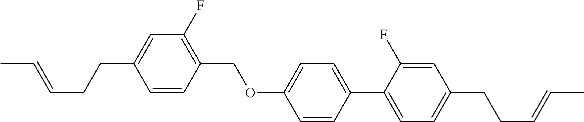 [SMILES: C/C=C/CCc1ccc(COc2ccc(-c3ccc(CC/C=C/C)cc3F)cc2)c(F)c1] |
| 221 | 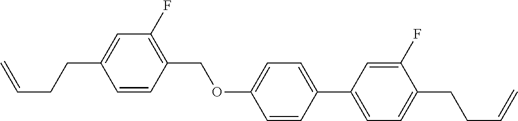 [SMILES: C=CCCc1ccc(COc2ccc(-c3ccc(CCC=C)c(F)c3)cc2)c(F)c1] |
| 222 | 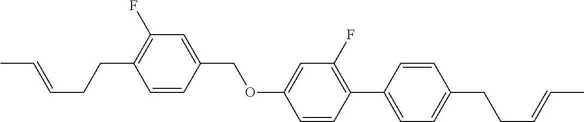 [SMILES: C/C=C/CCc1ccc(-c2ccc(OCc3ccc(CC/C=C/C)c(F)c3)cc2F)cc1] |
| 223 | 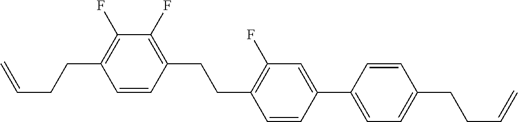 [SMILES: C=CCCc1ccc(-c2ccc(CCc3ccc(CCC=C)c(F)c3F)c(F)c2)cc1] |
| 224 | 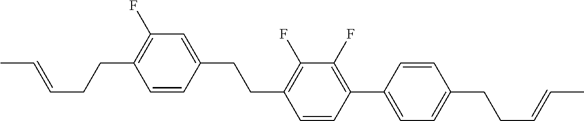 [SMILES: C/C=C/CCc1ccc(-c2ccc(CCc3ccc(CC/C=C/C)c(F)c3)c(F)c2F)cc1] |
| 225 | 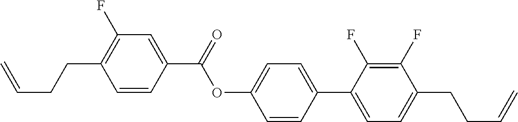 [SMILES: C=CCCc1ccc(C(=O)Oc2ccc(-c3ccc(CCC=C)c(F)c3F)cc2)cc1F] |
| 226 | 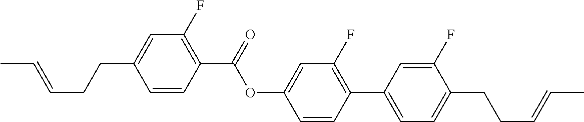 [SMILES: C/C=C/CCc1ccc(C(=O)Oc2ccc(-c3ccc(CC/C=C/C)c(F)c3)c(F)c2)c(F)c1] |
| 227 | 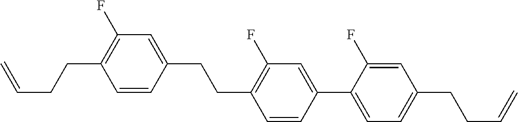 [SMILES: C=CCCc1ccc(-c2ccc(CCc3ccc(CCC=C)c(F)c3)c(F)c2)c(F)c1] |
| 228 | 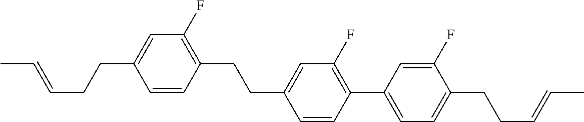 [SMILES: C/C=C/CCc1ccc(CCc2ccc(-c3ccc(CC/C=C/C)c(F)c3)c(F)c2)c(F)c1] |
| 229 | 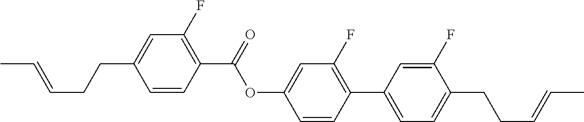 [SMILES: C/C=C/CCc1ccc(C(=O)Oc2ccc(-c3ccc(CC/C=C/C)c(F)c3)c(F)c2)c(F)c1] |
| 230 | 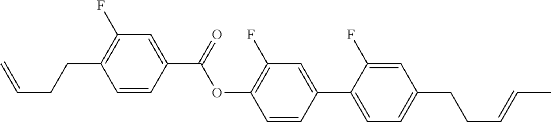 [SMILES: C=CCCc1ccc(C(=O)Oc2ccc(-c3ccc(CC/C=C/C)cc3F)cc2F)cc1F] |
| 231 | 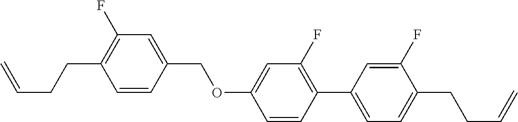 [SMILES: C=CCCc1ccc(COc2ccc(-c3ccc(CCC=C)c(F)c3)c(F)c2)cc1F] |
| 232 | 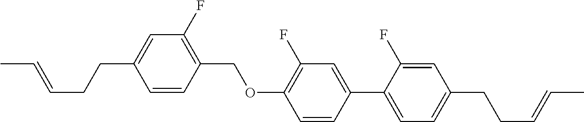 [SMILES: C/C=C/CCc1ccc(COc2ccc(-c3ccc(CC/C=C/C)cc3F)cc2F)c(F)c1] |
| 233 | 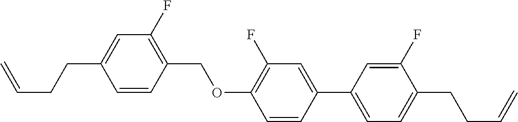 [SMILES: C=CCCc1ccc(COc2ccc(-c3ccc(CCC=C)c(F)c3)cc2F)c(F)c1] |
| 234 | 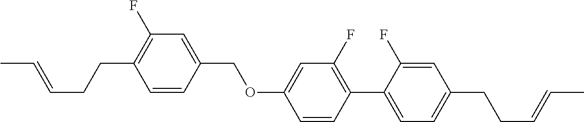 [SMILES: C/C=C/CCc1ccc(-c2ccc(OCc3ccc(CC/C=C/C)c(F)c3)cc2F)c(F)c1] |
| 235 | 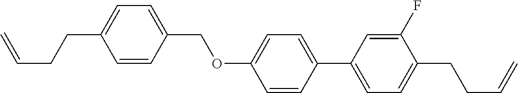 [SMILES: C=CCCc1ccc(COc2ccc(-c3ccc(CCC=C)c(F)c3)cc2)cc1] |
| 236 | 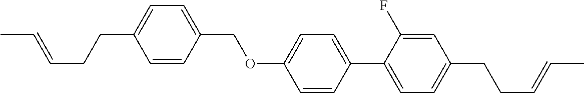 [SMILES: C/C=C/CCc1ccc(COc2ccc(-c3ccc(CC/C=C/C)cc3F)cc2)cc1] |
| 237 | 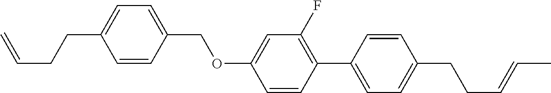 [SMILES: C=CCCc1ccc(COc2ccc(-c3ccc(CC/C=C/C)cc3)c(F)c2)cc1] |
| 238 | 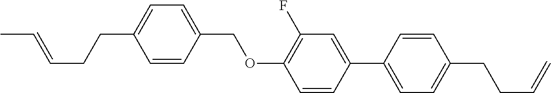 [SMILES: C=CCCc1ccc(-c2ccc(OCc3ccc(CC/C=C/C)cc3)c(F)c2)cc1] |
| 239 | 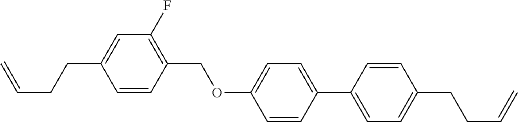 [SMILES: C=CCCc1ccc(-c2ccc(OCc3ccc(CCC=C)cc3F)cc2)cc1] |
| 240 | 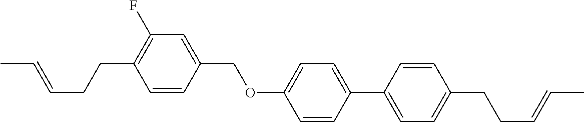 [SMILES: C/C=C/CCc1ccc(-c2ccc(OCc3ccc(CC/C=C/C)c(F)c3)cc2)cc1] |
| 241 | 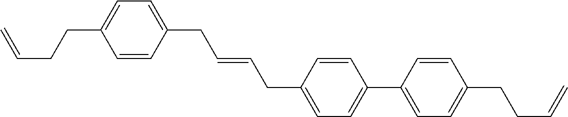 [SMILES: C=CCCc1ccc(C/C=C/Cc2ccc(-c3ccc(CCC=C)cc3)cc2)cc1] |
| 242 | 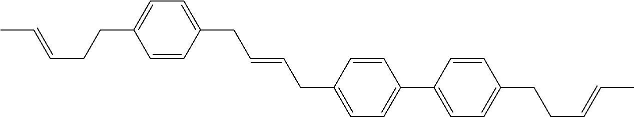 [SMILES: C/C=C/CCc1ccc(C/C=C/Cc2ccc(-c3ccc(CC/C=C/C)cc3)cc2)cc1] |
| 243 | 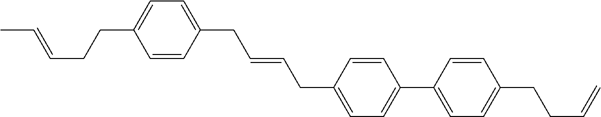 [SMILES: C=CCCc1ccc(-c2ccc(C/C=C/Cc3ccc(CC/C=C/C)cc3)cc2)cc1] |
| 244 | 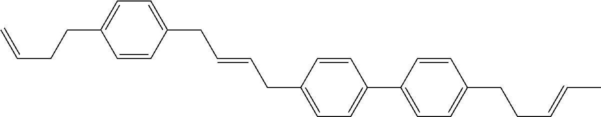 [SMILES: C=CCCc1ccc(C/C=C/Cc2ccc(-c3ccc(CC/C=C/C)cc3)cc2)cc1] |
| 245 | 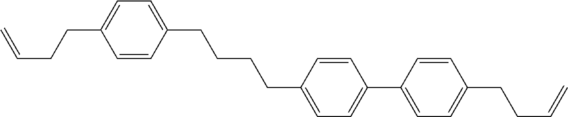 [SMILES: C=CCCc1ccc(CCCCc2ccc(-c3ccc(CCC=C)cc3)cc2)cc1] |
| 246 | 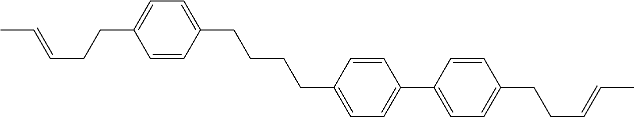 [SMILES: C/C=C/CCc1ccc(CCCCc2ccc(-c3ccc(CC/C=C/C)cc3)cc2)cc1] |
| 247 | 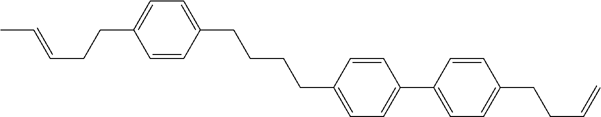 [SMILES: C=CCCc1ccc(-c2ccc(CCCCc3ccc(CC/C=C/C)cc3)cc2)cc1] |
| 248 | 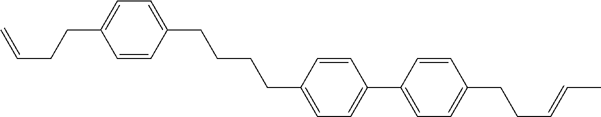 [SMILES: C=CCCc1ccc(CCCCc2ccc(-c3ccc(CC/C=C/C)cc3)cc2)cc1] |
| 249 | 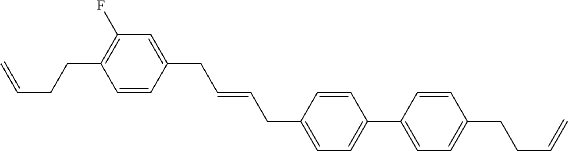 [SMILES: C=CCCc1ccc(-c2ccc(C/C=C/Cc3ccc(CCC=C)c(F)c3)cc2)cc1] |
| 250 | 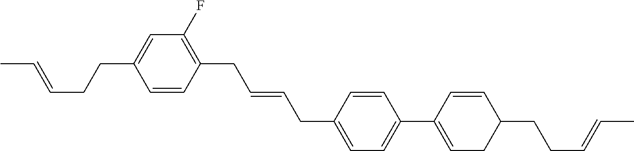 [SMILES: C/C=C/CCc1ccc(C/C=C/Cc2ccc(C3=CCC(CC/C=C/C)C=C3)cc2)c(F)c1] |
| 251 | 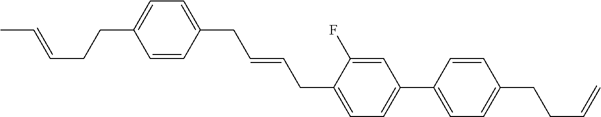 [SMILES: C=CCCc1ccc(-c2ccc(C/C=C/Cc3ccc(CC/C=C/C)cc3)c(F)c2)cc1] |
| 252 | 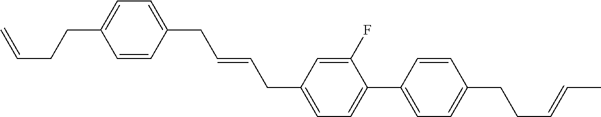 [SMILES: C=CCCc1ccc(C/C=C/Cc2ccc(-c3ccc(CC/C=C/C)cc3)c(F)c2)cc1] |
| 253 | 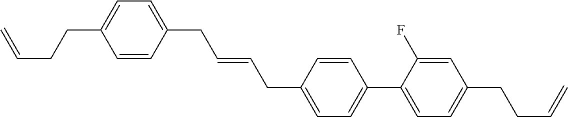 [SMILES: C=CCCc1ccc(C/C=C/Cc2ccc(-c3ccc(CCC=C)cc3F)cc2)cc1] |
| 254 | 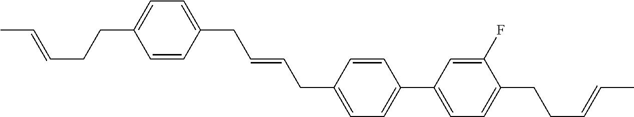 [SMILES: C/C=C/CCc1ccc(C/C=C/Cc2ccc(-c3ccc(CC/C=C/C)c(F)c3)cc2)cc1] |
| 255 | 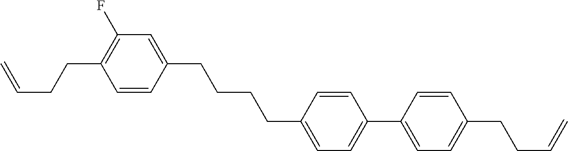 [SMILES: C=CCCc1ccc(-c2ccc(CCCCc3ccc(CCC=C)c(F)c3)cc2)cc1] |
| 256 | 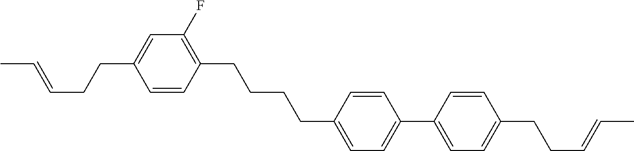 [SMILES: C/C=C/CCc1ccc(-c2ccc(CCCCc3ccc(CC/C=C/C)cc3F)cc2)cc1] |
| 257 | 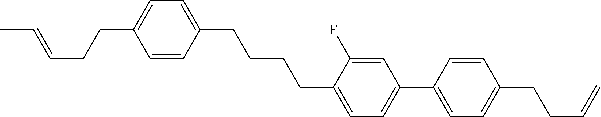 [SMILES: C=CCCc1ccc(-c2ccc(CCCCc3ccc(CC/C=C/C)cc3)c(F)c2)cc1] |
| 258 | 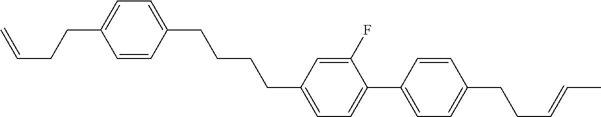 [SMILES: C=CCCc1ccc(CCCCc2ccc(-c3ccc(CC/C=C/C)cc3)c(F)c2)cc1] |
| 259 | 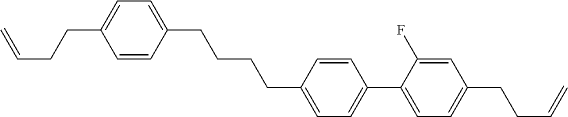 [SMILES: C=CCCc1ccc(CCCCc2ccc(-c3ccc(CCC=C)cc3F)cc2)cc1] |
| 260 | 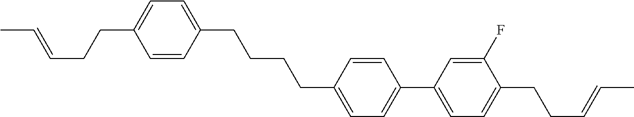 [SMILES: C/C=C/CCc1ccc(CCCCc2ccc(-c3ccc(CC/C=C/C)c(F)c3)cc2)cc1] |
| 261 | 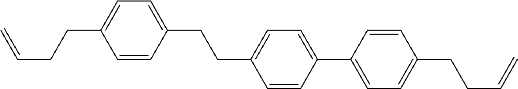 [SMILES: C=CCCc1ccc(CCc2ccc(-c3ccc(CCC=C)cc3)cc2)cc1] |
| 262 | 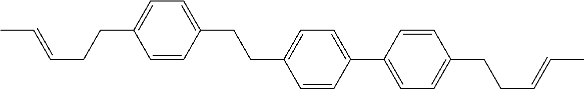 [SMILES: C/C=C/CCc1ccc(CCc2ccc(-c3ccc(CC/C=C/C)cc3)cc2)cc1] |
| 263 | 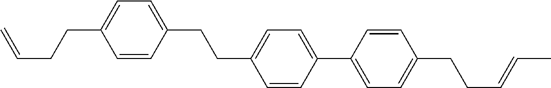 [SMILES: C=CCCc1ccc(CCc2ccc(-c3ccc(CC/C=C/C)cc3)cc2)cc1] |
| 264 | 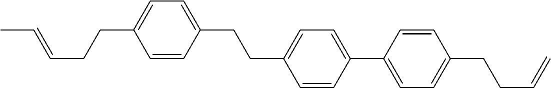 [SMILES: C=CCCc1ccc(-c2ccc(CCc3ccc(CC/C=C/C)cc3)cc2)cc1] |
| 265 | 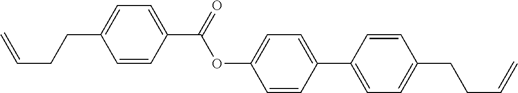 [SMILES: C=CCCc1ccc(C(=O)Oc2ccc(-c3ccc(CCC=C)cc3)cc2)cc1] |
| 266 | 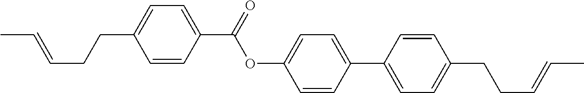 [SMILES: C/C=C/CCc1ccc(C(=O)Oc2ccc(-c3ccc(CC/C=C/C)cc3)cc2)cc1] |
| 267 | 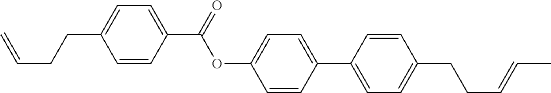 [SMILES: C=CCCc1ccc(C(=O)Oc2ccc(-c3ccc(CC/C=C/C)cc3)cc2)cc1] |
| 268 | 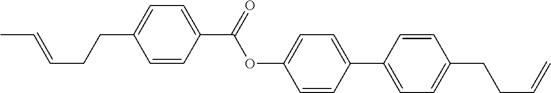 [SMILES: C=CCCc1ccc(-c2ccc(OC(=O)c3ccc(CC/C=C/C)cc3)cc2)cc1] |
| 269 | 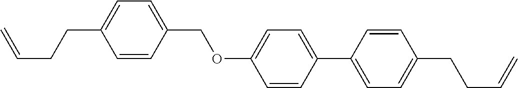 [SMILES: C=CCCc1ccc(COc2ccc(-c3ccc(CCC=C)cc3)cc2)cc1] |
| 270 | 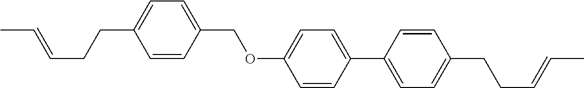 [SMILES: C/C=C/CCc1ccc(COc2ccc(-c3ccc(CC/C=C/C)cc3)cc2)cc1] |
| 271 | 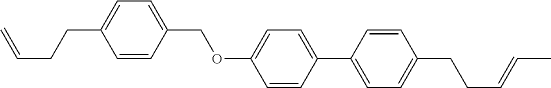 [SMILES: C=CCCc1ccc(COc2ccc(-c3ccc(CC/C=C/C)cc3)cc2)cc1] |
| 272 | 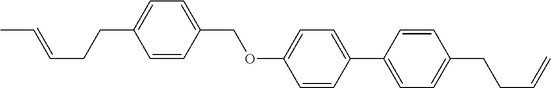 [SMILES: C=CCCc1ccc(-c2ccc(OCc3ccc(CC/C=C/C)cc3)cc2)cc1] |
| 273 | 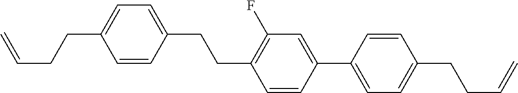 [SMILES: C=CCCc1ccc(CCc2ccc(-c3ccc(CCC=C)cc3)cc2F)cc1] |
| 274 | 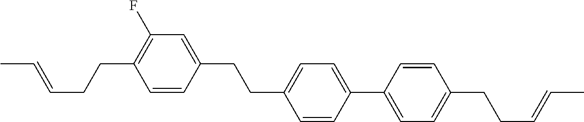 [SMILES: C/C=C/CCc1ccc(-c2ccc(CCc3ccc(CC/C=C/C)c(F)c3)cc2)cc1] |
| 275 | 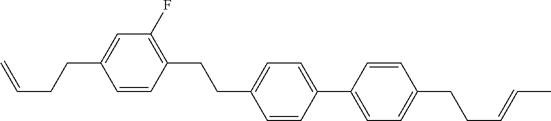 [SMILES: C=CCCc1ccc(CCc2ccc(-c3ccc(CC/C=C/C)cc3)cc2)c(F)c1] |
| 276 | 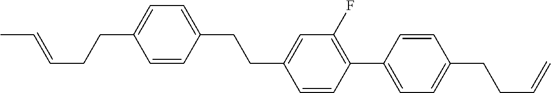 [SMILES: C=CCCc1ccc(-c2ccc(CCc3ccc(CC/C=C/C)cc3)cc2F)cc1] |
| 277 | 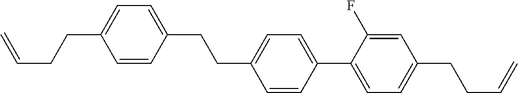 [SMILES: C=CCCc1ccc(CCc2ccc(-c3ccc(CCC=C)cc3F)cc2)cc1] |
| 278 | 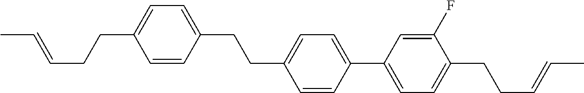 [SMILES: C/C=C/CCc1ccc(CCc2ccc(-c3ccc(CC/C=C/C)c(F)c3)cc2)cc1] |
| 279 | 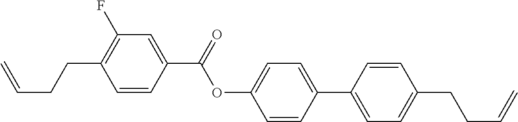 [SMILES: C=CCCc1ccc(-c2ccc(OC(=O)c3ccc(CCC=C)c(F)c3)cc2)cc1] |
| 280 | 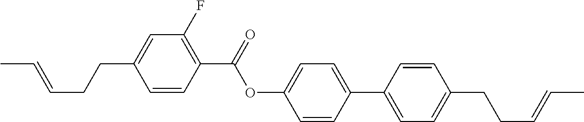 [SMILES: C/C=C/CCc1ccc(-c2ccc(OC(=O)c3ccc(CC/C=C/C)cc3F)cc2)cc1] |
| 281 | 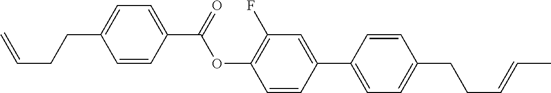 [SMILES: C=CCCc1ccc(C(=O)Oc2ccc(-c3ccc(CC/C=C/C)cc3)cc2F)cc1] |
| 282 | 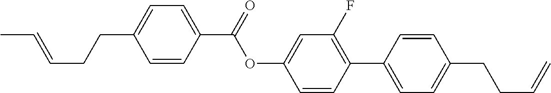 [SMILES: C=CCCc1ccc(-c2ccc(OC(=O)c3ccc(CC/C=C/C)cc3)cc2F)cc1] |
| 283 | 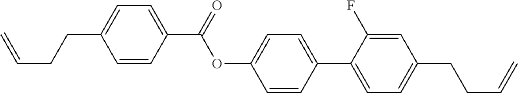 [SMILES: C=CCCc1ccc(C(=O)Oc2ccc(-c3ccc(CCC=C)cc3F)cc2)cc1] |
| 284 | 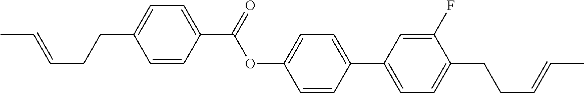 [SMILES: C/C=C/CCc1ccc(C(=O)Oc2ccc(-c3ccc(CC/C=C/C)c(F)c3)cc2)cc1] |
| 285 | 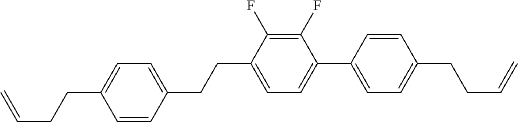 [SMILES: C=CCCc1ccc(CCc2ccc(-c3ccc(CCC=C)cc3)c(F)c2F)cc1] |
| 286 | 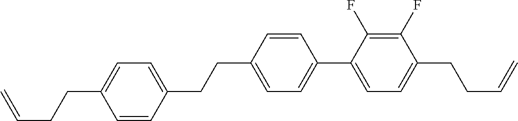 [SMILES: C=CCCc1ccc(CCc2ccc(-c3ccc(CCC=C)c(F)c3F)cc2)cc1] |

2. Examples of composition

The invention will be described in greater detail by way of Examples. The Examples include a typical example, and therefore the invention is not limited by the Examples. For example, in addition to compositions in Use Examples, the invention includes a mixture of a composition in Use Example 1 and a composition in Use Example 2. The invention also includes a mixture prepared by mixing at least two of the compositions in the Use Examples. Compounds in the Use Examples were represented using symbols according to definitions in Table 3 described below. In Table 3, a configuration of 1,4-cyclohexylene is trans. A parenthesized number next to a symbolized compound in the Use Examples represents a chemical formula to which the compound belongs. A symbol (−) means a liquid crystal compound different from compounds (1) to (15). A proportion (percentage) of the liquid crystal compound is expressed in terms of weight percent (% by weight) based on the weight of the liquid crystal composition containing no additive. Values of the physical properties of the composition are summarized in a last part. The physical properties were measured according to the methods described above, and measured values are directly described (without extrapolation).

TABLE 3
Method for Description of Compounds using Symbols
R—(A₁)—Z₁— . . . —Zₙ—(Aₙ)—R′

| 1) Left-terminal Group R— | Symbol |
|---|---|
| FCₙH₂ₙ— | Fn- |
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| 2) Right-terminal Group —R′ | Symbol |
| —CₙH₂ₙ₊₁ | -n |
| —OCₙH₂ₙ₊₁ | —On |
| —COOCH₃ | —EMe |
| —CH═CH₂ | —V |
| —CH═CH—CₙH₂ₙ₊₁ | —Vn |
| —CₙH₂ₙ—CH═CH₂ | -nV |
| —CₘH₂ₘ—CH═CH—CₙH₂ₙ₊₁ | -mVn |
| —CH═CF₂ | —VFF |
| —F | —F |
| —Cl | —CL |
| —OCF₃ | —OCF3 |
| —OCF₂H | —OCF2H |
| —CF₃ | —CF3 |
| —C≡N | —C |
| 3) Bonding Group —Zₙ— | Symbol |
| —CₙH₂ₙ— | n |
| —COO— | E |
| —CH═CH— | V |
| —CH₂O— | 1O |
| —OCH₂— | O1 |
| —CF₂O— | X |
| —C≡C— | T |
| 4) Ring Structure —Aₙ— | Symbol |
| 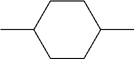 | H |
| 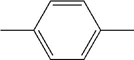 | B |
| 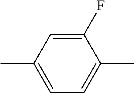 | B(F) |
| 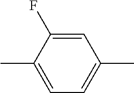 | B(2F) |
| 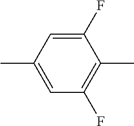 | B(F, F) |
| 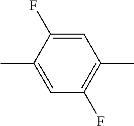 | B(2F, 5F) |
| 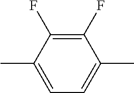 | B(2F, 3F) |
| 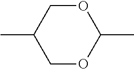 | G |
| 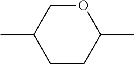 | dH |
| 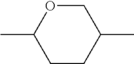 | Dh |
| 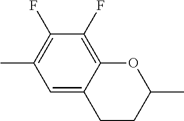 | Cro(7F, 8F) |
| 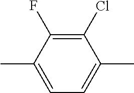 | B(2F, 3CL) |
| 5) Examples of Description | |

Example 1 V2-B2BB-2V

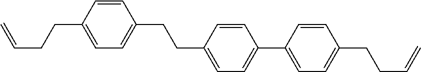 [SMILES: C=CCCc1ccc(CCc2ccc(-c3ccc(CCC=C)cc3)cc2)cc1]

Example 2 3-HBB(F,F)-F

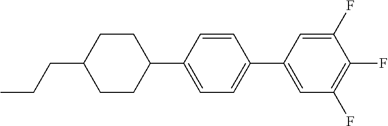 [SMILES: CCCC1CCC(c2ccc(-c3cc(F)c(F)c(F)c3)cc2)CC1]

Use example 1

| | | |
|---|---|---|
| V2-B2BB-2V | (261) | 5% |
| 2-HB-C | (5-1) | 5% |
| 3-HB-C | (5-1) | 12% |
| 3-HB-O2 | (13-5) | 15% |
| 2-BTB-1 | (13-10) | 3% |
| 3-HHB-F | (3-1) | 4% |
| 3-HHB-1 | (14-1) | 8% |
| 3-HHB-3 | (14-1) | 14% |
| 3-HHEB-F | (3-10) | 4% |
| 5-HHEB-F | (3-10) | 4% |
| 2-HHB(F)-F | (3-2) | 7% |
| 3-HHB(F)-F | (3-2) | 7% |
| 5-HHB(F)-F | (3-2) | 7% |
| 3-HHB(F,F)-F | (3-2) | 5% |

NI=97.3° C.; η=16.5 mPa·s; Δn=0.105; Δε=4.8.

Use example 2

| | | |
|---|---|---|
| V2-B2B(2F)B-2V | (273) | 5% |
| 3-HB-CL | (2-2) | 13% |
| 3-HH-4 | (13-1) | 12% |
| 3-HB-O2 | (13-5) | 3% |
| 3-HHB(F,F)-F | (3-3) | 3% |
| 3-HBB(F,F)-F | (3-24) | 30% |
| 5-HBB(F,F)-F | (3-24) | 24% |
| 5-HBB(F)B-2 | (15-5) | 5% |
| 5-HBB(F)B-3 | (15-5) | 5% |

NI=73.8° C.; η=19.9 mPa·s; Δn=0.123; Δε=5.6.

Use example 3

| | | |
|---|---|---|
| V2-B2BB-2V | (261) | 5% |
| 7-HB(F,F)-F | (2-4) | 3% |
| 3-HB-O2 | (13-5) | 7% |
| 2-HHB(F)-F | (3-2) | 10% |
| 3-HHB(F)-F | (3-2) | 8% |
| 5-HHB(F)-F | (3-2) | 8% |
| 2-HBB(F)-F | (3-23) | 8% |
| 3-HBB(F)-F | (3-23) | 9% |
| 5-HBB(F)-F | (3-23) | 16% |
| 2-HBB-F | (3-22) | 4% |
| 3-HBB-F | (3-22) | 4% |
| 5-HBB-F | (3-22) | 3% |
| 3-HBB(F,F)-F | (3-24) | 5% |
| 5-HBB(F,F)-F | (3-24) | 10% |

NI=86.5° C.; η=23.7 mPa·s; Δn=0.121; Δε=5.7.

Use example 4

| | | |
|---|---|---|
| V2-B2B(2F)B-2V | (273) | 4% |
| 5-HB-CL | (2-2) | 16% |
| 3-HH-4 | (13-1) | 12% |
| 3-HH-5 | (13-1) | 4% |
| 3-HHB-F | (3-1) | 3% |
| 3-HHB-CL | (3-1) | 3% |
| 4-HHB-CL | (3-1) | 4% |
| 3-HHB(F)-F | (3-2) | 10% |
| 4-HHB(F)-F | (3-2) | 9% |
| 5-HHB(F)-F | (3-2) | 9% |
| 7-HHB(F)-F | (3-2) | 8% |
| 5-HBB(F)-F | (3-23) | 3% |
| 1O1-HBBH-5 | (15-1) | 3% |
| 4-HHBB(F,F)-F | (4-6) | 3% |
| 5-HHBB(F,F)-F | (4-6) | 3% |
| 3-HH2BB(F,F)-F | (4-15) | 3% |
| 4-HH2BB(F,F)-F | (4-15) | 3% |

NI=111.6° C.; η=17.3 mPa·s; Δn=0.094; Δε=3.6.

Use example 5

| | | |
|---|---|---|
| V2-B2BB-2V | (261) | 5% |
| 3-HHB(F,F)-F | (3-3) | 8% |
| 3-H2HB(F,F)-F | (3-15) | 8% |
| 4-H2HB(F,F)-F | (3-15) | 8% |
| 5-H2HB(F,F)-F | (3-15) | 8% |
| 3-HBB(F,F)-F | (3-24) | 20% |
| 5-HBB(F,F)-F | (3-24) | 18% |
| 3-H2BB(F,F)-F | (3-27) | 9% |
| 5-HHBB(F,F)-F | (4-6) | 3% |
| 5-HHEBB-F | (4-17) | 2% |
| 3-HH2BB(F,F)-F | (4-15) | 3% |
| 1O1-HBBH-4 | (15-1) | 4% |
| 1O1-HBBH-5 | (15-1) | 4% |

NI=101.0° C.; η=33.4 mPa·s; Δn=0.121; Δε=8.8. A pitch was 66.8 micrometers when compound (Op-05) was added to the composition described above in a proportion of 0.25% by weight.

Use example 6

| | | |
|---|---|---|
| V2-B2B(2F)B-2V | (273) | 4% |
| 5-HB-F | (2-2) | 12% |
| 6-HB-F | (2-2) | 9% |
| 7-HB-F | (2-1) | 7% |
| 2-HHB-OCF3 | (3-1) | 7% |
| 3-HHB-OCF3 | (3-1) | 5% |
| 4-HHB-OCF3 | (3-1) | 7% |
| 5-HHB-OCF3 | (3-1) | 5% |
| 3-HH2B-OCF3 | (3-4) | 4% |
| 5-HH2B-OCF3 | (3-4) | 4% |
| 3-HHB(F,F)-OCF2H | (3-3) | 4% |
| 3-HHB(F,F)-OCF3 | (3-3) | 4% |
| 3-HH2B(F)-F | (3-5) | 3% |
| 3-HBB(F)-F | (3-23) | 9% |
| 5-HBB(F)-F | (3-23) | 10% |
| 5-HBBH-3 | (15-1) | 3% |
| 3-HB(F)BH-3 | (15-2) | 3% |

NI=85.0° C.; η=14.0 mPa·s; Δn=0.096; Δε=4.3.

Use example 7

| | | |
|---|---|---|
| V2-B2BB-2V | (261) | 6% |
| 5-HB-CL | (2-2) | 11% |
| 3-HH-4 | (13-1) | 8% |
| 3-HHB-1 | (14-1) | 4% |
| 3-HHB(F,F)-F | (3-3) | 8% |
| 3-HBB(F,F)-F | (3-24) | 17% |
| 5-HBB(F,F)-F | (3-24) | 15% |
| 3-HHEB(F,F)-F | (3-10) | 9% |
| 4-HHEB(F,F)-F | (3-10) | 3% |
| 5-HHEB(F,F)-F | (3-10) | 3% |
| 2-HBEB(F,F)-F | (3-39) | 3% |
| 3-HBEB(F,F)-F | (3-39) | 4% |
| 5-HBEB(F,F)-F | (3-39) | 3% |
| 3-HHBB(F,F)-F | (4-6) | 6% |

NI=82.7° C.; η=20.3 mPa·s; Δn=0.109; Δε=8.4.

Use example 8

| | | |
|---|---|---|
| V2-B2B(2F)B-2V | (273) | 6% |
| 3-HB-CL | (2-2) | 5% |
| 5-HB-CL | (2-2) | 3% |
| 3-HHB-OCF3 | (3-1) | 5% |
| 3-H2HB-OCF3 | (3-13) | 5% |
| 5-H4HB-OCF3 | (3-19) | 15% |
| V-HHB(F)-F | (3-2) | 5% |
| 3-HHB(F)-F | (3-2) | 4% |
| 5-HHB(F)-F | (3-2) | 4% |
| 3-H4HB(F,F)-CF3 | (3-21) | 8% |
| 5-H4HB(F,F)-CF3 | (3-21) | 10% |
| 5-H2HB(F,F)-F | (3-15) | 5% |
| 5-H4HB(F,F)-F | (3-21) | 7% |
| 2-H2BB(F)-F | (3-26) | 5% |
| 3-H2BB(F)-F | (3-26) | 8% |
| 3-HBEB(F,F)-F | (3-39) | 5% |

NI=66.1° C.; η=24.4 mPa·s; Δn=0.091; Δε=7.9.

Use example 9

| | | |
|---|---|---|
| V2-B2BB-2V | (261) | 4% |
| 5-HB-CL | (2-2) | 15% |
| 7-HB(F,F)-F | (2-4) | 3% |
| 3-HH-4 | (13-1) | 10% |
| 3-HH-5 | (13-1) | 5% |
| 3-HB-O2 | (13-5) | 15% |
| 3-HHB-1 | (14-1) | 8% |
| 3-HHB-O1 | (14-1) | 4% |
| 2-HHB(F)-F | (3-2) | 7% |
| 3-HHB(F)-F | (3-2) | 6% |
| 5-HHB(F)-F | (3-2) | 7% |
| 3-HHB(F,F)-F | (3-3) | 6% |
| 3-H2HB(F,F)-F | (3-15) | 5% |
| 4-H2HB(F,F)-F | (3-15) | 5% |

NI=73.0° C.; η=13.2 mPa·s; Δn=0.079; Δε=2.8.

Use example 10

| | | |
|---|---|---|
| V2-B2B(2F)B-2V | (273) | 5% |
| 5-HB-CL | (2-2) | 3% |
| 7-HB(F)-F | (2-3) | 7% |
| 3-HH-4 | (13-1) | 9% |
| 3-HH-5 | (13-1) | 10% |
| 3-HB-O2 | (13-5) | 11% |
| 3-HHEB-F | (3-10) | 8% |
| 5-HHEB-F | (3-10) | 7% |
| 3-HHEB(F,F)-F | (3-12) | 10% |
| 4-HHEB(F,F)-F | (3-12) | 4% |
| 3-GHB(F,F)-F | (3-109) | 5% |
| 4-GHB(F,F)-F | (3-109) | 6% |
| 5-GHB(F,F)-F | (3-109) | 5% |
| 2-HHB(F,F)-F | (3-3) | 5% |
| 3-HHB(F,F)-F | (3-3) | 5% |

NI=72.3° C.; η=17.6 mPa·s; Δn=0.074; Δδ=5.6.

Use example 11

| | | |
|---|---|---|
| V2-B2BB-2V | (261) | 5% |
| 3-HB-O1 | (13-5) | 15% |
| 3-HH-4 | (13-1) | 5% |
| 3-HB(2F,3F)-O2 | (6-1) | 12% |
| 5-HB(2F,3F)-O2 | (6-1) | 10% |
| 2-HHB(2F,3F)-1 | (7-1) | 11% |
| 3-HHB(2F,3F)-1 | (7-1) | 10% |
| 3-HHB(2F,3F)-O2 | (7-1) | 13% |
| 5-HHB(2F,3F)-O2 | (7-1) | 13% |
| 3-HHB-1 | (14-1) | 6% |

NI=88.8° C.; η=34.0 mPa·s; Δn=0.097; Δε=−3.2.

Use example 12

| | | |
|---|---|---|
| V2-B2B(2F)B-2V | (273) | 4% |
| 2-HH-5 | (13-1) | 3% |
| 3-HH-4 | (13-1) | 13% |
| 3-HH-5 | (13-1) | 4% |
| 3-HB-O2 | (13-5) | 12% |
| 3-H2B(2F,3F)-O2 | (6-4) | 13% |
| 5-H2B(2F,3F)-O2 | (6-4) | 15% |
| 3-HHB(2F,3CL)-O2 | (7-12) | 5% |
| 2-HBB(2F,3F)-O2 | (7-7) | 3% |
| 3-HBB(2F,3F)-O2 | (7-7) | 9% |
| 5-HBB(2F,3F)-O2 | (7-7) | 9% |
| 3-HHB-1 | (14-1) | 3% |
| 3-HHB-3 | (14-1) | 4% |
| 3-HHB-O1 | (14-1) | 3% |

NI=78.0° C.; η=19.3 mPa·s; Δn=0.099; Δε=−3.9.

Use example 13

| | | |
|---|---|---|
| V2-B2BB-2V | (261) | 5% |
| 2-HH-3 | (13-1) | 21% |
| 3-HH-4 | (13-1) | 9% |
| 1-BB-3 | (13-8) | 9% |
| 3-HB-O2 | (13-5) | 2% |
| 3-BB(2F,3F)-O2 | (6-3) | 9% |
| 5-BB(2F,3F)-O2 | (6-3) | 6% |
| 2-HH1OB(2F,3F)-O2 | (7-5) | 8% |
| 3-HH1OB(2F,3F)-O2 | (7-5) | 21% |
| 3-HHB-1 | (14-1) | 5% |
| 3-HHB-O1 | (14-1) | 3% |
| 5-B(F)BB-2 | (14-8) | 2% |

NI=74.5° C.; η=12.6 mPa·s; Δn=0.103; Δε=−2.8.

Use example 14

| | | |
|---|---|---|
| V2-B2B(2F)B-2V | (273) | 4% |
| 2-HH-3 | (13-1) | 16% |
| 7-HB-1 | (13-5) | 8% |
| 5-HB-O2 | (13-5) | 8% |
| 3-HB(2F,3F)-O2 | (6-1) | 17% |
| 5-HB(2F,3F)-O2 | (6-1) | 14% |
| 3-HHB(2F,3CL)-O2 | (7-12) | 3% |
| 4-HHB(2F,3CL)-O2 | (7-12) | 3% |
| 5-HHB(2F,3CL)-O2 | (7-12) | 2% |
| 3-HH1OCro(7F,8F)-5 | (10-6) | 5% |
| 5-HBB(F)B-2 | (15-5) | 10% |
| 5-HBB(F)B-3 | (15-5) | 10% |

NI=79.5° C.; η=22.7 mPa·s; Δn=0.110; Δε=−2.4.

Use example 15

| | | |
|---|---|---|
| V2-B2BB-2V | (261) | 5% |
| 2-HH-3 | (13-1) | 4% |
| 1-BB-3 | (13-8) | 0% |
| 3-HH-V | (13-1) | 27% |
| 3-BB(2F,3F)-O2 | (6-3) | 11% |
| 2-HH1OB(2F,3F)-O2 | (7-5) | 18% |
| 3-HH1OB(2F,3F)-O2 | (7-5) | 12% |
| 3-HHB-1 | (14-1) | 7% |
| 5-B(F)BB-2 | (14-8) | 6% |

NI=74.1° C.; η=12.0 mPa·s; Δn=0.109; Δε=−2.6.

Use example 16

| | | |
|---|---|---|
| V2-B2B(2F)B-2V | (273) | 4% |
| 2-HH-3 | (13-1) | 6% |
| 3-HH-V1 | (13-1) | 10% |
| 1V2-HH-1 | (13-1) | 8% |
| 1V2-HH-3 | (13-1) | 7% |
| 3-BB(2F,3F)-O2 | (6-3) | 8% |
| 5-BB(2F,3F)-O2 | (6-3) | 4% |
| 3-H1OB(2F,3F)-O2 | (6-5) | 7% |
| 2-HH1OB(2F,3F)-O2 | (7-5) | 8% |
| 3-HH1OB(2F,3F)-O2 | (7-5) | 15% |
| 3-HDhB(2F,3F)-O2 | (7-3) | 7% |
| 3-HHB-1 | (14-1) | 3% |
| 3-HHB-3 | (14-1) | 2% |
| 2-BB(2F,3F)B-3 | (8-1) | 11% |

NI=82.9° C.; η=19.8 mPa·s; Δn=0.112; Δε=−4.1.

Use example 17

| | | |
|---|---|---|
| V2-B2BB-2V | (261) | 5% |
| 1V2-BEB(F,F)-C | (15-5) | 6% |
| 3-HB-C | (5-1) | 18% |
| 2-BTB-1 | (13-10) | 10% |
| 5-HH-VFF | (13-1) | 25% |
| 3-HHB-1 | (14-1) | 4% |
| VFF-HHB-1 | (14-1) | 8% |
| VFF2-HHB-1 | (14-1) | 11% |
| 3-H2BTB-2 | (14-17) | 5% |
| 3-H2BTB-3 | (14-17) | 4% |
| 3-H2BTB-4 | (14-17) | 4% |

NI=85.0° C.; η=12.5 mPa·s; Δn=0.139; Δε=6.8.

Use example 18

| | | |
|---|---|---|
| V2-B2B(2F)B-2V | (273) | 3% |
| 5-HB(F)B(F,F)XB(F,F)-F | (4-41) | 5% |
| 3-BB(F)B(F,F)XB(F,F)-F | (4-47) | 3% |
| 4-BB(F)B(F,F)XB(F,F)-F | (4-47) | 7% |
| 3-HH-V | (13-1) | 41% |
| 3-HH-V1 | (13-1) | 7% |
| 3-HHEH-5 | (14-13) | 3% |
| 3-HHB-1 | (14-1) | 4% |
| V-HHB-1 | (14-1) | 5% |
| V2-BB(F)B-1 | (14-6) | 5% |
| 1V2-BB-F | (2-1) | 3% |
| 3-BB(F,F)XB(F,F)-F | (3-97) | 11% |
| 3-HHBB(F,F)-F | (4-6) | 3% |

NI=81.8° C.; η=10.0 mPa·s; Δn=0.105; Δε=5.5.

Use example 19

| | | |
|---|---|---|
| V2-B2BB-2V | (261) | 5% |
| 3-GB(F)B(F,F)XB(F,F)-F | (4-57) | 4% |
| 5-HB(F)B(F,F)XB(F,F)-F | (4-41) | 3% |
| 3-BB(F)B(F,F)XB(F,F)-F | (4-47) | 3% |
| 4-BB(F)B(F,F)XB(F,F)-F | (4-47) | 6% |
| 5-BB(F)B(F,F)XB(F,F)-F | (4-47) | 3% |
| 3-HH-V | (13-1) | 39% |
| 3-HH-V1 | (13-1) | 5% |
| 3-HHEH-5 | (14-13) | 3% |
| 3-HHB-1 | (14-1) | 4% |
| V-HHB-1 | (14-1) | 5% |
| V2-BB(F)B-1 | (14-6) | 5% |
| 1V2-BB-F | (2-1) | 3% |
| 3-BB(F,F)XB(F,F)-F | (3-97) | 5% |
| 3-GB(F,F)XB(F,F)-F | (3-113) | 4% |
| 3-HHBB(F,F)-F | (4-6) | 3% |

NI=86.1° C.; η=13.3 mPa·s; Δn=0.111; Δε=7.2.

### INDUSTRIAL APPLICABILITY

A liquid crystal compound according to the invention has good physical properties. A liquid crystal composition containing the compound can be widely applied to a liquid crystal display device used for a personal computer, a television and so forth.

What is claimed is:

1. A compound, represented by formula (1): 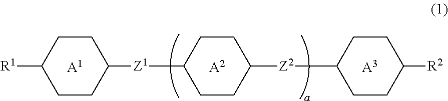
wherein, in formula (1),
R¹ and R² are independently alkenyl having 2 to 10 carbons, and in the alkenyl, at least one piece of hydrogen maybe replaced by fluorine or chlorine;
ring A¹, ring A² and ring A³ are independently 1,4-phenylene or 1,4-phenylene in which at least one piece of hydrogen is replaced by fluorine or chlorine;
Z¹ and Z² are independently alkylene having 1 to 4 carbons, and in the groups, at least one piece of —CH₂— may be replaced by —O—, —COO— or —OCO—, and at least one piece of —CH₂CH₂— may be replaced by —CH═CH—, and in the groups, at least one piece of hydrogen maybe replaced by fluorine or chlorine, and at least one of Z¹ and Z² may be a single bond; and
a is 1 or 2.

2. The compound according to claim 1, represented by formula (1a): 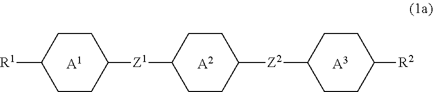
wherein, in formula (1a), R¹⁻ and R² are independently alkenyl having 4 or 5 carbons, and in the groups, at least one piece of hydrogen may be replaced by fluorine or chlorine; ring A¹, ring A² and ring A³ are independently 1,4-phenylene or 1, 4 -phenylene in which at least one piece of hydrogen is replaced by fluorine; and Z¹ and Z² are independently —OCO—, —CH₂O—, —CF₂O—, —CH₂CH₂—, —CF₂CF₂—, —CF═CF—, —(CH₂)₄—, or —CH₂CH═CHCH₂—, and at least one of Z¹ and Z² may be a single bond.

3. The compound according to claim 1, represented by formula (1b): 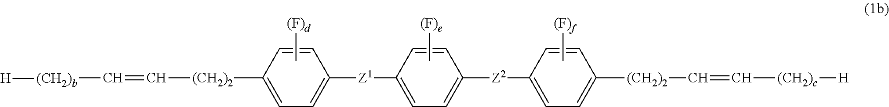
wherein, in formula (1b), b and c are independently 0 or 1; d, e and f are independently 0, 1 or 2, and a sum of d, e and f is from 0 to 3; and Z¹ and Z² are independently —COO—, —CH₂O—, —CH₂CH₂—, —(CH₂)₄— or —CH₂CH═CHCH₂—, and at least one of Z¹ and Z² may be a single bond.

4. The compound according to claim 1, represented by formula (1c): 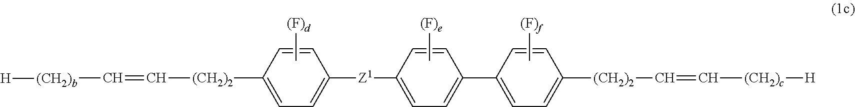
wherein, in formula (1c), b and c are independently 0 or 1; d, e and f are independently 0, 1 or 2, and a sum of d, e and f is 0, 1 or 2; and Z¹ is —COO—, —CH₂O— or —CH₂CH₂—.

5. The compound according to claim 4, wherein, in formula (1c), b and c are independently 0 or 1; d, e and f are independently 0 or 1, and a sum of d, e and f is 0 or 1; and Z¹ is —CH₂CH₂—.

6. The compound according to claim 1, represented by any one of formulas (1d) to (1g): 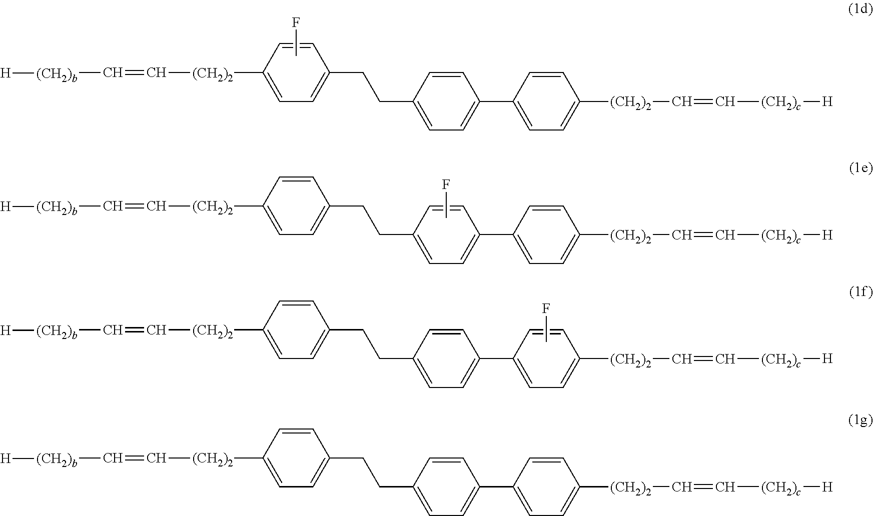
wherein, in formulas (1d) to (1g), b and c are independently 0 or 1.

7. The compound according to claim 1, represented by any one of formulas (1h) to (1k):

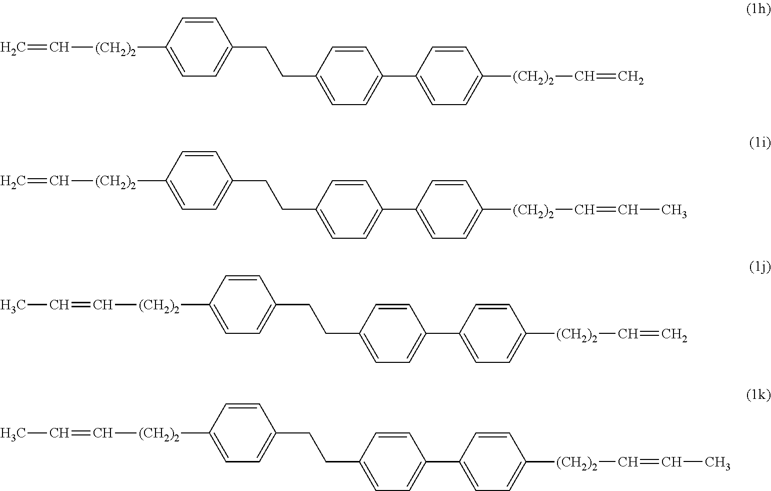

8. A liquid crystal composition, comprising a compound according to claim 1.

9. The liquid crystal composition according to claim 8, further comprising at least one compound selected from the group of compounds represented by formulas (2) to (4): 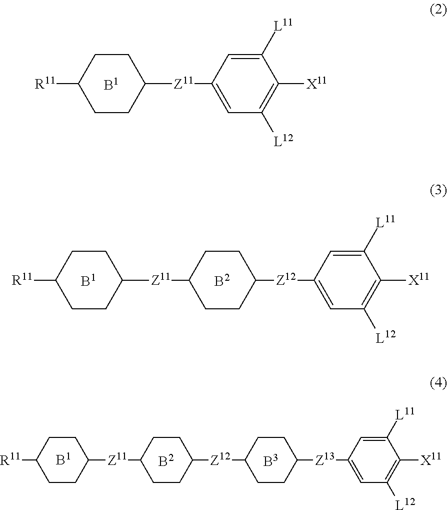
wherein, in formulas (2) to (4),
R¹¹ is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine;
X¹¹ is fluorine, chlorine, —OCF₃, —OCHF₂, —CF₃, —CHF₂, —CH₂F, —OCF₂CHF₂ or —OCF₂CHFCF₃;
ring B¹, ring B² and ring B³ are independently 1,4-cyclohexylene, 1,4-phenylene, 1,4-phenylene in which at least one piece of hydrogen is replaced by fluorine, tetrahydropyran-2,5-diyl, 1,3-dioxane-2,5-diyl or pyrimidine-2,5-diyl;
Z¹¹, Z¹² and Z³ are independently —COO—, —OCO—, —CH₂O—, —OCH₂—, —CF₂O—, —OCF₂—, —CH₂CH₂—, —CH═CH—, or —(CH₂)₄—; and
L¹¹ and L¹² are independently hydrogen or fluorine.

10. The liquid crystal composition according to claim 8, further comprising at least one compound selected from the group of compounds represented by formula (5): 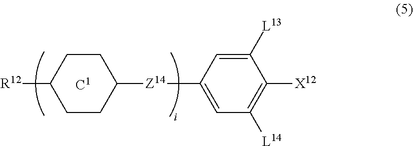
wherein, in formula (5),
R¹² is alkyl having 1 to 10 carbons or alkenyl having 2 to 10 carbons, and in the alkyl and the alkenyl, at least one piece of —CH₂— may be replaced by —O—, and in the groups, at least one piece of hydrogen may be replaced by fluorine;
X¹² is —C≡N or —C≡C—C≡N;
ring C¹ is 1,4-cyclohexylene, 1,4-phenylene, 1,4-phenylene in which at least one piece of hydrogen is replaced by fluorine, tetrahydropyran-2,5-diyl, 1,3-dioxane-2,5-diyl or pyrimidine-2,5-diyl;
Z¹⁴ is a single bond, —COO—, —OCO—, —CH₂O—, —OCH₂—, —CF₂O—, —OCF₂—, —CH₂CH₂— or —C≡C—;
L¹³ and L¹⁴ are independently hydrogen or fluorine; and
i is 1, 2, 3 or 4.

11. The liquid crystal composition according to claim 8, further comprising at least one compound selected from the group of compounds represented by formulas (6) to (12): 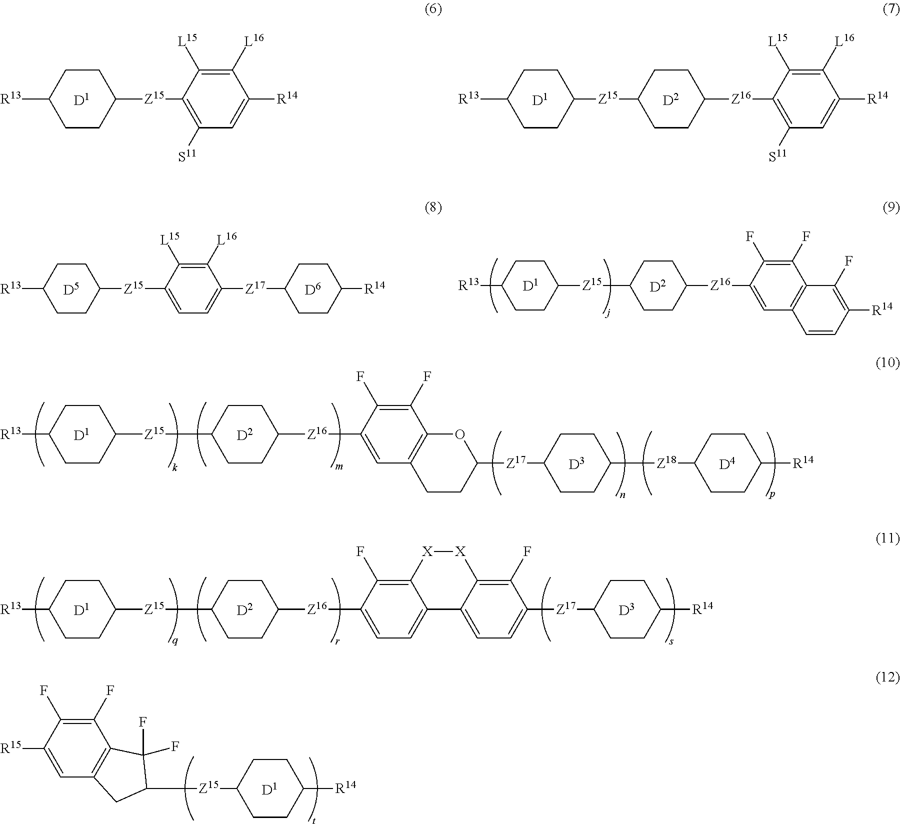
wherein, in formulas (6) to (12),
R¹³, R¹⁴ and R¹⁵ are independently alkyl having 1 to 10 carbons or alkenyl having 2 to 10 carbons, and in the groups, at least one piece of —CH₂— may be replaced by —O—, and in the groups, at least one piece of hydrogen may be replaced by fluorine, and R¹⁵ may be hydrogen or fluorine;
ring D^{I-}, ring D², ring D³ and ring D⁴ are independently 1,4-cyclohexylene, 1,4-cyclohexenylene, 1,4-phenylene, 1, 4-phenylene in which at least one piece of hydrogen is replaced by fluorine, tetrahydropyran-2,5-diyl or decahydronaphthalene-2,6-diyl;
ring D⁵ and ring D⁶ are independently 1,4-cyclohexylene, 1,4-cyclohexenylene, 1,4-phenylene, tetrahydropyran-2,5-diyl or decahydronaphthalene-2,6-diyl;
Z¹⁵, Z¹⁶, Z¹⁷ and Z¹⁸ are independently a single bond, —COO—, —OCO—, —CH₂O—, —OCH₂—, —CF₂O—, —OCF₂—, —CH₂CH₂—, —CF₂OCH₂CH₂— or —OCF₂CH₂CH₂—;
L¹⁵ and L¹⁶ are independently fluorine or chlorine;
S¹¹ is hydrogen or methyl;
X is —CHF— or —CF₂—; and
j, k, m, n, p, q, r and s are independently 0 or 1, a sum of k, m, n and p is 1 or 2, a sum of q, r and s is 0, 1, 2 or 3, and t is 1, 2 or 3.

12. The liquid crystal composition according to claim 8, further comprising at least one compound selected from the group of compounds represented by formulas (13) to (15): 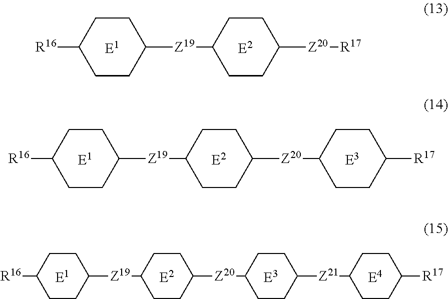
wherein, in formulas (13) to (15),
R¹⁶ and R¹⁷ are independently alkyl having 1 to 10 carbons or alkenyl having 2 to 10 carbons, and in the groups, at least one piece of —CH₂— may be replaced by —O—, and in the groups, at least one piece of hydrogen may be replaced by fluorine;
ring E¹, ring E², ring E³ and ring E⁴ are independently 1,4-cyclohexylene, 1,4-phenylene, 2-fluoro-1,4-phenylene, 2,5-difluoro-1,4-phenylene or pyrimidine-2,5-diyl;
Z¹⁹, Z²⁰ and Z²¹ are independently a single bond, —COO—, —CH₂CH₂—, —CH═CH— or —C≡C—; however,
in formulas (14) and (15), when one of R¹⁶ or R¹⁷ is alkenyl having 2 to 10 carbons, in which at least one piece of hydrogen may be replaced by fluorine, another of R¹⁶ or R¹⁷ is alkyl having 1 to 10 carbons, in which at least one piece of hydrogen may be replaced by fluorine.

13. A liquid crystal display device, comprising a liquid crystal composition according to claim 8.
